(19) United States
(12) Patent Application Publication
(10) Pub. No.: US 2025/0310062 A1
(43) Pub. Date: Oct. 2, 2025

(54) METHOD AND DEVICE FOR TRANSMITTING OR RECEIVING DEMODULATION REFERENCE SIGNAL IN WIRELESS COMMUNICATION SYSTEM

(71) Applicant: Samsung Electronics Co., Ltd., Suwon-si (KR)

(72) Inventors: Youngrok JANG, Suwon-si (KR); Ameha Tsegaye ABEBE, Suwon-si (KR); Hyoungju JI, Suwon-si (KR); Kyungjun CHOI, Suwon-si (KR)

(21) Appl. No.: 19/082,932

(22) Filed: Mar. 18, 2025

(30) Foreign Application Priority Data
Mar. 26, 2024 (KR) 10-2024-0041324

(51) Int. Cl. H04L 5/00; H04W 72/232

(52) U.S. Cl. CPC H04L 5/0053; H04W 72/232

(57) ABSTRACT

A user equipment (UE) in a wireless communication system is provided. The UE includes a transceiver, and a controller coupled with the transceiver, and configured to transmit, to a base station, first UE capability information indicating a supported demodulation reference signal (DMRS) type for downlink and second UE capability information indicating a supported enhanced DMRS type for physical downlink shared channel (PDSCH), transmit, to the base station, third UE capability information including a value indicating a maximum number of DMRS types for PDSCH across all downlink control information (DCI) formats, and receive, from the base station, a DMRS for PDSCH according to at least one DMRS type among the supported DMRS type and the supported enhanced DMRS type, wherein a number of the at least one DMRS type is equal to or less than the maximum number of DMRS types.

### CROSS-REFERENCE TO RELATED APPLICATION(S)

This application is based on and claims priority under 35 U.S.C. § 119(a) of a Korean patent application number 10-2024-0041324, filed on Mar. 26, 2024, in the Korean Intellectual Property Office, the disclosure of which is incorporated by reference herein in its entirety.

### BACKGROUND

### 1. Field

The disclosure relates to an operation of a terminal and a base station in a wireless communication system. More particularly, the disclosure relates to a method for transmitting or receiving a downlink demodulation reference signal in a wireless communication system, and a device capable of performing same.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a wireless communication system.

Additional aspects will be set forth in part in the description which follows and, in part, will be apparent from the description, or may be learned by practice of the presented embodiments.

In accordance with an aspect of the disclosure, a user equipment (UE) in a wireless communication system is provided. The UE includes a transceiver; a memory storing one or more computer programs; and one or more processors communicatively coupled to the transceiver and the memory, wherein the one or more programs include computer-executable instructions that, when executed by the one or more processors individually or collectively, cause the UE to transmit, to a base station, first UE capability information indicating a supported demodulation reference signal (DMRS) type for downlink and second UE capability information indicating a supported enhanced DMRS type for physical downlink shared channel (PDSCH), transmit, to the base station, third UE capability information including a value indicating a maximum number of DMRS types for PDSCH across all downlink control information (DCI) formats, and receive, from the base station, a DMRS for PDSCH according to at least one DMRS type among the supported DMRS type and the supported enhanced DMRS type, wherein a number of the at least one DMRS type is equal to or less than the maximum number of DMRS types.

In accordance with an aspect of the disclosure, a base station in a wireless communication system is provided. The base station includes a transceiver; a memory storing one or more computer programs; and one or more processors communicatively coupled to the transceiver and the memory, wherein the one or more programs include computer-executable instructions that, when executed by the one or more processors individually or collectively, cause the base station to receive, from a user equipment (UE), first UE capability information indicating a supported demodulation reference signal (DMRS) type for downlink and second UE capability information indicating a supported enhanced DMRS type for physical downlink shared channel (PDSCH), receive, from the UE, third UE capability information including a value indicating a maximum number of DMRS types for PDSCH across all downlink control information (DCI) formats, and transmit, to the UE, a DMRS for a PDSCH according to at least one DMRS type among the supported DMRS type and the supported enhanced DMRS type, wherein a number of the at least one DMRS type is equal to or less than the maximum number of DMRS types.

In accordance with an aspect of the disclosure, a method performed by a user equipment (UE) in a wireless communication system is provided. The method includes transmitting, to a base station, first UE capability information indicating a supported demodulation reference signal (DMRS) type for downlink and second UE capability information indicating a supported enhanced DMRS type for physical downlink shared channel (PDSCH), transmitting, to the base station, third UE capability information including a value indicating a maximum number of DMRS types for PDSCH across all downlink control information (DCI) formats, and receiving, from the base station, a DMRS for a PDSCH according to at least one DMRS type among the supported DMRS type and the supported enhanced DMRS type, wherein a number of the at least one DMRS type is equal to or less than the maximum number of DMRS types.

In accordance with an aspect of the disclosure, a method performed by a base station in a wireless communication system is provided. The method includes receiving, from a user equipment (UE), first UE capability information indicating a supported demodulation reference signal (DMRS) type for downlink and second UE capability information indicating a supported enhanced DMRS type for physical downlink shared channel, PDSCH, receiving, from the UE, third UE capability information including a value indicating a maximum number of DMRS types for PDSCH across all downlink control information, DCI, formats, and transmitting, to the UE, a DMRS for a PDSCH according to at least one DMRS type among the supported DMRS type and the supported enhanced DMRS type, wherein a number of the at least one DMRS type is equal to or less than the maximum number of DMRS types.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of a control resource set configuration of a downlink control channel in a wireless communication system according to an embodiment of the disclosure;

FIG. 5A illustrates a structure of a downlink control channel in a wireless communication according to an embodiment of the disclosure;

FIG. 5B illustrates, in terms of spans, a case in which a UE may have multiple physical downlink control channel (PDCCH) monitoring occasions inside a slot in a wireless communication system according to an embodiment of the disclosure;

FIG. 6 illustrates an example of a discontinuous reception (DRX) operation in a wireless communication system according to an embodiment of the disclosure;

FIG. 7 illustrates an example of base station beam allocation according to TCI state configuration in a wireless communication system according to an embodiment of the disclosure;

FIG. 8 illustrates an example of a method for TCI state allocation with regard to a PDCCH in a wireless communication system according to an embodiment of the disclosure;

FIG. 9 illustrates a TCI indication MAC CE signaling structure for a PDCCH DMRS in a wireless communication system according to an embodiment of the disclosure;

FIG. 10 illustrates an example of beam configuration with regard to a control resource set and a search space in a wireless communication system according to an embodiment of the disclosure;

FIG. 11 illustrates an example of a method in which a base station and a UE transmit/receive data in consideration of a downlink data channel and a rate matching resource in a wireless communication system according to an embodiment of the disclosure;

FIG. 12 illustrates an example of a method in which, upon receiving a downlink control channel, a UE selects a receivable control resource set in consideration of priority in a wireless communication system according to an embodiment of the disclosure;

FIG. 13 illustrates an example of time domain resource allocation with regard to a PDSCH in a wireless communication system according to an embodiment of the disclosure;

FIG. 14 illustrates an example of time domain resource allocation with regard to a PDSCH in a wireless communication system according to an embodiment of the disclosure;

FIG. 15 illustrates an example of time domain resource allocation according to a subcarrier spacing with regard to a data channel and a control channel in a wireless communication system according to an embodiment of the disclosure;

FIG. 16 illustrates a process for beam configuration and activation with regard to a PDSCH in a wireless communication system according to an embodiment of the disclosure;

FIG. 17 illustrates radio protocol structures of a base station and a UE in single cell, carrier aggregation, and dual connectivity situations in a wireless communication system according to an embodiment of the disclosure;

FIG. 18 illustrates an example of an antenna port configuration and resource allocation for cooperative communication in a wireless communication system according to an embodiment of the disclosure;

FIG. 19 illustrates an example of a downlink control information (DCI) configuration for cooperative communication in a wireless communication system according to an embodiment of the disclosure;

FIG. 20 illustrates an enhanced PDSCH TCI state activation/deactivation MAC-CE structure according to an embodiment of the disclosure;

FIG. 21 illustrates an operation of a terminal for transmitting or receiving a demodulation signal in a wireless communication system according to an embodiment of the disclosure;

FIG. 22 illustrates an operation of a base station for transmitting or receiving a demodulation signal in a wireless communication system according to an embodiment of the disclosure;

FIG. 23 illustrates a structure of a UE in a wireless communication system according to an embodiment of the disclosure; and

FIG. 24 illustrates a structure of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” may refer to a radio link via which a base station transmits a signal to a terminal, and an “uplink (UL)” may refer to a radio link via which a terminal transmits a signal to a base station. Furthermore, in the following description, long term evolution (LTE) or LTE advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in various embodiments of the disclosure may include one or more processors.

A wireless communication system is advancing to a broadband wireless communication system for providing high-speed and high-quality packet data services using communication standards, such as high-speed packet access (HSPA) of 3^{rd} generation partnership project (3GPP), LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

The eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### NR Time-Frequency Resources

Hereinafter, a frame structure of a 5G system will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

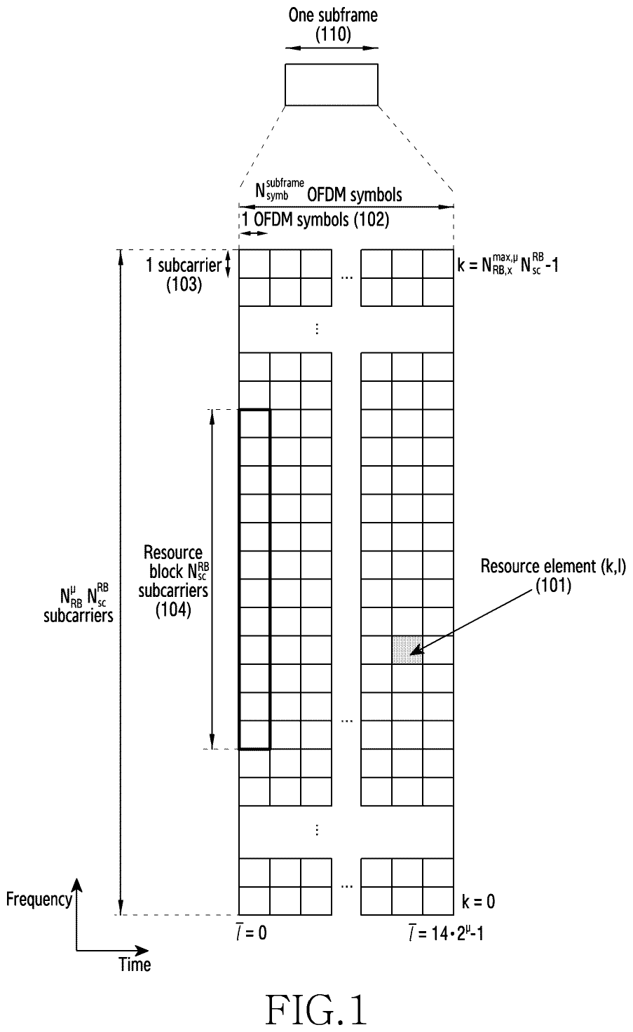

FIG. 1 illustrates a basic structure of a time-frequency domain, which is a radio resource domain used to transmit data or control channels, in a 5G system according to an embodiment of the disclosure.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain,

$${N}_{SC}^{RB}$$

(for example, 12) consecutive REs may constitute one resource block (RB) 104. In the time domain, one subframe 110 may include multiple OFDM symbols 102. For example, the length of one subframe may be 1 ms.

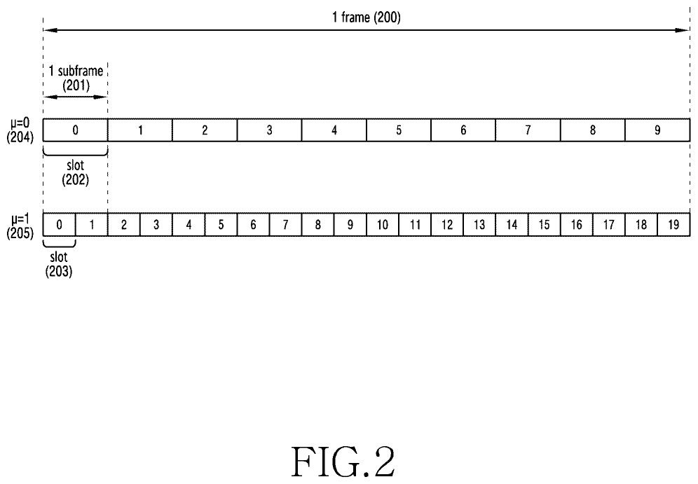

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols

$$( that is , the number of symbols per one slot {N}_{symb}^{slot} = 14 ) .$$

One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

Next, a bandwidth part (BWP) configuration in a 5G communication system will be described in detail with reference to the accompanying drawings.

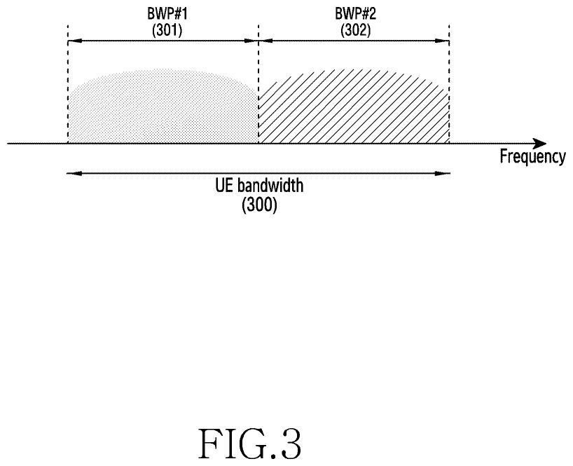

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given below.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |

}

Obviously, the above example is not limiting, and various parameters related to the bandwidth part may be configured for the UE, in addition to the above configuration information. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### Bandwidth Part (BWP) Change

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given below, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

According to various embodiments of the disclosure, the requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### SS/PBCH Block

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

According to various embodiments of the disclosure, the UE may detect the PSS and SSS and may decode the PBCH in the initial access step. The UE may acquire an MIB from the PBCH, and this may be used to configure control resource set (CORESET) #0 (which may correspond to, for example, a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### DRX

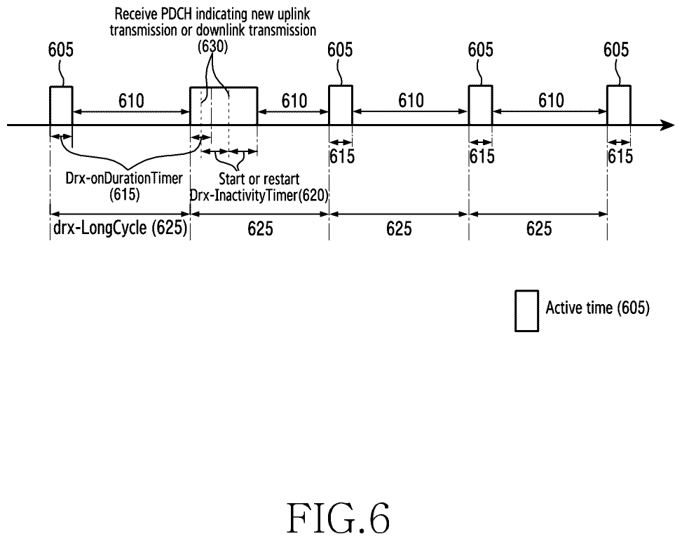

FIG. 6 illustrates an example of a discontinuous reception (DRX) operation in a wireless communication system according to an embodiment of the disclosure.

DRX refers to an operation in which a UE currently using a service discontinuously receives data in an RRC-connected state in which a radio link is configured between the base station and the UE. If the DRX is applied, the UE may turn on a receiver at a specific timepoint so as to monitor a control channel, and may turn off the receiver if there is no data received for a predetermined period of time, thereby reducing power consumed by the UE. The DRX operation may be controlled by a MAC layer device, based on various parameters and timers.

Referring to FIG. 6, the active time 605 refers to a time during which the UE wakes up at each DRX cycle and monitors the PDCCH. The active time 605 may be defined as follows.
drx-onDurationTimer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble

drx-onDurationTimer, drx-InactivityTimer, drx-RetransmissionTimerDL, drx-RetransmissionTimerUL, ra-ContentionResolutionTimer, and the like are timers having values configured by the base station, and have functions which cause the UE to monitor the PDCCH in a situation in which a predetermined condition is satisfied.

drx-onDurationTimer 615 is a parameter for configuring the minimum time during which the UE is awake at the DRX cycle. drx-InactivityTimer 620 is a parameter for configuring a time during which the UE is additionally awake upon receiving (630) a PDCCH indicating new uplink transmission or downlink transmission. drx-RetransmissionTimerDL is a parameter for configuring the maximum time during which the UE is awake in order to receive downlink retransmission in a downlink HARQ procedure. drx-RetransmissionTimerUL is a parameter for configuring the maximum time during which the UE is awake in order to receive an uplink retransmission grant in an uplink HARQ procedure. drx-onDurationTimer, drx-InactivityTimer, drx-RetransmissionTimerDL, and drx-RetransmissionTimerUL may be configured as, for example, time, the number of subframes, the number of slots, and the like. ra-ContentionResolutionTimer is a parameter for monitoring the PDCCH in a random access procedure.

inActive time 610 refers to a time configured such that the PDCCH is not monitored during the DRX operation or a time configured such that the PDCCH is not received, and the inActive time 610 may be obtained by subtracting the active time 605 from the entire time during which the DRX operation is performed. If the UE does not monitor the PDCCH during the active time 605, the UE may enter a sleep or inActive state, thereby reducing power consumption.

The DRX cycle refers to the cycle at which the UE wakes up and monitors the PDCCH. That is, the DRX cycle refers to the time interval between when the UE monitors a PDCCH and when the next PDCCH is monitored, or the cycle at which on-duration occurs. There are two kinds of DRX cycles: a short DRX cycle and a long DRX cycle. The short DRX cycle may be optionally applied.

The long DRX cycle 625 is the longer cycle between two DRX cycles configured for the UE. While operating with long DRX, the UE restarts the drx-onDurationTimer 615 at a timepoint at which the long DRX cycle 625 has elapsed from the start point (for example, start symbol) of the drx-onDurationTimer 615. If operating at the long DRX cycle 625, the UE may start the drx-onDurationTimer 615 in a slot after drx-SlotOffset in a subframe satisfying Equation 1 below. Here, drx-SlotOffset refers to a delay before the drx-onDurationTimer 615 is started. The drx-SlotOffset may be configured, for example, as time, the number of slots, or the like.

$$[ ( SFN \times 10 ) + subframe number ] modulo ( drx - LongCycle ) = drx - StartOffset \qquad Equation 1$$

wherein, drx-LongCycleStartOffset may be used to define the long DRX cycle 625, and drx-StartOffset may be used to define a subframe to start the long DRX cycle 625. drx-LongCycleStartOffset may be configured as, for example, time, the number of subframes, the number of slots, or the like.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

TABLE 4

| | |
|---|---|
| - | Identifier for DCI formats-[1] bit |
| - | Frequency domain resource assignment- |
| | $[ ⌈ {log}_{2} ( {N}_{R B}^{UL , BWP} ( {N}_{R B}^{UL , BWP} + 1 ) / 2 ) ⌉ ] bits$ |
| - | Time domain resource assignment-X bits |
| - | Frequency hopping flag-1 bit. |
| - | Modulation and coding scheme-5 bits |
| - | New data indicator-1 bit |
| - | Redundancy version-2 bits |
| - | HARQ process number-4 bits |
| - | TPC command for scheduled PUSCH-[2] bits |
| - | UL/SUL indicator-0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

TABLE 5

| - | Carrier indicator-0 or 3 bits | |
|---|---|---|
| - | UL/SUL indicator-0 or 1 bit | |
| - | Identifier for DCI formats-[1] bits | |
| - | Bandwidth part indicator-0, 1 or 2 bits | |
| - | Frequency domain resource assignment | |
| | * | $For resource allocation type 0 , ⌈ {N}_{R B}^{UL , BWP} / P ⌉ bits$ |
| | * | $For resource allocation type 1 , ⌈ {log}_{2} ( {N}_{R B}^{UL , BWP} ( {N}_{R B}^{UL , BWP} + 1 ) / 2 ) ⌉ bits$ |
| - | Time domain resource assignment-1, 2, 3, or 4 bits | |
| - | VRB-to-PRB mapping-0 or 1 bit, only for resource allocation type 1. | |
| | * | 0 bit if only resource allocation type 0 is configured; |
| | * | 1 bit otherwise. |
| - | Frequency hopping flag-0 or 1 bit, only for resource allocation type 1. | |
| | * | 0 bit if only resource allocation type 0 is configured; |
| | * | 1 bit otherwise. |
| - | Modulation and coding scheme-5 bits | |
| - | New data indicator-1 bit | |
| - | Redundancy version-2 bits | |
| - | HARQ process number-4 bits | |
| - | 1st downlink assignment index-1 or 2 bits | |
| | * | 1 bit for semi-static HARQ-ACK codebook; |
| | * | 2 bits for dynamic HARQ-ACK codebook with single HARQ- |
| | | ACK codebook. |
| - | 2nd downlink assignment index-0 or 2 bits | |
| | * | 2 bits for dynamic HARQ-ACK codebook with two HARQ- |
| | | ACK sub-codebooks; |
| | * | 0 bit otherwise. |
| - | TPC command for scheduled PUSCH-2 bits | |
| - | $SRS resource indicator - ⌈ {log}_{2} ( {\sum }_{k = 1}^{{L}_{max} \sum } ( \begin{matrix}{N}_{S R S} \\ k\end{matrix} ) ( ) ) □ □ ⌉ or ⌈ {log}_{2} ( {N}_{S R S} ) ⌉ bits$ | |
| | * | $⌈ {log}_{2} ( {\sum }_{k = 1}^{{L}_{max} \sum } ( \begin{matrix}{N}_{S R S} \\ k\end{matrix} ) ( ) ) □ □ ⌉ bits for non - codebook based$ |
| | * | ┌log₂(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | Channel state information (CSI) request-0, 1, 2, 3, 4, 5, or 6 bits |
| - | Code block group (CBG) transmission information-0, 2, 4, 6, or 8 bits |
| - | Phase tracking reference signal (PTRS)-demodulation reference signal |

(DDMRS) association-0 or 2 bits.

| | |
|---|---|
| - | beta_offset indicator-0 or 2 bits |
| - | DMRS sequence initialization-0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 6

| | |
|---|---|
| - | Identifier for DCI formats-[1] bit |
| - | Frequency domain resource assignment- |
| | $[ ⌈ {log}_{2} ( {N}_{R B}^{D L , BWP} ( {N}_{R B}^{D L , BWP} + 1 ) / 2 ) ⌉ ] bits$ |
| - | Time domain resource assignment-X bits |
| - | VRB-to-PRB mapping-1 bit. |
| - | Modulation and coding scheme-5 bits |
| - | New data indicator-1 bit |
| - | Redundancy version-2 bits |
| - | HARQ process number-4 bits |
| - | Downlink assignment index-2 bits |
| - | TPC command for scheduled PUCCH-[2] bits |
| - | PUCCH resource indicator-3 bits |
| - | PDSCH-to-HARQ feedback timing indicator-[3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

TABLE 7

| - | Carrier indicator-0 or 3 bits | |
|---|---|---|
| - | Identifier for DCI formats-[1] bits | |
| - | Bandwidth part indicator-0, 1 or 2 bits | |
| - | Frequency domain resource assignment | |
| | * | $For resource allocation type 0 , ⌈ {N}_{R B}^{D L , BWP} / P ⌉ bits$ |
| | * | $For resource allocation type 1 , ⌈ {log}_{2} ( {N}_{R B}^{D L , B W P} ( {N}_{R B}^{D L , BWP} + 1 ) / 2 ) ⌉ bits$ |
| - | Time domain resource assignment-1, 2, 3, or 4 bits | |
| - | VRB-to-PRB mapping-0 or 1 bit, only for resource allocation type 1. | |
| | * | 0 bit if only resource allocation type 0 is configured; |
| | * | 1 bit otherwise. |

| | |
|---|---|
| - | PRB bundling size indicator-0 or 1 bit |
| - | Rate matching indicator-0, 1, or 2 bits |
| - | ZP CSI-RS trigger-0, 1, or 2 bits |

For transport block 1:

| | |
|---|---|
| - | Modulation and coding scheme-5 bits |
| - | New data indicator-1 bit |
| - | Redundancy version-2 bits |

For transport block 2:

| | |
|---|---|
| - | Modulation and coding scheme-5 bits |
| - | New data indicator-1 bit |
| - | Redundancy version-2 bits |
| - | HARQ process number-4 bits |
| - | Downlink assignment index-0 or 2 or 4 bits |
| - | TPC command for scheduled PUCCH-2 bits |
| - | PUCCH resource indicator-3 bits |
| - | PDSCH-to-HARQ feedback timing indicator-3 bits |
| - | Antenna ports-4, 5 or 6 bits |
| - | Transmission configuration indication-0 or 3 bits |
| - | SRS request-2 bits |
| - | CBG transmission information-0, 2, 4, 6, or 8 bits |
| - | CBG flushing out information-0 or 1 bit |
| - | DMRS sequence initialization-1 bit |

Hereinafter, a downlink control channel in a 5G communication system will be described in more detail with reference to the accompanying drawings.

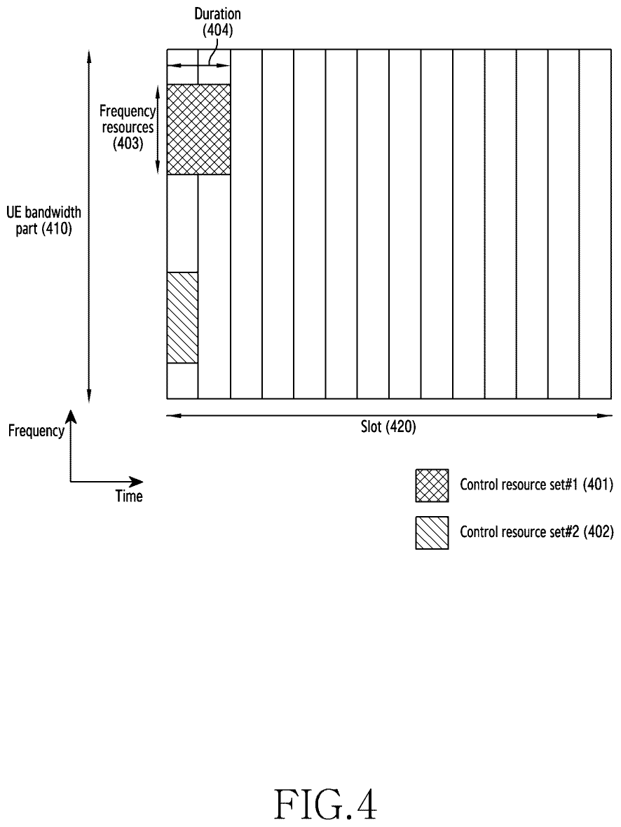

FIG. 4 illustrates an example of a control resource set configuration of a downlink control channel in a wireless communication system according to an embodiment of the disclosure. More specifically, FIG. 4 illustrates an example of a control resource set (CORESET) used to transmit a downlink control channel in a 5G wireless communication system.

FIG. 4 illustrates an example in which a UE bandwidth part 410 is configured along the frequency axis, and two control resource sets (control resource set #1 401 and control resource set #2 402) are configured within one slot 420 along the time axis. The control resource sets 401 and 402 may be configured in a specific frequency resource 403 within the entire UE bandwidth part 410 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the following pieces of information may be included.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| precoderGranularity | ENUMERATED {sameAsRE |
| G-bundle, allContiguousRBs}, | |
| interleaverSize | ENUMERATED {n2, n3, n6} |
| shiftIndex | INTEGER(0..maxNrofPhysicalRe |
| sourceBlocks-1) | OPTIONAL |

},

| | |
|---|---|
| nonInterleaved | NULL |

},

| | |
|---|---|
| tci-StatesPDCCH | SEQUENCE(SIZE (1..maxNrofTCI-S |
| tatesPDCCH)) OF TCI-StateId | OPTIONAL, |
| tci-PresentInDCI | ENUMERATED {enabled} |
| OPTIONAL, | ... Need S |

}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

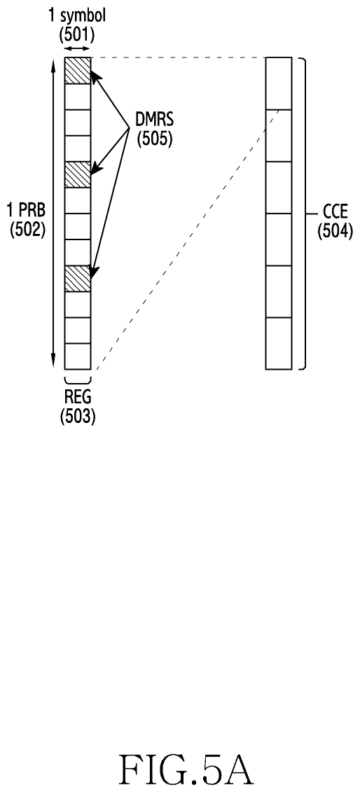

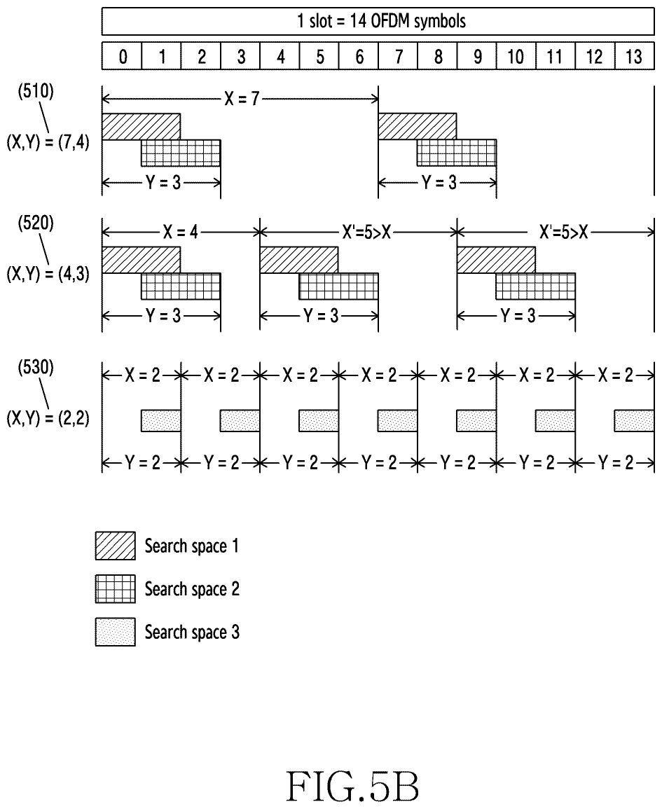

FIG. 5A illustrates a structure of a downlink control channel in a wireless communication according to an embodiment of the disclosure. More specifically, FIG. 5A illustrates an example of a basic unit of time and frequency resources constituting a downlink control channel available in a 5G system.

Referring to FIG. 5A, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5A, one CCE 504 may include multiple REGs 503. To describe the REG 503 illustrated in FIG. 5A, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5A, that is, the REG 503, may include both REs to which DCI is mapped, and an area to which a reference signal (DMRS 505) for decoding the same is mapped. As in FIG. 5A, three DRMSs 505 may be transmitted inside one REG 503. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs may be defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the following pieces of information may be included.

TABLE 9

| | |
|---|---|
| SearchSpace ::= | SEQUENCE { |

-- Identity of the search space. SearchSpaceId = 0 identifies the SearchSpace configure
d via PBCH (MIB) or ServingCellConfigCommon.

| | |
|---|---|
| searchSpaceId | SearchSpaceId, |
| controlResourceSetId | ControlResourceSetId, |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration | INTEGER (2..2559) |
| monitoringSymbolsWithinSlot | BIT STRING (SIZE (14)) |
| | OPTIONAL, |
| nrofCandidates | SEQUENCE { |
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

n6, n8}
},

| | |
|---|---|
| searchSpaceType | CHOICE { |

-- Configures this search space as common search space (CSS) and DCI formats to
monitor.

| | |
|---|---|
| common | SEQUENCE { |

}

| | |
|---|---|
| ue-Specific | SEQUENCE { |

-- Indicates whether the UE monitors in this USS for DCI formats 0-0 and 1-0
or for formats 0-1 and 1-1.

| | |
|---|---|
| formats | ENUMERATED {formats0-0-And-1- |

0, formats0-1-And-1-1},
...
}

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

Combinations of DCI formats and RNTIs given below may be monitored in a UE-specific search space. Obviously, the examples given below are not limiting.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) |
| | and OFDM symbol(s) where UE may assume |
| | no transmission is intended for the UE |
| 2_2 | Transmission of TPC commands for PUCCH |
| | and PUSCH |
| 2_3 | Transmission of a group of TPC commands |
| | for SRS transmissions by one or more UEs |

In a 5G system, the search space at aggregation level L in connection with CORESET p and search space set s may be expressed by Equation 2 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 2$$

L: aggregation level
n_{CI}: carrier index
N_{CCE,p}: total number of CCEs existing in control resource set p

$${n}_{s , f}^{μ} :$$

slot index

$$- {M}_{s , max}^{( L )} :$$

M_{s,max}^{(L)}: number of PDCCH candidates at aggregation level L
m_{s,n}_{_{CI}}=0, . . . ,

$${M}_{s , max}^{( L )} - 1 :$$

PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D .$$

Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### PDCCH: Span

The UE may perform UE capability reporting at each subcarrier spacing with regard to a case in which the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be expressed by (X,Y) wherein X refers to the minimum number of symbols by which the first symbols of two consecutive spans are spaced apart from each other, and Y refers to the number of consecutive symbols in which a PDCCH can be monitored within one span. The UE may monitor the PDCCH in a range inside a span corresponding to Y symbols from the first symbol of the span.

FIG. 5B illustrates, in terms of spans, a case in which a UE may have multiple PDCCH monitoring occasions inside a slot in a wireless communication system according to an embodiment of the disclosure.

According to various embodiments of the disclosure, possible spans are (X,Y)=(7,3), (4,3), (2,2), and the three cases may be indicated by (510), (520), and (530) in FIG. 5B, respectively. As an example, (510) describes a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. As another example, (520) describes a case in which there are a total of three spans described by (4,3) inside a slot, and the second and third spans are spaced apart by X′=5 symbols which are larger than X=4. Similarly, (530) describes a case in which there is a span described by (2,2) inside a slot.

### PDCCH: UE Capability Report

The slot location at which the above-described common search space and the UE-specific search space are positioned is indicated by parameter “monitoringSymbolsWitninSlot” in Table 11-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.
UE capability 1 (hereinafter referred to as FG 3-1). This UE capability may have the following meaning: if there is one monitoring occasion (MO) regarding type 1 and type 3 common search spaces or UE-specific search spaces inside a slot, as in Table 11 below, the UE can monitor the corresponding MO when the corresponding MO is located inside the first three symbols inside the slot. This UE capability is a mandatory capability which is to be supported by all UEs that support NR, and whether or not UE capability 1 is supported is not explicitly reported to the base station.

TABLE 11-1

| | Feature | | Field name in |
|---|---|---|---|
| Index | group | Components | TS 38.331 [2] |
| 3-1 | Basic DL | 1) One configured CORESET per BWP per | n/a |
| | control | cell in addition to CORESET0 | |
| | channel | CORESET resource allocation of 6RB bit- | |
| | | map and duration of 1-3 OFDM symbols for | |
| | | FR1 | |
| | | For type 1 CSS without dedicated RRC | |
| | | configuration and for type 0, 0A, and 2 CSSs, | |
| | | CORESET resource allocation of 6RB bit- | |
| | | map and duration 1-3 OFDM symbols for FR2 | |
| | | For type 1 CSS with dedicated RRC | |
| | | configuration and for type 3 CSS, UE specific | |
| | | SS, CORESET resource allocation of 6RB bit- | |
| | | map and duration 1-2 OFDM symbols for FR2 | |
| | | REG-bundle sizes of 2/3 RBs or 6 RBs | |
| | | Interleaved and non-interleaved CCE-to- | |
| | | REG mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a | |
| | | scheduled SCell per BWP | |
| | | This search space limit is before applying all | |
| | | dropping rules. | |
| | | For type 1 CSS with dedicated RRC | |
| | | configuration, type 3 CSS, and UE-SS, the | |
| | | monitoring occasion is within the first 3 | |
| | | OFDM symbols of a slot | |
| | | For type 1 CSS without dedicated RRC | |
| | | configuration and for type 0, 0A, and 2 CSS, | |
| | | the monitoring occasion can be any OFDM | |
| | | symbol(s) of a slot, with the monitoring | |
| | | occasions for any of Type 1- CSS without | |
| | | dedicated RRC configuration, or Types 0, 0A, | |
| | | or 2 CSS configurations within a single span | |
| | | of three consecutive OFDM symbols within a | |
| | | slot | |
| | | 3) Monitoring DCI formats 0_0, 1_0, 0_1, 1_1 | |
| | | 4) Number of PDCCH blind decodes per slot | |
| | | with a given SCS follows Case 1-1 table | |
| | | 5) Processing one unicast DCI scheduling DL | |
| | | and one unicast DCI scheduling UL per slot | |
| | | per scheduled CC for FDD | |
| | | 6) Processing one unicast DCI scheduling DL | |
| | | and 2 unicast DCI scheduling UL per slot per | |
| | | scheduled CC for TDD | |

UE capability 2 (hereinafter referred to as FG 3-2). This UE capability has the following meaning: if there is one monitoring occasion (MO) regarding a common search space or a Ug-specific search space inside a slot, as in Table 11-2 below, the UE can monitor the corresponding MO no matter what of the start symbol location of the corresponding MO may be. This UE capability is optionally supported by the UE, and whether or not this UE capability is supported is explicitly reported to the base station.

TABLE 11-2

| | Feature | | Field name in |
|---|---|---|---|
| Index | group | Components | TS 38.331 [2] |
| 3-2 | PDCCH monitoring | For a given UE, all search space | pdcchMonitoringSingleOccasion |
| | on any span of | configurations are within the | |
| | up to 3 | same span of 3 consecutive | |
| | consecutive OFDM | OFDM symbols in the slot | |
| | symbols of a slot | | |

UE capability 3 (hereinafter, referred to as FG 3-5, 3-5a, or 3-5b). This UE capability has the following meaning: if there are multiple monitoring occasions (MO) regarding a common search space or a U-specific search space inside a slot, as in Table 11-3 below, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. This UE capability is optionally supported by the Ua, and whether or not this UE capability is supported and the above-mentioned combination of (X,Y) are explicitly reported to the base station.

TABLE 11-3

| | Feature | | Field name in |
|---|---|---|---|
| Index | group | Components | TS 38.331 [2] |
| 3-5 | For type 1 CSS with | For type 1 CSS with dedicated | pdcch- |
| | dedicated RRC | RRC configuration, type 3 CSS, | MonitoringAnyOccasions |
| | configuration, | and UE-SS, monitoring occasion | {3-5. withoutDCI-Gap |
| | type 3 CSS, | can be any OFDM symbol(s) of a | 3-5a. withDCI-Gap} |
| | and UE-SS, | slot for Case 2 | |
| | monitoring | | |
| | occasion can | | |
| | be any OFDM | | |
| | symbol(s) of | | |
| | a slot for | | |
| | Case 2 | | |
| 3-5a | For type 1 | For type 1 CSS with dedicated | |
| | CSS with | RRC configuration, type 3 CSS and | |
| | dedicated RRC | UE-SS, monitoring occasion can be | |
| | configuration, | any OFDM symbol(s) of a slot for | |
| | type 3 CSS, | Case 2, with minimum time | |
| | and UE-SS, | separation (including the cross-slot | |
| | monitoring | boundary case) between two DL | |
| | occasion can | unicast DCIs, between two UL | |
| | be any OFDM | unicast DCIs, or between a DL and | |
| | symbol(s) of | an UL unicast DCI in different | |
| | a slot for | monitoring occasions where at least | |
| | Case 2 with a | one of them is not the monitoring | |
| | DCI gap | occasions of FG-3-1, for a same UE | |
| | | as | |
| | | 2OFDM symbols for 15 kHz | |
| | | 4OFDM symbols for 30 kHz | |
| | | 7OFDM symbols for 60 kHz | |
| | | with NCP | |
| | | 11OFDM symbols for | |
| | | 120 kHz | |
| | | Up to one unicast DL DCI and up | |
| | | to one unicast UL DCI in a | |
| | | monitoring occasion except for the | |
| | | monitoring occasions of FG 3-1. | |
| | | In addition for TDD the minimum | |
| | | separation between the first two UL | |
| | | unicast DCIs within the first 3 | |
| | | OFDM symbols of a slot can be | |
| | | zero OFDM symbols. | |

The UE may report whether the above-described capability 2 or capability 3 are supported and relevant parameters to the base station. The base station may allocate time-domain resources to the common search space and the UE-specific search space, based on the UE capability report. According to an embodiment, during the resource allocation, the base station may ensure that the MO is not positioned not at a location at which the UE cannot monitor the same.

### PDCCH: BD/CCE Limit

If there are multiple search space sets configured for a UE, the following conditions may be considered in connection with a method for determining a search space set to be monitored by the UE.

According to an embodiment, if the value of “monitoringCapabilityConfig-r16” (upper layer signaling) has been configured to be “r15monitoringcapability” for the UE, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each slot. According to an embodiment, if the value of “monitoringCapabilityConfig-r16” has been configured to be “r16monitoringcapability”, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each span.

### Condition 1: Maximum Number of PDCCH Candidates Limited

According to the above-mentioned upper layer signaling configuration value, the maximum number Mμ of PDCCH candidates that the UE can monitor may follow Table 12-1 given below if the same is defined with reference to a slot in a cell configured to have a subcarrier spacing of 15·2μ kHz, and may follow Table 12-2 given below if the same is defined with reference to a span.

TABLE 12-1

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination | | |
| | (X, Y) and per serving cell | | |
| μ | (2, 2) | (4, 3) | (7, 3) |
| 0 | 14 | 28 | 44 |
| 1 | 12 | 24 | 36 |

### Condition 2: Maximum Number of CCEs Limited

According to the above-mentioned upper layer signaling configuration value, the maximum number Cp. of CCEs constituting the entire search space (as used herein, the entire search space refers to the entire CCE set corresponding to a union domain of multiple search space sets) may follow Table 12-3 given below if the same is defined with reference to a slot in a cell configured to have a subcarrier spacing of 15·2μ kHz, and may follow Table 12-4 given below if the same is defined with reference to a span.

TABLE 12-3

| | Maximum number of non-overlapped |
|---|---|
| | CCEs per slot and |
| μ | per serving cell (C^{μ}) |
| 0 | 56 |
| 1 | 56 |
| 2 | 48 |
| 3 | 32 |

TABLE 12-4

| | Maximum number C^{μ} of non-overlapped | | |
|---|---|---|---|
| | CCEs per span for combination | | |
| | (X, Y) and per serving cell | | |
| μ | (2, 2) | (4, 3) | (7, 3) |
| 0 | 18 | 36 | 56 |
| 1 | 18 | 36 | 56 |

For the sake of descriptive convenience, a situation satisfying both conditions 1 and 2 above at a specific timepoint may be defined as “condition A”. Therefore, the description that condition A is not satisfied may mean that at least one of conditions 1 and 2 above is not satisfied.

### PDCCH: Overbooking

According to the configuration of search space sets of the base station, a case in which condition A is not satisfied may occur at a specific timepoint. If condition A is not satisfied at a specific timepoint, the UE may select and monitor only some of search space sets configured to satisfy condition A at the corresponding timepoint, and the base station may transmit a PDCCH to the selected search space set.

A method for selecting some search spaces from all configured search space sets may follow methods given below.

If condition A regarding a PDCCH fails to be satisfied at a specific timepoint (slot), the UE (or the base station) may preferentially select a search space set having a search space type configured as a common search space, among search space sets existing at the corresponding timepoint, over a search space set configured as a UE-specific search space.

If all search space sets configured as common search spaces have been selected (that is, if condition A is satisfied even after all search spaces configured as common search spaces have been selected), the UE (or the bae station) may select search space sets configured as UE-specific search spaces. If there are multiple search space sets configured as UE-specific search spaces, a search space set having a lower search space set index may have a higher priority. UE-specific search space sets may be selected as long as condition A is satisfied, in consideration of the priority.

### QCL, TCI State

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 13 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 13 below.

TABLE 13

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 14 below. Referring to Table 14, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 13 above.

TABLE 14

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, - |
| - Need R | | |
| ... | | |
| } | | |
| QCL-Info ::= | SEQUENCE { | |
| cell | ServCellIndex | OPTIONAL, -- |

| Need R | |
|---|---|
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, |

typeD},
...
}

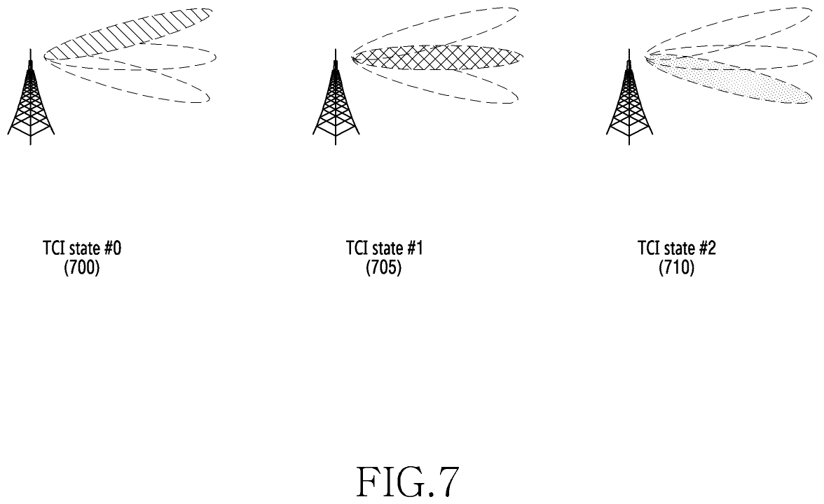

FIG. 7 illustrates an example of base station beam allocation according to TCI state configuration in a wireless communication system according to an embodiment of the disclosure. Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Tables 15-1 to 15-5 below enumerate valid T state configurations according to the target antenna port type.

Table 15-1 enumerates valid TCI state configurations when the target antenna port is a CSI-RS for tracking (TRS) The TRS refers to an NZP CSI-RS which has no repetition parameter configured therefor, and trs-Info of which is configured as “true”, among CRI-RSs. In Table 15-1, configuration no. 3 may be used for an aperiodic TRS.

TABLE 15-1
Valid TCI state configurations when the target
antenna port is a CSI-RS for tracking (TRS)

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 enumerates valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CRI-RSs.

TABLE 15-2
Valid TCI state configurations when the
target antenna port is a CSI-RS for CSI

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 enumerates valid TCI state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of“on” or “off”, and trs-Info of which is not configured as “true”, among CRI-RSs.

TABLE 15-3
Valid TCI state configurations when the target antenna
port is a CSI-RS for BM (for L1 RSRP reporting)

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 15-4 enumerates valid TCI state configurations when the target antenna port is a PDCCH DMRS.

TABLE 15-4
Valid TCI state configurations when the
target antenna port is a PDCCH DMRS

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 enumerates valid TCI state configurations when the target antenna port is a PDSCH DMRS.

TABLE 15-5
Valid TCI state configurations when the
target antenna port is a PDSCH DMRS

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

According to a representative QCL configuration method based on Tables 15-1 to 15-5 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### PDCCH: Regarding TCI State

Specific TCI state combinations applicable to a PDCCH DMRS antenna port may be given in Table 16 below. The fourth row in Table 16 corresponds to a combination assumed by the UE before RRC configuration, and no configuration is possible after the RRC.

TABLE 16

| Valid TCI | | | DL RS 2 | qcl-Type2 |
|---|---|---|---|---|
| state | DL | qcl- | (If | (If |
| Configuration | RS 1 | Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH | QCL-TypeD |
| | Block | | Block | |

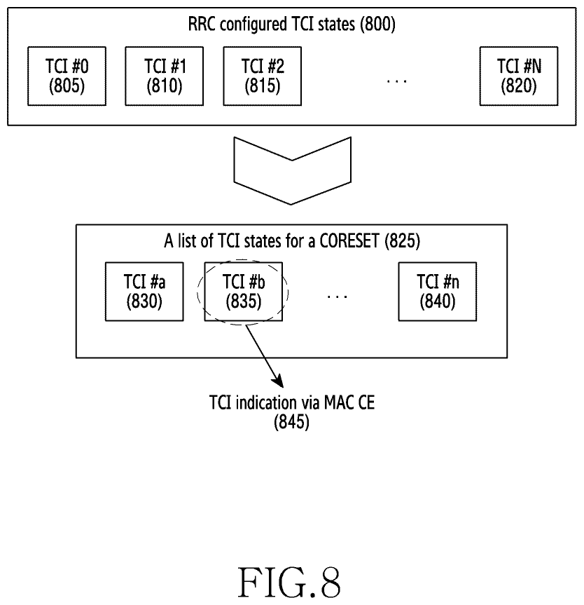

FIG. 8 illustrates an example of a method for TCI state allocation with regard to a PDCCH in a wireless communication system according to an embodiment of the disclosure.

In NR, a hierarchical signaling method as illustrated in FIG. 8 is supported for dynamic allocation regarding a PDCCH beam. Referring to FIG. 8, the base station may configure N TCI states 805, 810, 815, . . . , 820 for the UE through RRC signaling 800, and may configure some thereof as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

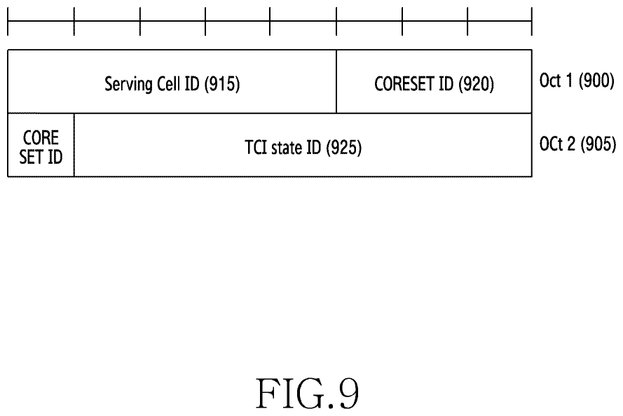

FIG. 9 illustrates a TCI indication MAC CE signaling structure for a PDCCH DMRS in a wireless communication system according to an embodiment of the disclosure. More specifically, FIG. 9 illustrates a TCI indication MAC CE signaling structure for a PDCCH DMRS.

Referring to FIG. 9, the TCI indication MAC CE signaling for the PDCCH DMRS may be configured by 2 bytes (16 bits) 900 and 905, and include a 5-bit serving cell ID 915, a 4-bit CORESET ID 920, and a 7-bit TCI state ID 925.

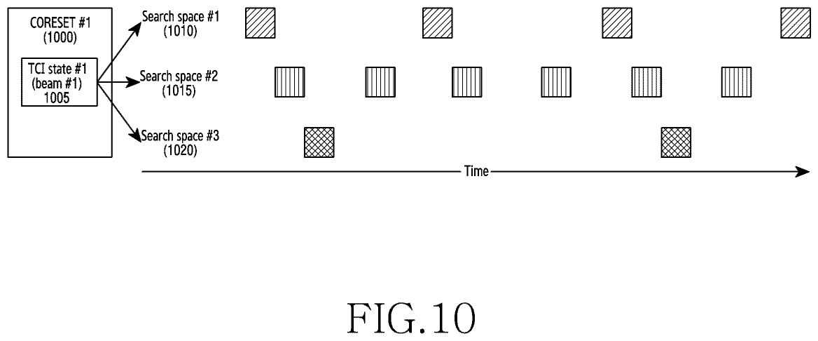

FIG. 10 illustrates an example of beam configuration with regard to a control resource set and a search space in a wireless communication system according to an embodiment of the disclosure. More specifically, FIG. 10 illustrates an example of beam configuration with regard to a control resource set (CORESET) and a search space according to the above description. Referring to FIG. 10, the base station may indicate one of TCI state lists included in CORESET #1 (1000) configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding CORESET, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block (SSB) identified in the initial access process or in a non-contention-based random access process not triggered by a PDCCH command.

With regard to a control resource set having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### PDCCH: Regarding QCL Prioritization Rule

Hereinafter, operations for determining QCL priority regarding a PDCCH will be described in detail.

If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.

Criterion 1. A control resource set connected to a common search space having the lowest index inside a cell corresponding to the lowest index among cells including a common search space

Criterion 2. A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2.

According to an embodiment, if selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

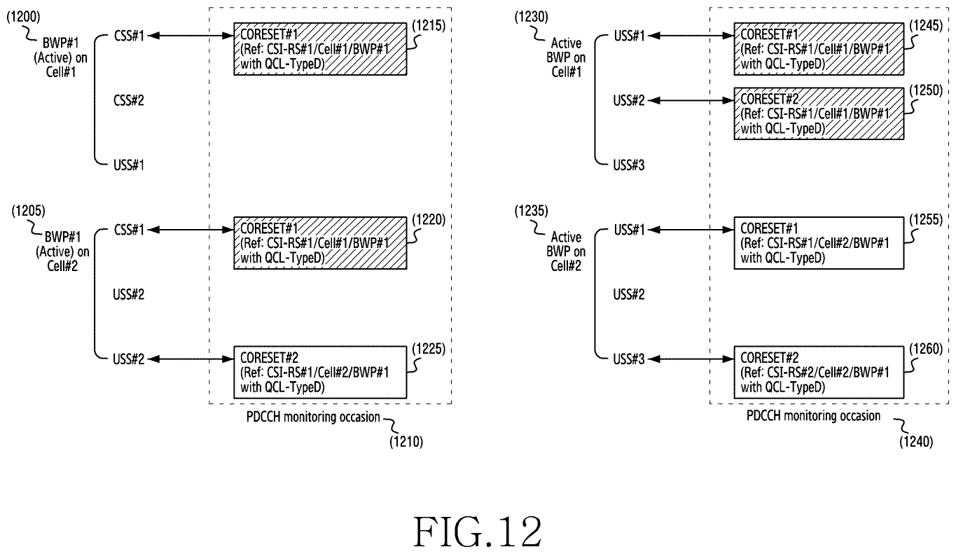

FIG. 12 illustrates an example of a method in which, upon receiving a downlink control channel, a UE selects a receivable control resource set in consideration of priority in a wireless communication system according to an embodiment of the disclosure.

According to an embodiment, as an example, the UE may be configured to receive multiple control resource sets overlapping temporally in a specific PDCCH monitoring occasion, and such multiple control resource sets may be connected to a common search space or a UE-specific search space with regard to multiple cells. In the corresponding PDCCH monitoring occasion, control resource set no. 1 1215 connected to common search space no. 1 may exist in bandwidth part no. 1 1200 of cell no. 1, and control resource set no. 1 1215 connected to common search space no. 1 and control resource set no. 2 1220 connected to UE-specific search space no. 2 may exist in bandwidth part no. 1 1225 of cell no. 2. The control resource sets 1215 and 1220 may have a relation of QCL-TypeD with CSI-RS resource no. 1 configured in bandwidth part no. 1 of cell no. 1, and the control resource set 1225 may have a relation of QCL-TypeD with CSI-RS resource no. 1 configured in bandwidth part no. 1 of cell no. 2. If criterion 1 is applied to the corresponding PDCCH monitoring occasion 1210, all other control resource sets having the same reference signal of QCL-TypeD as control resource set no. 1 1215 may be received. Therefore, the UE may receive the control resource sets 1210 and 1215 in the corresponding PDCCH monitoring occasion 1220.

According to an embodiment, as another example, the UE may be configured to receive multiple control resource sets overlapping temporally in a specific PDCCH monitoring occasion, and such multiple control resource sets may be connected to a common search space or a UE-specific search space with regard to multiple cells. In the corresponding PDCCH monitoring occasion, control resource set no. 1 1230 connected to UE-specific search space no. 1 and control resource set no. 2 1245 connected to UE-specific search space no. 2 may exist in bandwidth part no. 1 1250 of cell no. 1, and control resource set no. 1 1235 connected to UE-specific search space no. 1 and control resource set no. 2 1255 connected to UE-specific search space no. 3 may exist in bandwidth part no. 1 1260 of cell no. 2. The control resource sets 1245 and 1250 may have a relation of QCL-TypeD with CSI-RS resource no. 1 configured in bandwidth part no. 1 of cell no. 1, the control resource set 1255 may have a relation of QCL-TypeD with CSI-RS resource no. 1 configured in bandwidth part no. 1 of cell no. 2, and the control resource set 1260 may have a relation of QCL-TypeD with CSI-RS resource no. 2 configured in bandwidth part no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other control resource sets having the same reference signal of QCL-TypeD as control resource set no. 1 1245 may be received. Therefore, the UE may receive the control resource sets 1240 and 1245 in the corresponding PDCCH monitoring occasion 1250.

### Regarding Rate Matching/Puncturing

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

Rate matching operation

According to an embodiment, the base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

According to an embodiment, the UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3}(corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3}(corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

According to an embodiment, the UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3}(corresponding to resource C) is not transmitted, and based on the assumption that symbol sequence {symbol #1, symbol #2, symbol #4} corresponding to remaining resources {resource #1, resource #2, resource #4} other than {resource #3}(corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

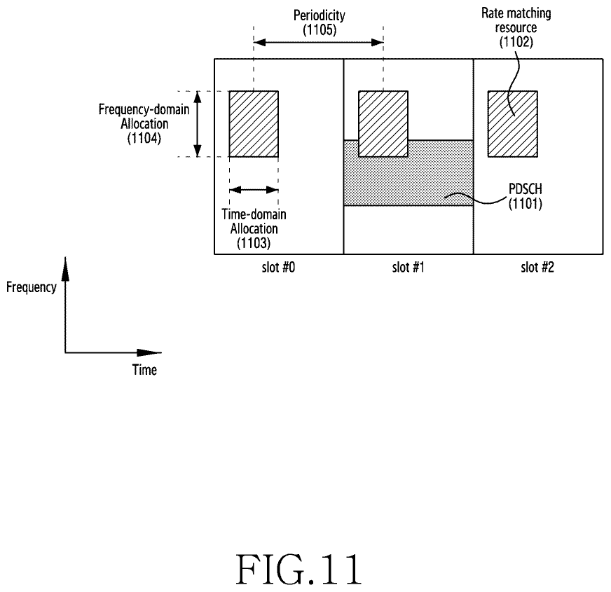

FIG. 11 illustrates an example of a method in which a base station and a UE transmit/receive data in consideration of a downlink data channel and a rate matching resource in a wireless communication system according to an embodiment of the disclosure.

FIG. 11 illustrates a downlink data channel (PDSCH) 1101 and a rate matching resource 1102. The base station may configure one or multiple rate matching resources 1102 for the UE through upper layer signaling (for example, RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 602, the base station may rate-match and transmit the PDSCH 1101 in a rate matching resource 1102 part, and the UE may perform reception and decoding after assuming that the PDSCH 1102 has been rate-matched in a rate matching resource 1102 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

According to an embodiment, the UE may have a maximum of four RateMatchPatterns configured per each bandwidth part through upper layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

According to an embodiment, the UE may have the following contents configured through upper layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### Regarding LTE CRS Rate Match

Next, a rate matching process regarding the above-mentioned LTE CRS will be described in detail. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR provides a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 17 shows a ServingCellConfig IE including the CRS patterns, and Table 18 shows a RateMatchPatternLTE-CRS IE including at least one parameter regarding CRS patterns.

TABLE 17

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |
| BWP-Id | OPTIONAL, -- Need N |
| downlinkBWP-ToAddModList | SEQUENCE (SIZE (1..maxNrofBWPs)) |
| OF BWP-Downlink | OPTIONAL, -- Need N |
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, |

ms6, ms8, ms10, ms20, ms30,

ms40,ms50, ms60, ms80,ms100,

ms200,ms300, ms500,

ms750, ms1280, ms1920,

ms2560, spare10, spare9, spare8,

| | |
|---|---|
| | spare7, spare6, spare5, |
| spare4, spare3, spare2, spare1 } | OPTIONAL, --Need R |
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH- |
| ServingCellConfig } | OPTIONAL, -- Need M |
| pdsch-ServingCellConfig | SetupRelease { PDSCH- |
| ServingCellConfig } | OPTIONAL, -- Need M |
| csi-MeasConfig | SetupRelease { CSI-MeasConfig } |

OPTIONAL, -- Need M

| | |
|---|---|
| sCellDeactivationTimer | ENUMERATED {ms20, ms40, ms80, |

ms160, ms200, ms240,

ms320, ms400, ms480, ms520,

ms640, ms720,

ms840, ms1280, spare2,spare1}

OPTIONAL, -- Cond ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { RateMatchPatternLTE- |
| CRS } | OPTIONAL, -- Need M |
| rateMatchPatternToAddModList | SEQUENCE (SIZE |
| (1..maxNrofRateMatchPatterns)) OF RateMatchPattern | OPTIONAL, -- Need |

N

| | |
|---|---|
| rateMatchPatternToReleaseList | SEQUENCE (SIZE |
| (1..maxNrofRateMatchPatterns)) OF RateMatchPatternId | OPTIONAL, -- Need |

N

| | |
|---|---|
| downlinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL- |
| ConfigDedicated-IAB-MT-r16 | OPTIONAL, -- Cond TDD_IAB |
| dormantBWP-Config-r16 | SetupRelease { DormantBWP-Config- |
| r16 } | OPTIONAL, -- Need M |
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}
OPTIONAL, -- Cond AsyncCA

| | |
|---|---|
| channelAccessConfig-r16 | SetupRelease { |
| ChannelAccessConfig-r16 } | OPTIONAL, -- Need M |
| intraCellGuardBandsDL-List-r16 | SEQUENCE (SIZE (1..maxSCSs)) |
| OF IntraCellGuardBandsPerSCS-r16 | OPTIONAL, -- Need S |
| intraCellGuardBandsUL-List-r16 | SEQUENCE (SIZE (1..maxSCSs)) |
| OF IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS- |
| PatternList-r16 } | OPTIONAL, -- Need M |
| lte-CRS-PatternList2-r16 | SetupRelease { LTE-CRS- |
| PatternList-r16 } | OPTIONAL, -- Need M |
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R

| | |
|---|---|
| enableDefaultTCI-StatePerCoresetPoolIndex-r16 | ENUMERATED |
| {enabled} | OPTIONAL, -- Need R |
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

TABLE 18
- RateMatchPatternLTE-CRS
The IE RateMatchPatternLTE-CRS is used to configure a pattern to rate match around
LTE CRS. See TS 38.214 [19], clause 5.1.4.2.

RateMatchPatternLTE-CRS information element
-- ASN1START
-- TAG-RATEMATCHPATTERNLTE-CRS-START

| RateMatchPatternLTE-CRS ::= | SEQUENCE { |
|---|---|
| carrierFreqDL | INTEGER (0..16383), |
| carrierBandwidthDL | ENUMERATED {n6, n15, n25, n50, n75, |
| n100, spare2, spare1}, | |
| mbsfn-SubframeConfigList | EUTRA-MBSFN-SubframeConfigList |
| OPTIONAL, -- Need M | |
| nrofCRS-Ports | ENUMERATED {n1, n2, n4}, |
| v-Shift | ENUMERATED {n0, n1, n2, n3, n4, n5} |
| } | |
| LTE-CRS-PatternList-r16 ::= | SEQUENCE (SIZE (1..maxLTE-CRS- |

Patterns-r16)) OF RateMatchPatternLTE-CRS
-- TAG-RATEMATCHPATTERNLTE-CRS-STOP
-- ASN1STOP

RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19],
clause 5.1.4.2).

### PDSCH: Regarding Frequency Resource Allocation

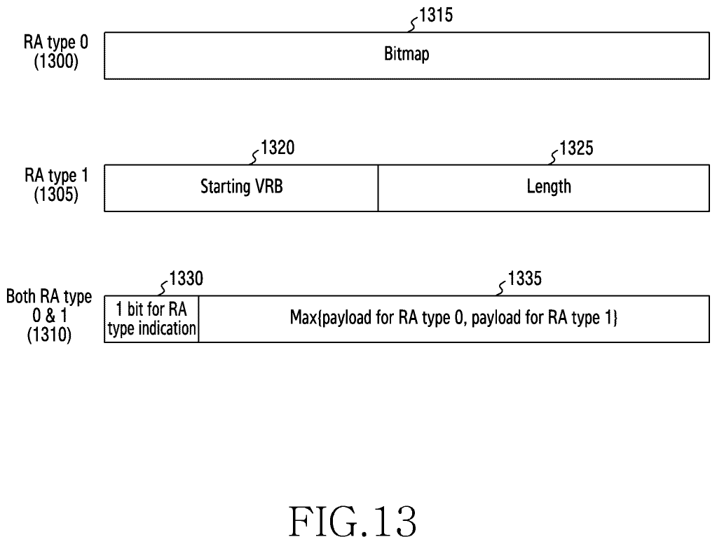

FIG. 13 illustrates an example of frequency domain resource allocation with regard to a physical downlink shared channel (PDSCH) in a wireless communication system according to an embodiment of the disclosure.

FIG. 13 illustrates three frequency domain resource allocation methods of type 0 1300, type 1 1301, and dynamic switch 1310 which can be configured through an upper layer in an NR wireless communication system.

Referring to FIG. 13, in the case in which a UE is configured to use only resource type 0 through upper layer signaling (1300), partial downlink control information (DCI) for allocating a PDSCH to the UE include a bitmap including NRBG bits. The conditions for this will be described again later. As used herein, N_{RBG} refers to the number of resource block groups (RBGs) determined according to the BWP size allocated by a BWP indicator and upper layer parameter rbg-Size, as in Table 19 below, and data is transmitted in RBGs indicated as “1” by the bitmap.

TABLE 19

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case in which the UE is configured to use only resource type 1 through upper layer signaling (1305), partial DCI includes frequency domain resource allocation information including

$$[ {log}_{2} ( {N}_{R B}^{DL , BWP} ( {N}_{R B}^{DL , BWP} + 1 ) / 2 ] bits .$$

The conditions for this will be described again later. The base station may thereby configure a starting VRB 1320 and the length 1325 of a frequency domain resource allocated continuously therefrom.

In the case in which the UE is configured to use both resource type 0 and resource type 1 (1310) through upper layer signaling, partial DCI for allocating a PDSCH to the corresponding UE includes frequency domain resource allocation information including as many bits as the larger value 1335 between the payload 1315 for configuring resource type 0 and the payload 1320 and 1325 for configuring resource type 1. The conditions for this will be described again later. One bit 1330 may be added to the foremost part (MSB) of the frequency domain resource allocation information inside the DCI, and if the bit has the value of “0”, use of resource type 0 may be indicated, and if the bit has the value of “1”, use of resource type 1 may be indicated.

### PDSCH/PUSCH: Regarding Time Resource Allocation

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 20 or Table 21 below may be transmitted from the base station to the UE.

TABLE 20
PDSCH-TimeDomainResourceAllocationList information element

| | | |
|---|---|---|
| PDSCH-TimeDomainResourceAllocationList | ::= | SEQUENCE |

(SIZE(1..maxNrofDL-Allocations)) OF
PDSCH-TimeDomainResourceAllocation

| | |
|---|---|
| PDSCH-TimeDomainResourceAllocation ::= | SEQUENCE { |

| | |
|---|---|
| k0 | INTEGER(0..32) |

OPTIONAL, -- Need S

| | |
|---|---|
| mappingType | ENUMERATED {typeA, typeB}, |
| startSymbolAndLength | INTEGER (0..127) |

}

TABLE 21
PUSCH-TimeDomainResourceAllocationList information element

| | | |
|---|---|---|
| PUSCH-TimeDomainResourceAllocationList | ::= | SEQUENCE |

(SIZE(1..maxNrofUL-Allocations)) OF
PUSCH-TimeDomainResourceAllocation

| PUSCH-TimeDomainResourceAllocation ::= | SEQUENCE { | |
|---|---|---|
| k2 | INTEGER(0..32) | OPTIONAL, |

-- Need S

| | |
|---|---|
| mappingType | ENUMERATED {typeA, typeB}, |
| startSymbolAndLength | INTEGER (0..127) |

}

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

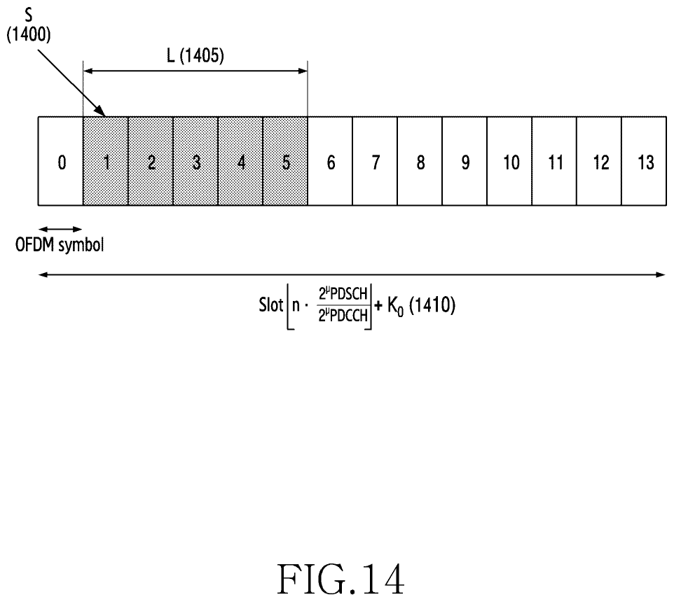

FIG. 14 illustrates an example of time domain resource allocation with regard to a PDSCH in a wireless communication system according to an embodiment of the disclosure.

Referring to FIG. 14, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 1400 and length 1405 within one slot 1410 dynamically indicated through DCI.

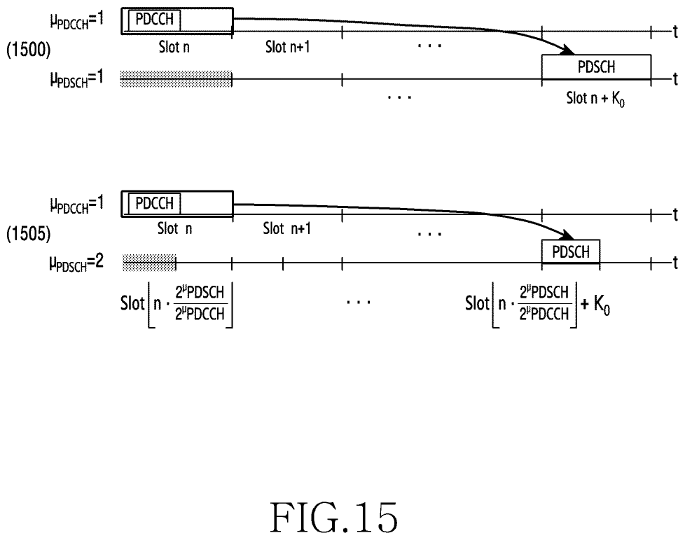

FIG. 15 illustrates an example of time domain resource allocation according to a subcarrier spacing with regard to a data channel and a control channel in a wireless communication system according to an embodiment of the disclosure.

Referring to FIG. 15, if the data channel and the control channel have the same subcarrier spacing (1500, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (1505, μ_{PDSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### PDSCH: TCI State Activation MAC-CE

Next, a beam configuration method regarding a PDSCH will be described.

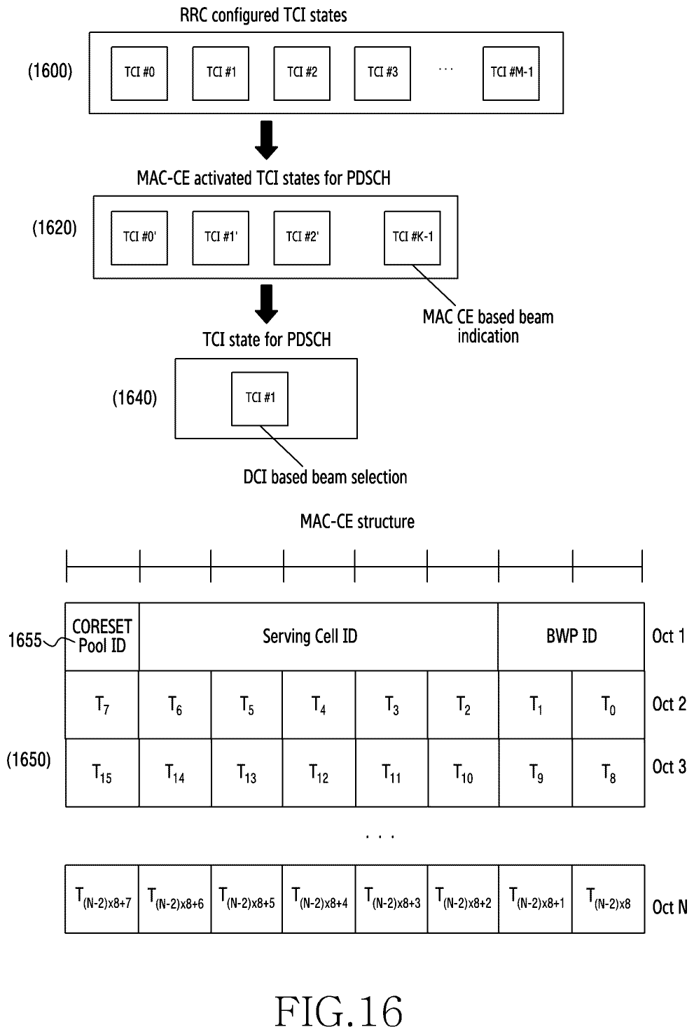

FIG. 16 illustrates a process for beam configuration and activation with regard to a PDSCH in a wireless communication system according to an embodiment of the disclosure; A list of TCI states regarding a PDSCH may be indicated through an upper layer list such as RRC (1600). The list of TCI states may be indicated by tci-StatesToAddModList and/or tci-StatesToReleaseList inside a BWP-specific PDSCH-Config IE, for example. Next, a part of the list of TCI states may be activated through a MAC-CE (1620). The maximum number of activated TCI states may be determined by the capability reported by the UE. According to an embodiment, one of the activated TCI states may be indicated through DCI (1640).

Also, FIG. 16 illustrates an example of MAC-CE structure 1650 for PDSCH TCI state activation/deactivation.

The meaning of respective fields inside the MAC CE and values configurable for respective fields are as follows.

Serving Cell ID (serving cell identity): This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;

BWP ID (bandwidth part identity): This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;

Ti (TCI state identity): If there is a TCI state with TCI-StateId i as specified in TS 38.331 [5], this field indicates the activation/deactivation status of the TCI state with TCI-StateId i, otherwise MAC entity shall ignore the Ti field. The Ti field is set to 1 to indicate that the TCI state with TCI-StateId i shall be activated and mapped to the codepoint of the DCI Transmission Configuration Indication field, as specified in TS 38.214 [7]. The Ti field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1 and so on. The maximum number of activated TCI states is 8;

CORESET Pool ID (CORESET pool identity): This field indicates that mapping between the activated TCI states and the codepoint of the DCI Transmission Configuration Indication set by field Ti is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORESET Pool ID field shall be ignored when receiving the MAC CE.

### PUSCH: Regarding Transmission Scheme

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 22 through upper signaling. If PUSCH transmission is operated by a configured grant, parameters applied to the PUSCH transmission are applied through configuredGrantConfig (upper signaling) in Table 22 except for dataScramblingIdentityPUSCH, txConfig, codebookSubset, maxRank, and scaling of UCI-OnPUSCH, which are provided by pusch-Config (upper signaling) in Table 23. If provided with transformPrecoder inside configuredGrantConfig (upper signaling) in Table 22, the UE applies tp-pi2BPSK inside pusch-Config in Table 23 to PUSCH transmission operated by a configured grant.

TABLE 22

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym 160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 23, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 23, the UE does not expect scheduling through DCI format 0_1.

TABLE 23

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent′” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### Regarding UE Capability Report

In LTE and NR, a UE may perform a procedure in which, while being connected to a serving base station, the UE may report capability supported by the UE to the corresponding base station. In the following description, the above-described procedure will be referred to as a UE capability report.

According to an embodiment, the base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step is applied in MR-DC as well, that is, LTE bands are also applied. BCs remaining after the above step constitute the final “candidate BC list”.

4. The UE may select BCs appropriate for the requested RAT type from the final “candidate BC list” and select BCs to report. In this step, the UE configures supportedBandCombinationList in a determined order. That is, the UE configures BCs and UE capability to report according to a preconfigured rat-Type order (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

### Regarding CA/DC

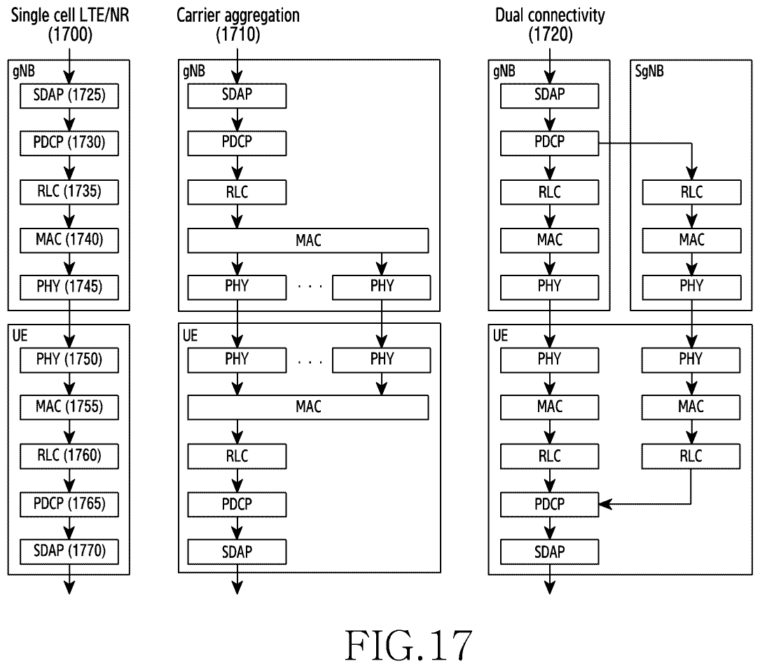

FIG. 17 illustrates radio protocol structures of a base station and a UE in single cell, carrier aggregation, and dual connectivity situations in a wireless communication system according to an embodiment of the disclosure.

Referring to FIG. 17, the radio protocol of a next-generation mobile communication system includes an NR service data adaptation protocol (SDAP) 1725 or 1770, an NR packet data convergence protocol (PDCP) 1730 or 1765, an NR radio link control (RLC) 1735 or 1760, and an NR medium access controls (MAC) 1740 or 1755, on each of UE and NR base station sides.

The main functions of the NR SDAP 1725 or 1770 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1730 or 1765 may include some of the following functions: below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 1735 or 1760 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of delivering RLC SDUs, received from the lower layer, to the upper layer in sequence. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery function of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1740 or 1755 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1745 or 1750 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 1700. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1710. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 1720.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, embodiments of the disclosure will be described in detail in conjunction with the accompanying drawings The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling”, “PDCP signaling”, or “MAC control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### Regarding NC-JT

According to an embodiment of the disclosure, in order to receive a PDSCH from a plurality of TRPs, the UE may use non-coherent joint transmission (NC-JT).

A 5G wireless communication system may support all of the service having very short transmission latency and the service requiring a high connectivity density as well as the service requiring a high transmission rate unlike the conventional system. In a wireless communication network including a plurality of cells, transmission and reception points (TRPs), or beams, coordinated transmission between respective cells, TRPs, and/or beams may satisfy various service requirements by increasing the strength of a signal received by the UE or efficiently controlling interference between the cells, TRPs, and/or beams.

Joint transmission (JT) is a representative transmission technology for the coordinated communication and may increase the strength of a signal received by the UE or throughput by transmitting signals to one UE through different cells, TRPs, and/or beams. Here, a channel between respective cells, TRPs, and/or beam and the UE may have different characteristics, and particularly, non-coherent joint transmission (NC-JT) supporting non-coherent precoding between respective cells, TRPs, and/or beams may need individual precoding, MCS, resource allocation, and TCI indication according to the channel characteristics for each link between respective cells, TRPs, and/or beam and the UE.

The above-described NC-JT transmission may be applied to at least one of a downlink data channel (PDSCH), a downlink control channel (PDCCH), an uplink data channel (PUSCH), and an uplink control channel (PUCCH). During PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

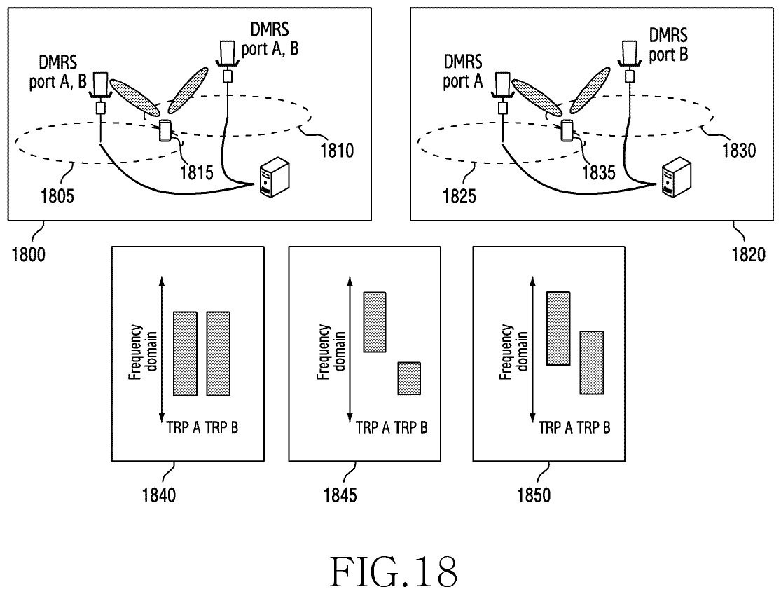

FIG. 18 illustrates a configuration of antenna ports and an example of resource allocation for transmitting a PDSCH using cooperative communication in a wireless communication system according to an embodiment of the disclosure.

Referring to FIG. 18, the example for PDSCH transmission is described for each scheme of joint transmission (JT), and examples for allocating radio resources for each TRP are described.

Referring to FIG. 18, an example 1800 of coherent joint transmission (C-JT) supporting coherent precoding between respective cells, TRPs, and/or beams is illustrated.

In the case of C-JT, a TRP A 1805 and a TRP B 1810 transmit single data (PDSCH) to a UE 1815, and multiple TRPs may perform joint precoding. This may signify that the TRP A 1805 and a TRP B 1810 transmit DMRSs through the same DMRS ports in order to transmit the same PDSCH. For example, the TRP A 1805 and a TRP B 1810 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

According to an embodiment, FIG. 18 illustrates an example 1820 of non-coherent joint transmission (NC-JT) that supports non-coherent precoding between each cell, TRP or/and beam for PDSCH transmission.

In the case of NC-JT, the PDSCH is transmitted to a UE 1835 per cell, per TPR, and/or per beam, and individual precoding may be applied to each PDSCH. Respective cells, TRPs, and/or beams (1825, 1830) may transmit different PDSCHs or different PDSCH layers to the UE, thereby improving throughput compared to single cell, TRP, and/or beam transmission. Further, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

In this case, various wireless resource allocations such as the case 1840 in which frequency and time resources used by a plurality of TRPs for PDSCH transmission are all the same, the case 1845 in which frequency and time resources used by a plurality of TRPs do not overlap at all, and the case 1850 in which some of the frequency and time resources used by a plurality of TRPs overlap each other may be considered.

In order to support NC-JT, DCIs in various forms, structures, and relations may be considered to simultaneously allocate a plurality of PDSCHs to one UE.

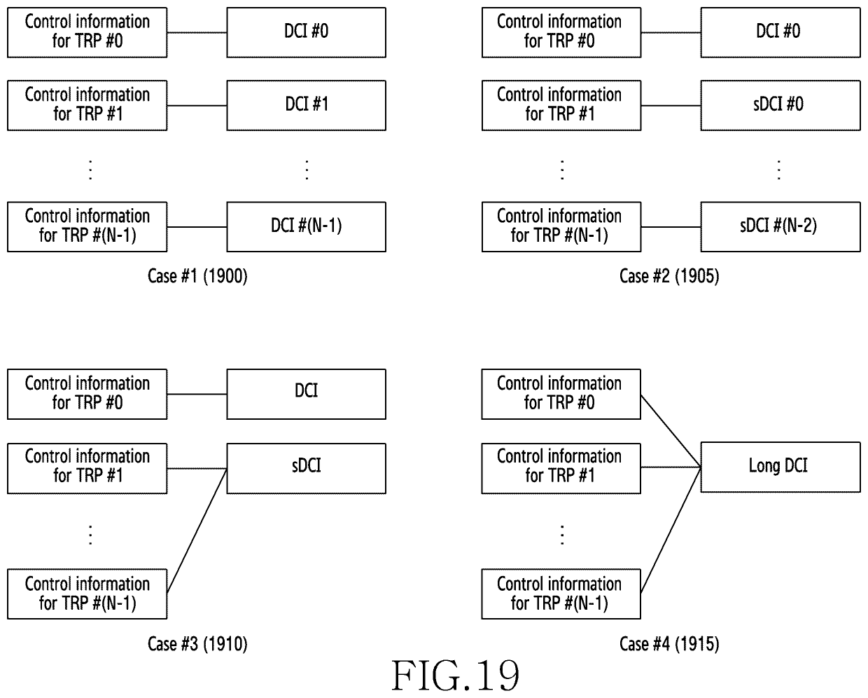

FIG. 19 illustrates an example of a downlink control information (DCI) configuration for cooperative communication in a wireless communication system according to an embodiment of the disclosure. More specifically, FIG. 19 illustrates an example for a configuration of downlink control information (DCI) for NC-JT in which respective TRPs transmit different PDSCHs or different PDSCH layers to the UE in a wireless communication system according to an embodiment of the disclosure.

Referring to FIG. 19, case #1 1900 is an example in which control information for PDSCHs transmitted from (N−1) additional TRPs is transmitted independently from control information for a PDSCH transmitted from a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCIs (DC1 #0 to DCI #(N−1)). Formats between the above-described independent DCIs may be the same as or different from each other, and payload between the DCls may also be the same as or different from each other. →In case #1 described above, a degree of freedom of PDSCH control or allocation may be completely guaranteed, but when respective pieces of the DCI are transmitted by different TRPs, a difference between DCI coverages may be generated and reception performance may deteriorate.

Case #2 1905 is an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2 described above, a degree of freedom of each PDSCH control or allocation may be limited according to content of information elements included in the sDCl, but reception capability of the sDCI is better than the nDCI, and thus a probability of the generation of difference between DCI coverages may become lower.

Case #3 1910 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 12 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a bandwidth part (BWP) indicator and a carrier indicator may follow the DCI (DCI #0, normal DCI, or nDCI) of the serving TRP.

In case #3 1910, a degree of freedom of PDSCH control or allocation may be limited according to content of the information elements included in the sDCI but reception performance of the sDCI can be controlled, and case #3 1130 may have smaller complexity of DCI blind decoding of the UE compared to case #1 1900 or case #2 1905.

Case #4 1915 is an example in which control information for PDSCHs transmitted from (N−1) additional TRPs is transmitted in the DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1915, complexity of DCI blind decoding of the UE may not be increased, but a degree of freedom of PDSCH control or allocation may be low since the number of cooperative TRPs is limited according to long DCI payload restriction.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following description and embodiments, Case #1 1900, case #2 1905, and case #3 1910 in which one or more pieces of DCI (or PDCCHs) are used to support NC-JT may be classified as multiple PDCCH-based NC-JT, and case #4 1915 in which single DCI (or PDCCH) is used to support NC-JT may be classified as single PDCCH-based NC-JT. In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Furthermore, in single PDCCH-based NC-JT, single DCI schedules a single PDSCH having a plurality of layers instead of scheduling a plurality of PDSCHs, and the plurality of layers may be transmitted from a plurality of TRPs. In this case, association between a layer and a TRP transmitting the corresponding layer may be indicated through a transmission configuration indicator (TCI) indication for the layer.

According to embodiments of the disclosure, the “cooperative TRP” may be replaced by various terms such as a “cooperative panel” or a “cooperative beam” when actually applied.

According to embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more transmission configuration indicator (TCI) indications in one BWP”, and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, if there is no backhaul delay between cooperative TRPs or there is a small backhaul delay, a method (a CA-like method) using a structure based on MAC layer multiplexing can be used. On the other hand, when the backhaul delay between cooperative TRPs is too large to be ignored (for example, when a time of 2 ms or longer is needed to exchange information such as CSI, scheduling, and HARQ-ACK between cooperative TRPs), a method (a DC-like method) of securing a characteristic robust to a delay can be used through an independent structure for each TRP from an RLC layer.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTClstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

### Multi-DCI-Based Multi-TRP

As an embodiment of the disclosure, a multi-DCI-based multi-TRP transmission method is described. In the multi-DCI-based multi-TRP transmission method, a downlink control channel for NC-JT may be configured based on multiple PDCCHs.

In NC-JT based on multiple PDCCHs, at the time of DCI transmission for PDSCH scheduling of each TRP, a CORESET or a search space distinguished for each TRP may be provided. The CORESET or search space for each TRP may be configurable as at least one of the following cases.
Configuration of higher layer index for each CORESET: CORESET configuration information configured through a higher layer may include an index value, and the configured index value for each CORESET may be used to distinguish a TRP transmitting a PDCCH in a corresponding CORESET. That is, in a set of CORESETs having the same higher layer index value, it may be considered that the same TRP transmits a PDCCH or a PDCCH scheduling a PDSCH of the same TRP is transmitted. The index for each CORESET may be called CORESETPoolIndex, and it may be considered that a PDCCH is transmitted from the same TRP in CORESETs configured to have the same value of CORESETPoolIndex. For a CORESET for which a value of CORESETPoolIndex is not configured, it may be considered that a default value of CORESETPoolIndex is configured, and the default value may be 0.

In the disclosure, if the number of CORESETPoolIndex types of multiple CORESETs included in the higher layer signaling PDCCH-Config exceeds 1, that is, if each CORESET has a different value of CORESETPoolIndex, a UE may consider that a base station is able to use a multi-DCI-based multi-TRP transmission method.

On the contrary, in the disclosure, if the number of CORESETPoolIndex types of multiple CORESETs included in the higher layer signaling PDCCH-Config is 1, that is, if all the CORESETs have the same value of CORESETPoolIndex of 0 or 1, the UE may consider that the base station performs transmission by using a single TRP rather than using a multi-DCI-based multi-TRP transmission method.
Configuration of multiple values of PDCCH-Config: Multiple values of PDCCH-Config are configured in one BWP, each value of PDCCH-Config may include a TRP-specific PDCCH configuration. That is, a CORESET list for each TRP and/or a search space list for each TRP may be configured in one value of PDCCH-Config, and one or more CORESETs and one or more search spaces included in one value of PDCCH-Config may be considered to correspond to a particular TRP.
CORESET beam/beam group configuration: Through a beam or beam group configured for each CORESET, a TRP corresponding to a corresponding CORESET may be distinguished. For example, if the same TCI state is configured for multiple CORESETs, it may be considered that the CORESETs are transmitted through the same TRP or a PDCCH scheduling a PDSCH of the same TRP is transmitted in the CORESETs.
Search space beam/beam group configuration: A beam or beam group is configured for each search space, and a TRP for each search space may be distinguished therethrough. For example, if the same beam/beam group or TCI state is configured for multiple search spaces, it may be considered that the same TRP transmits a PDCCH in the search spaces or a PDCCH scheduling a PDSCH of the same TRP is transmitted in the search spaces.

A CORESET or search space is distinguished by each TRP as described above, whereby classification of a PDSCH and HARQ-ACK information for each TRP is possible and thus independent generation of a HARQ-ACK codebook and independent usage of PUCCH resources for each TRP are possible.

The above configuration may be independent for each cell or each BWP. For example, two different values of CORESETPoolIndex may be configured for a PCell, and on the contrary, a value of CORESETPoolIndex may not be configured for a particular SCell. In this case, it may be considered that NC-JT is configured in the PCell, but NC-JT is not configured in the SCell in which a value of CORESETPoolIndex is not configured.

According to an embodiment, a PDSCH TCI state activation/deactivation MAC-CE which is applicable to a multi-DCI-based multi-TRP transmission method may follow FIG. 16 described above. If CORESETPoolIndex for all CORESETs in the higher layer signaling PDCCH-Config is not configured for a UE, the UE may disregard a CORESET pool ID field 1655 in a MAC-CE 1650. If the UE is able to support a multi-DCI-based multi-TRP transmission method, that is, if respective CORESETs in the higher layer signaling PDCCH-Config have different values of CORESETPoolIndex, the UE may activate a TCI state in DCI included in PDCCHs transmitted in CORESETs having the same CORESETPoolIndex value as that of the CORESET pool ID field 1655 in the MAC-CE 1650. For example, if the value of the CORESET pool ID field 1655 in the MAC-CE 1650 is 0, a TCI state in DCI included in PDCCHs transmitted from CORESETs having CORESETPoolIndex of 0 may follow activation information of the MAC-CE.

In a case where the UE is configured, by the base station, to be able to use a multi-DCI-based multi-TRP transmission method, that is, in a case where the number of CORESETPoolIndex types of multiple CORESETs included in the higher layer signaling PDCCH-Config exceeds 1, or in a case where the respective CORESETs have different values of CORESETPoolIndex, the UE may recognize that PDSCHs scheduled by PDCCHs in the respective CORESETs having two different values of CORESETPoolIndex have the following restrictions.

If PDSCHs indicated by PDCCHs in respective CORESETs having two different values of CORESETPoolIndex fully or partially overlap with each other, the UE may apply TCI states indicated by the PDCCHs to different CDM groups, respectively. That is, two or more TCI states may not be applied to one CDM group.

If PDSCHs indicated by PDCCHs in respective CORESETs having two different values of CORESETPoolIndex entirely or partially overlap with each other, the UE may expect that the PDSCHs have the same number of actual front loaded DMRS symbols, the same number of actual additional DMRS symbols, the same position of an actual DMRS symbol, and the same DMRS type.

The UE may expect that bandwidth parts indicated by PDCCHs in respective CORESETs having two different CORESETPoolIndexs are the same and the subcarrier spacings are also the same.

The UE may expect that information on a PDSCH scheduled by a PDCCH in a CORESET having each of two different CORESETPoolIndexs is fully included in a corresponding PDCCH.

### Single-DCI-Based Multi-TRP

As an embodiment of the disclosure, a single-DCI-based multi-TRP transmission method is described. In the single-DCI-based multi-TRP transmission method, a downlink control channel for NC-JT may be configured based on a single PDCCH.

In the single-DCI-based multi-TRP transmission method, a PDSCH transmitted by multiple TRPs may be scheduled by one DCI. As a method of indicating the number of TRPs transmitting the PDSCH, the number of TCI states may be used. That is, if the number of TCI states indicated in DCI scheduling a PDSCH is 2, transmission may be considered to be single PDCCH-based NC-JT, and if the number of TCI states is 1, transmission may be considered to be single-TRP transmission. The TCI states indicated in the DCI may correspond to one or two TCI states among TCI states activated by a MAC-CE. If TCI states of DCI correspond to two TCI states activated by a MAC-CE, a TCI codepoint indicated in the DCI and the TCI states activated by the MAC-CE may have a correspondence relation, and this may correspond to a case where the number of the TCI states activated by the MAC-CE and corresponding to the TCI codepoint is 2.

As another example, if at least one codepoint among all codepoints of a TCI state field in DCI indicates two TCI states, a UE may consider that a base station is able to perform transmission based on a single-DCI-based multi-TRP method. The at least one codepoint indicating two TCI states in the TCI state field may be activated through an enhanced PDSCH TCI state activation/deactivation MAC-CE.

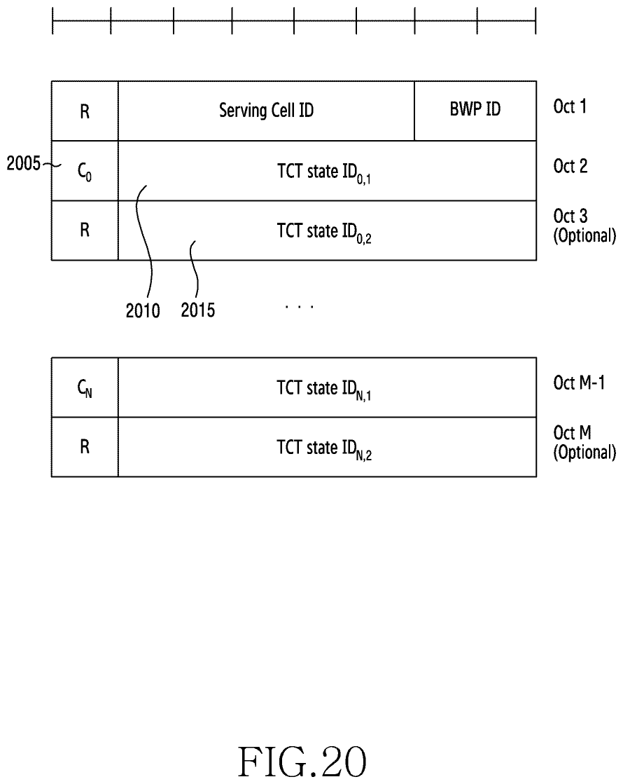

FIG. 20 illustrates an enhanced PDSCH TCI state activation/deactivation MAC-CE structure according to an embodiment of the disclosure. The meaning of each field in the MAC CE and a value configurable in each field are as follows.

Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;

BWP ID: This field indicates a DL BWP for which the MAC CE applies as the codepoint of the DCI bandwidth part indicator field as specified in TS 38.212 [9]. The length of the BWP ID field is 2 bits;

C_i: This field indicates whether the octet containing TCI state ID_i,2 is present. If this field is set to “1”, the octet containing TCI state ID_i,2 is present. If this field is set to “0”, the octet containing TCI state ID_i,2 is not present;

TCI state ID_i,j: This field indicates the TCI state identified by TCI-StateId as specified in TS 38.331 [5], where i is the index of the codepoint of the DCI Transmission configuration indication field as specified in TS 38.212 [9] and TCI state ID_i,j denotes the j-th TCI state indicated for the i-th codepoint in the DCI Transmission Configuration Indication field. The TCI codepoint to which the TCI States are mapped is determined by its ordinal position among all the TCI codepoints with sets of TCI state ID_i,j fields, i.e. The first TCI codepoint with TCI state ID0,1 and TCI state ID0,2 shall be mapped to the codepoint value 0, the second TCI codepoint with TCI state ID_1,1 and TCI state ID_1,2 shall be mapped to the codepoint value 1 and so on. The TCI state ID_i,2 is optional based on the indication of the C_i field. The maximum number of activated TCI codepoint is 8 and the maximum number of TCI states mapped to a TCI codepoint is 2.

R: Reserved bit, set to “0”.

Referring to FIG. 20, if the value of a C_0 field 2005 is 1, the MAC-CE may include a TCI state ID0,2 field 2015 in addition to a TCI state ID0,1 field 21-10. This implies that TCI state ID_0,1 and TCI state ID_0,2 are activated for the 0-th codepoint of a TCI state field included in DCI, and if a base station indicates the codepoint to a UE, two TCI states may be indicated to the UE. If the value of the CO field 2005 is 0, the MAC-CE is unable to include the TCI state ID_0,2 field 21-15, and this implies that one TCI state corresponding to TCI state ID_0,1 is activated for the 0-th codepoint of a TCI state field included in DCI.

The above configuration may be independent for each cell or each BWP. For example, the number of activated TCI states corresponding to one TCI codepoint is a maximum of 2 in a PCell, but the number of activated TCI states corresponding to one TCI codepoint may be a maximum of 1 in a particular SCell. In this case, it may be considered that NC-JT is configured in the PCell, but NC-JT is not configured in the SCell.

### Single-DCI-Based Multi-TRP PDSCH Repeated Transmission Technique (TDM/FDM/SDM) Distinguishment Method

Next, a method of distinguishing a single-DCI-based multi-TRP PDSCH repeated transmission technique is described. Different single-DCI-based multi-TRP PDSCH repeated transmission techniques (e.g., TDM, FDM, and SDM) may be indicated to a UE by a base station according to a value indicated by a DCI field and a higher layer signaling configuration. Table 24 below shows a method of distinguishing between single or multi-TRP-based techniques indicated to a UE according to a particular DCI field value and a higher layer signaling configuration.

TABLE 24

| | | | repetitionNumber | | Transport |
|---|---|---|---|---|---|
| | Number | Number | configuration | | scheme |
| | of TCI | of CDM | and Indication | repetitionScheme | indicated |
| Combination | state | group | condition | configuration | to the UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 2 | Condition 3 | Configured | Multi-TRP FDM |
| | | | | | scheme A/FDM |
| | | | | | scheme B/TDM |
| | | | | | scheme A |
| 9 | 2 | 2 | Condition 1 | Not configured | Multi-TRP TDM |
| | | | | | scheme B |

In Table 24, each column may be described as follows.

Number of TCI states (second column): This indicates the number of TCI states indicated by a TCI state field in DCI, and may be 1 or 2.

Number of CDM groups (third column): This indicates the number of different CDM groups of DMRS ports indicated by an antenna port field in DCI. The number may be 1,2, or 3.

repetitionNumber configuration and indication condition (fourth column): There may be three conditions according to whether repetitionNumber is configured for all TDRA entries indicatable by a time domain resource allocation field in DCI, and whether an actually indicated TDRA entry has a repetitionNumber configuration.

Condition 1: At least one of all TDRA entries indicatable by a time domain resource allocation field includes a configuration on repetitionNumber, and a TDRA entry indicated by a time domain resource allocation field in DCI includes a configuration on repetitionNumber greater than 1

Condition 2: At least one of all TDRA entries indicatable by a time domain resource allocation field includes a configuration on repetitionNumber, and a TDRA entry indicated by a time domain resource allocation field in DCI does not include a configuration on repetitionNumber

Condition 3: All TDRA entries indicatable by a time domain resource allocation field do not include a configuration on repetitionNumber

Related to repetitionScheme configuration (fifth column): This indicates whether the higher layer signaling repetitionScheme is configured. As the higher layer signaling repetitionScheme, one of “tdmSchemeA,” “fdmSchemeA,” and “fdmSchemeB” may be configured.

Transmission technique indicated to UE (sixth column): This indicates single or multi-TRP techniques indicated by each combination (first column) represented in Table 24.

Single-TRP: This indicates single-TRP-based PDSCH transmission. If pdsch-AggegationFactor in the higher layer signaling PDSCH-config is configured for the UE, single-TRP-based PDSCH repeated transmission performed a configured number of times may be scheduled to the UE. Otherwise, single-TRP-based PDSCH single transmission may be scheduled to the UE.

Single-TRP TDM scheme B: This indicates single-TRP-based inter-slot time resource division-based PDSCH repeated transmission. According to condition 1 related to repetitionNumber described above, the UE repeats PDSCH transmission on the time domain in a number of slots equal to the count of repetitionNumber greater than 1 configured in a TDRA entry indicated by a time domain resource allocation field. The UE applies the same start symbol and the same symbol length of a PDSCH indicated by the TDRA entry for each of the slots, the number of which is equal to the count of repetitionNumber, and applies the same TCI state to every PDSCH repetitive transmission. This technique is similar to a slot aggregation scheme in that inter-slot PDSCH repetitive transmission is performed in the time resources, but differs from slot aggregation in that whether repetitive transmission is indicated may be dynamically determined based on a time domain resource allocation field in DCI.

Multi-TRP SDM: This means a multi-TRP-based spatial resource division PDSCH transmission scheme. This is a method of receiving distributed layers from TRPs, and is not a repeated transmission scheme, but may increase the reliability of PDSCH transmission in that the number of layers is increased to enable transmission at a lowered code rate. A UE may apply two TCI states indicated through a TCI state field in DCI to two CDM groups indicated by a base station, respectively, so as to receive a PDSCH.

Multi-TRP FDM scheme A: This means a multi-TRP-based frequency resource division PDSCH transmission scheme. This technique provides one PDSCH transmission occasion and thus is not repeated transmission like multi-TRP SDM. However, the amount of frequency resources is increased to lower a code rate and thus enable transmission with high reliability. Multi-TRP FDM scheme A may apply two TCI states indicated through a TCI state field in DCI to frequency resources not overlapping each other, respectively. In a case where a PRB bundling size is determined to be a wideband, if the number of RBs indicated by a frequency domain resource allocation field is N, a UE applies a first TCI state to a first ceil(N/2) number of RBs, and applies a second TCI state to the remaining floor(N/2) number of RBs so as to perform reception. Here, ceil(.) and floor(.) are operators indicating rounding up and down for one decimal place. If a PRB bundling size is determined to be 2 or 4, the UE applies the first TCI state to even-numbered PRGs, and applies the second TCI state to odd-numbered PRGs to perform reception.

Multi-TRP FDM scheme B: This means a multi-TRP-based frequency resource division PDSCH repeated transmission scheme, and provides two PDSCH transmission occasions to repeat PDSCH transmission in the respective occasions. In the same way as multi-TRP FDM scheme A, multi-TRP FDM scheme B may also apply two TCI states indicated through a TCI state field in DCI to frequency resources not overlapping each other, respectively. In a case where a PRB bundling size is determined to be a wideband, if the number of RBs indicated by a frequency domain resource allocation field is N, a UE applies a first TCI state to a first ceil(N/2) number of RBs, and applies a second TCI state to the remaining floor(N/2) number of RBs so as to perform reception. Here, ceil(.) and floor(.) are operators indicating rounding up and down for one decimal place. If a PRB bundling size is determined to be 2 or 4, the UE applies the first TCI state to even-numbered PRGs, and applies the second TCI state to odd-numbered PRGs to perform reception.

Multi-TRP TDM scheme A: This means a multi-TRP-based time resource division intra-slot PDSCH repetitive transmission scheme. The UE may have two PDSCH transmission occasions in one slot, and a first reception occasion may be determined based on the starting symbol and the symbol length of a PDSCH indicated through a time domain resource allocation field in DCI. A starting symbol of a second reception occasion of the PDSCH may be a position obtained by applying a symbol offset of the higher layer signaling StartingSymbolOffsetK to a last symbol of the first transmission occasion, and the transmission occasion may be determined to be as long as the indicated symbol length from the position. If the higher layer signaling StartingSymbolOffsetK is not configured, a symbol offset may be considered as 0.

Multi-TRP TDM scheme B: This means a multi-TRP-based time resource division inter-slot PDSCH repeated transmission scheme. A UE may have one PDSCH transmission occasion in one slot, and receive repetitive transmission, based on the same PDSCH start symbol and symbol length during a number of slots corresponding to the count of repetitionNumber indicated through a time domain resource allocation field in DCI. If repetitionNumber is 2, the UE may receive PDSCH repeated transmission in first and second slots by applying first and second TCI states thereto, respectively. If repetitionNumber is greater than 2, the UE may use different TCI state application schemes according to which value the higher layer signaling tciMapping is configured to be. If tciMapping is configured to be cyclicMapping, the UE applies first and second TCI states to first and second PDSCH transmission occasions, respectively, and also applies this TCI state application method to the remaining PDSCH transmission occasions in the same way. If tciMapping is configured to be sequenticalMapping, the UE applies a first TCI state to first and second PDSCH transmission occasions, applies a second TCI state to third and fourth PDSCH transmission occasions, respectively, and also applies this TCI state application method to the remaining PDSCH transmission occasions in the same way.

### Related to DMRS

Next, antenna port field indication included in DCI format 1_1 and DCI format 1_2 defined in Table 7 described above will be described. An antenna port field in DCI formats 1_1 and 12 may be expressed by 4, 5, or 6 bits, and may perform indication through Table 25-1 to Table 25-8 below.

TABLE 25-1
Antenna port(s) (1000 + DMRS port), dmrs-Type = 1, maxLength = 1
One Codeword: Codeword 0 enabled, Codeword 1 disabled

| | Number of DMRS CDM | DMRS |
|---|---|---|
| Value | group(s) without data | port (s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 25-2
Antenna port(s) (1000 + DMRS port), dmrs-Type = 1, maxLength = 1
One Codeword: Codeword 0 enabled, Codeword 1 disabled

| | Number of DMRS CDM | DMRS |
|---|---|---|
| Value | group(s) without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12 | 2 | 0, 2, 3 |
| 13-15 | Reserved | Reserved |

TABLE 25-3
Antenna port(s) (1000 + DMRS port), dmrs-Type = 1, maxLength = 2

| One Codeword: Codeword 0 enabled, | | | | Two Codewords: Codeword 0 enabled, | | | |
|---|---|---|---|---|---|---|---|
| Codeword 1 disabled | | | | Codeword 1 enabled | | | |
| | Number of DMRS | | Number of | | Number of DMRS | | Number of |
| | CDM group(s) | DMRS | front-load | | CDM group(s) | DMRS | front-load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, | 2 |
| | | | | | | 4, 6 | |
| 2 | 1 | 0, 1 | 1 | 2 | 2 | 0, 1, 2, 3, | 2 |
| | | | | | | 4, 5, 6 | |
| 3 | 2 | 0 | 1 | 3 | 2 | 0, 1, 2, 3, | 2 |
| | | | | | | 4, 5, 6, 7 | |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 25-4
Antenna port(s) (1000 + DMRS port), dmrs-Type = 1, maxLength = 2

| One Codeword: Codeword 0 enabled, | | | | Two Codewords: Codeword 0 enabled, | | | |
|---|---|---|---|---|---|---|---|
| Codeword 1 disabled | | | | Codeword 1 enabled | | | |
| | Number of DMRS | | Number of | | Number of DMRS | | Number of |
| | CDM group(s) | DMRS | front-load | | CDM group(s) | DMRS | front-load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, | 2 |
| | | | | | | 4, 6 | |
| 2 | 1 | 0, 1 | 1 | 2 | 2 | 0, 1, 2, 3, | 2 |
| | | | | | | 4, 5, 6 | |
| 3 | 2 | 0 | 1 | 3 | 2 | 0, 1, 2, 3, | 2 |
| | | | | | | 4, 5, 6, 7 | |
| 4 | 2 | 1 | 3 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

TABLE 25-5
Antenna port(s) (1000 + DMRS port), dmrs-Type = 2, maxLength = 1

| One codeword: Codeword 0 enabled, Codeword 1 disabled | | | Two codewords: Codeword 0 enabled, Codeword 1 enabled | | |
|---|---|---|---|---|---|
| | Number of DMRS CDM | DMRS | | Number of DMRS CDM | DMRS |
| Value | group(s) without data | port(s) | Value | group(s) without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

TABLE 25-6
Antenna port(s) (1000 + DMRS port), dmrs-Type = 2, maxLength = 1

| One codeword: Codeword 0 enabled, Codeword 1 disabled | | | Two codewords: Codeword 0 enabled, Codeword 1 enabled | | |
|---|---|---|---|---|---|
| | Number of DMRS CDM | DMRS | | Number of DMRS CDM | DMRS |
| Value | group(s) without data | port(s) | Value | group(s) without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 18 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25-31 | Reserved | Reserved | | | |

TABLE 25-7
Antenna port(s) (1000 + DMRS port), dmrs-Type = 2, maxLength = 2

| One codeword: Codeword 0 enabled, | | | | Two Codewords: Codeword 0 enabled, | | | |
|---|---|---|---|---|---|---|---|
| Codeword 1 disabled | | | | Codeword 1 enabled | | | |
| | Number of DMRS | | Number of | | Number of DMRS | | Number of |
| | CDM group(s) | DMRS | front-load | | CDM group(s) | DMRS | front-load |
| Value | without data | port(s) | symbols | Value | without data | port(s) | symbols |
| 0 | 1 | 0 | 1 | 0 | 3 | 0-4 | |
| 1 | 1 | 1 | 1 | 1 | 3 | 0-5 | 1 |
| 2 | 1 | 0, 1 | 1 | 2 | 2 | 0, 1, 2, | 2 |
| | | | | | | 3, 8 | |
| 3 | 2 | 0 | 1 | 3 | 2 | 0, 1, 2, | 2 |
| | | | | | | 3, 6, 8 | |
| 4 | 2 | 1 | 1 | 4 | 2 | 0, 1, 2, 3, | 2 |
| | | | | | | 6, 7, 8 | |
| 5 | 2 | 2 | 1 | 5 | 2 | 0, 1, 2, 3, | 2 |
| | | | | | | 6, 7, 8, 9 | |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 33 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 8 | 2 | | | | |
| 51 | 1 | 7 | 2 | | | | |
| 52 | 3 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58-63 | Reserved | Reserved | Reserved | | | | |

TABLE 25-8
Antenna port(s) (1000 + DMRS port), dmrs-Type = 2, maxLength = 2

| One codeword: Codeword 0 enabled, | | | | Two Codewords: Codeword 0 enabled, | | | |
|---|---|---|---|---|---|---|---|
| Codeword 1 disabled | | | | Codeword 1 enabled | | | |
| | Number of DMRS | | Number of | | Number of DMRS | | Number of |
| | CDM group(s) | DMRS | front-load | | CDM group(s) | DMRS | front-load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, | 2 |
| | | | | | | 3, 6 | |
| 3 | 2 | 0 | 1 | 3 | 2 | 0, 1, 2, | 2 |
| | | | | | | 3, 6, 8 | |
| 4 | 2 | 1 | 1 | 4 | 2 | 0, 1, 2, 3, | 2 |
| | | | | | | 6, 7, 8 | |
| 5 | 2 | 2 | 1 | 5 | 2 | 0, 1, 2, 3, | 2 |
| | | | | | | 6, 7, 8, 9 | |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 8, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 59-83 | Reserved | Reserved | Reserved | | | | |

Table 25-1 and Table 25-2 are tables used when dmrs-type is indicated to be 1 and maxLength is indicated to be 1, Table 25-3 and Table 25-4 are tables used when dmrs-type is equal to 1 and maxLength is equal to 2, Table 25-5 and Table 25-6 show DMRS ports used when dmrs-type is equal to 2 and maxLength is equal to 1, and Table 25-7 and Table 25-8 show DMRS ports used when dmrs-type is equal to 2 and maxLength is equal to 2.

According to an embodiment, if a UE has received a MAC-CE for activating a codepoint indicating two TCI states for at least one codepoint of a TCI state field in DCI, a DMRS port may be indicated to the UE by using Table 25-2, Table 25-4, Table 25-6, and Table 25-8, and otherwise, a DMRS port may be indicated to the UE by using Table 25-1, Table 25-3, Table 25-5, and Table 25-7. If a codepoint indicating two TCI states is indicated to the UE through a TCI state field, entries indicating DMRS ports 1000, 1002, and 1003 may be indicated to the UE for the purpose of NC-JT scheduling in Table 25-2, Table 25-4, Table 25-6, and Table 25-8, and the entries may be entry #12 in Table 25-2, entry #31 in Table 25-4, entry #24 in Table 25-6, and entry #58 in Table 25-8.

According to an embodiment, with respect to DCI format 1_1, if the higher layer signaling dmrs-DownlinkForPDSCH-MappingTypeA and dmrs-DownlinkForPDSCH-MappingTypeB are both configured for the UE, a bit length of an antenna port field in DCI format 11 may be determined to be max{xA, xB}, xA and xB may indicate bit lengths of the antenna port field determined through dmrs-DownlinkForPDSCH-MappingTypeA and dmrs-DownlinkForPDSCH-MappingTypeB, respectively. If a PDSCH mapping type corresponding to the smaller value among xA and xB is scheduled, each of as many MSB bits as |xA−xB| may be allocated 0 bits and then transmitted.

According to an embodiment, with respect to DCI format 1_2, if the higher layer signaling antennaPortsFieldPresenceDCI-1-2 is not configured for the UE, there may be no antenna port field in DCI format 1_2. That is, the length of the antenna port field is 0 bits, and the UE may determine a DMRS port by assuming the 0-th entry in Table 25-1, Table 25-3, Table 25-5, and Table 25-7. If the higher layer signaling antennaPortsFieldPresenceDCI-1-2 is configured for the UE, the bit length of an antenna port field in DCI format 12 may be determined similarly to the above case of DCI format 1_1. If the higher layer signaling dmrs-DownlinkForPDSCH-MappingTypeA-DCI-1-2 and dmrs-DownlinkForPDSCH-MappingTypeB-DCI-1-2 are both configured for the UE, the bit length of an antenna port field in DCI format 1_2 may be determined to be max{xA, xB}, and xA and xB may indicate bit lengths of the antenna port field determined through dmrs-DownlinkForPDSCH-MappingTypeA-DCI-1-2 and dmrs-DownlinkForPDSCH-MappingTypeB-DCI-1-2, respectively. If a PDSCH mapping type corresponding to the smaller value among xA and xB is scheduled, each of as many MSB bits as |xA−xB| may be allocated 0 bits and then transmitted.

According to an embodiment, the numbers 1, 2, and 3 indicated by number of DMRS CDM group(s) without data in Table 25-1 to Table 25-8 indicates CDM groups {0}, {0, 1}, and {0, 1, 2}, respectively. DMRS port(s) shows indexes of used ports in sequence. An antenna port may be indicated by DMRS port+1000. A CDM group of a DMRS is connected to an antenna port and a method of generating a DMRS sequence as shown in Table 26-1 and Table 26-2. Table 26-1 shows parameters of a case of using dmrs-type=1, and Table 26-2 shows parameters of a case of using dmrs-type=2.

TABLE 26-1
Parameters for PDSCH DM-RS dmrs-type = 1

| | | |
|---|---|---|
| CDM | w_{f}(k′) | wₜ(l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 26-2
Parameters for PDSCH DM-RS dmrs-type = 2

| | | |
|---|---|---|
| CDM | w_{f}(k′) | wₜ(l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

According to an embodiment, a DMRS sequence according to each parameter is determined by Equation 3-1 below. In Equation 3-1, p denotes a DMRS port, k denotes a subcarrier index, l denotes an OFDM symbol index, μ denotes a subcarrier spacing, wf(k′) and wt(l′) denote a frequency domain orthogonal cover code (FD-OCC) coefficient and a time domain orthogonal cover code (TD-OCC) coefficient according to a k′ value and a l′ value, respectively, and A expresses the interval between CDM groups by using the number of subcarriers. In Equation 3-1,

$${β}_{PDSCH}^{DMRS}$$

is a scaling factor indicating the ratio between the energy-per-RE (EPRE) of a PDSCH and the EPRE of a DMRS, and may be calculated by

$${β}_{PDSCH}^{DMRS} = {10}^{- \frac{{β}_{D M R S}}{20}} ,$$

and the value of β_{DMRS} may be 0 dB, −3 dB, and −4.77 dB according to 1, 2, and 3 of the number of CDM groups.

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \\ {k}^{′} = 0 , 1 \\ l = \overline{l} + {l}^{′} \\ n = 0 , 1 , … \qquad Equation 3 - 1$$

According to an embodiment, in a case where DMRS type 1 is used, if a single codeword is scheduled and entries #2, #9, #10, #11, and #30 are indicated to a UE by using Table 25-1 and Table 25-3, if a single codeword is scheduled and entries #2, #9, #10, #11, and #12 are indicated thereto by using Table 25-2, if a single codeword is scheduled and entries #2, #9, #10, #11, #30, and #31 are indicated thereto by using Table 25-4, or if two codewords are scheduled, the UE may consider that the scheduling is single-user MIMO scheduling. That is, the UE may assume that a different UE is not scheduled to all remaining orthogonal DMRS ports other than DMRS ports allocated to a scheduled PDSCH, and may not expect multi-user MIMO (MU-MIMO) scheduling. In this case, the UE does not assume that a different UE is co-scheduled, and may not perform a multi-user MIMO reception operation like canceling, nulling, or whitening multi-user interference.

According to an embodiment, in a case where DMRS type 2 is used, if a single codeword is scheduled and entries #2, #10, and #23 are indicated to a UE by using Table 25-5 and Table 25-7, if a single codeword is scheduled and entries #2, #10, #23, and #24 are indicated thereto by using Table 25-6, if a single codeword is scheduled and entries #2, #10, #23, and #58 are indicated thereto by using Table 25-8, or if two codewords are scheduled, the UE may consider that the scheduling is single-user MIMO scheduling. That is, the UE may assume that a different UE is not scheduled to all remaining orthogonal DMRS ports other than DMRS ports allocated to a scheduled PDSCH, and may not expect multi-user MIMO scheduling. In this case, the UE does not assume that a different UE is co-scheduled, and may not perform a multi-user MIMO reception operation like canceling, nulling, or whitening multi-user interference.

According to an embodiment, the UE may not expect that while the number of maximum front-loaded DMRS symbols is configured to be len2 through the higher layer signaling maxLength, one or more additional DMRS symbols are configured through the higher layer signaling dmrs-AdditionalPosition.

According to an embodiment, the UE may not expect that the number of actual front-loaded DMRS, the number of actual additional DMRS symbol, a DMRS symbol position, and a DMRS type configuration are different for all UEs subject to multi-user MIMO scheduling.

According to an embodiment, in a case of a UE having a PRG size of 2 or 4, the UE may not expect that frequency resource allocation does not match in a PRG unit grid for a different UE co-scheduled using different orthogonal DMRS ports in the same CDM group as that of a DMRS port indicated to the UE.

According to an embodiment, in a case of a PDSCH scheduled by DCI format 1_1 and 1_2, the UE may assume that CDM groups indicated through the column of “Number of DMRS CDM group(s) without data” in Table 25-1 to Table 25-8 may include DMRS ports allocated to a different UE co-schedulable through a multi-user MIMO scheme and may not be used for data transmission of the UE, and may understand that 1, 2, and 3 of the values indicated through the column of “Number of DMRS CDM group(s) without data” in Table 25-1 to Table 25-8 may imply that the indexes of CDM groups corresponding to the above meaning correspond to CDM groups 0, {0,1}, and {0,1,2}, respectively.

According to an embodiment, if the higher layer signaling dmrs-FD-OCC-disableForRanklPDSCH is configured for a UE and one DMRS port is allocated to the UE for PDSCH scheduling, the UE may not expect that a different UE is allocated a DMRS port in which a different FD-OCC is used, among different orthogonal DMRS ports belonging to the same CDM group as that of the one allocated DMRS port.

Next, antenna port field indication included in DCI format 0_1 and DCI format 0_2 defined in Table 5 described above will be described. An antenna port field in DCI formats 0_1 and 02 may be expressed by 3, 4, or 5 bits, and may perform indication through Table 25-9 to Table 25-24 below.

TABLE 25-9
Antenna port(s), transform precoder is disabled,
dmrs-Type = 1, maxLength = 1, rank = 1

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 25-10
Antenna port(s), transform precoder is disabled,
dmrs-Type = 1, maxLength = 1, rank = 2

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

TABLE 25-11
Antenna port(s), transform precoder is disabled,
dmrs-Type = 1, maxLength = 1, rank = 3

| | Number of DMRS | |
|---|---|---|
| | CDM group(s) | DMRS |
| Value | without data | port(s) |
| 0 | 2 | 0-2 |
| 1-7 | Reserved | Reserved |

TABLE 25-12
Antenna port(s), transform precoder is disabled,
dmrs-Type = 1, maxLength = 1, rank = 4

| | Number of DMRS | |
|---|---|---|
| | CDM group(s) | DMRS |
| Value | without data | port(s) |
| 0 | 2 | 0-3 |
| 1-7 | Reserved | Reserved |

TABLE 25-13
Antenna port(s), transform precoder is disabled,
dmrs-Type = 1, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 25-14
Antenna port(s), transform precoder is disabled,
dmrs-Type = 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

TABLE 25-15
Antenna port(s), transform precoder is disabled,
dmrs-Type = 1, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

TABLE 25-16
Antenna port(s), transform precoder is disabled,
dmrs-Type = 1, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

TABLE 25-17
Antenna port(s), transform precoder is disabled,
dmrs-Type = 2, maxLength = 1, rank = 1

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

TABLE 25-18
Antenna port(s), transform precoder is disabled, dmrs-Type = 2,
maxLength = 1, rank = 2

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

TABLE 25-19
Antenna port(s), transform precoder is disabled, dmrs-Type = 2,
maxLength = 1, rank = 3

| Value | Number of DMRS CDM group(s) without data | DMRS port(s) |
|---|---|---|
| 0 | 2 | 0-2 |
| 1 | 3 | 0-2 |
| 2 | 3 | 3-5 |
| 3-15 | Reserved | Reserved |

TABLE 25-20
Antenna port(s), transform precoder is disabled, dmrs-Type = 2,
maxLength = 1, rank = 4

| Value | Number of DMRS CDM group(s) without data | DMRS port(s) |
|---|---|---|
| 0 | 2 | 0-3 |
| 1 | 3 | 0-3 |
| 2-15 | Reserved | Reserved |

TABLE 25-21
Antenna port(s), transform precoder is disabled, dmrs-Type = 2,
maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

TABLE 25-22
Antenna port(s), transform precoder is disabled, dmrs-Type = 2,
maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

TABLE 25-23
Antenna port(s), transform precoder is disabled, dmrs-Type = 2,
maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

TABLE 25-24
Antenna port(s), transform precoder is disabled, dmrs-Type = 2,
maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

According to an embodiment, Table 25-9 to Table 25-12 are tables used when dmrs-type is indicated to be 1 and maxLength is indicated to be 1, Table 25-13 to Table 25-16 are tables used when dmrs-type=1 and maxLength=2 are indicated, Table 25-17 to Table 25-20 show DMRS ports used when dmrs-type is equal to 2 and maxLength is equal to 1, and Table 25-21 to Table 25-24 show DMRS ports used when dmrs-type is equal to 2 and maxLength is equal to 2.

According to an embodiment, with respect to DCI format 0_1, if the higher layer signaling dmrs-UplinkForPUSCH-MappingTypeA and dmrs-UplinkForPUSCH-MappingTypeB are both configured for the UE, a bit length of an antenna port field in DCI format 0_1 may be determined to be max{xA, xB}, xA and xB may indicate bit lengths of the antenna port field determined through dmrs-UplinkForPUSCH-MappingTypeA and dmrs-UplinkForPUSCH-MappingTypeB, respectively. If a PUSCH mapping type corresponding to the smaller value among xA and xB is scheduled, each of as many MSB bits as |xA−xB| may be allocated 0 bits and then transmitted.

According to an embodiment, with respect to DCI format 0_2, if the higher layer signaling antennaPortsFieldPresenceDCI-0-2 is not configured for the UE, there may be no antenna port field in DCI format 0_2. That is, in this case, the length of an antenna port field is 0 bits, and the UE may determine a DMRS port by assuming the 0-th entry in Table 25-9 to Table 25-24. If the higher layer signaling antennaPortsFieldPresenceDCI-0-2 is configured for the UE, the bit length of an antenna port field in DCI format 02 may be determined similarly to the above case of DCI format 0_1. If the higher layer signaling dmrs-UplinkForPUSCH-MappingTypeA-DCI-0-2 and dmrs-UplinkForPUSCH-MappingTypeB-DCI-0-2 are both configured for the UE, the bit length of an antenna port field in DCI format 0_2 may be determined to be max{xA, xB}, and xA and xB may indicate bit lengths of the antenna port field determined through dmrs-UplinkForPUSCH-MappingTypeA-DCI-0-2 and dmrs-UplinkForPUSCH-MappingTypeB-DCI-0-2, respectively. If a PDSCH mapping type corresponding to the smaller value among xA and xB is scheduled, each of as many MSB bits as |xA−xB| may be allocated 0 bits and then transmitted.

According to an embodiment, the numbers 1, 2, and 3 indicated by number of DMRS CDM group(s) without data in Table 25-9 to Table 25-24 indicates CDM groups {0}, {0, 1}, and {0, 1, 2}, respectively. DMRS port(s) shows indexes of used ports in sequence. An antenna port may be indicated by DMRS port+1000. A CDM group of a DMRS is connected to an antenna port and a method of generating a DMRS sequence as shown in Table 26-1a and Table 26-2a. Table 26-1a shows parameters of a case of using dmrs-type=1, and Table 26-2a shows parameters of a case of using dmrs-type=2.

TABLE 26-1a
Parameters for PUSCH DM-RS dmrs-type = 1

| | | |
|---|---|---|
| CDM | w_{f}(k′) | wₜ(l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 26-2a
Parameters for PUSCH DM-RS dmrs-type = 2

| | | |
|---|---|---|
| CDM | w_{f}(k′) | wₜ(l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

According to an embodiment, a DMRS sequence according to each parameter is determined by Equation 3-1 below. In Equation 3-1, \tilde{p} denotes a DMRS port, k denotes a subcarrier index, l denotes an OFDM symbol index, μ denotes a subcarrier spacing, wf(k′) and wt(l′) denote a frequency domain orthogonal cover code (FD-OCC) coefficient and a time domain orthogonal cover code (TD-OCC) coefficient according to a k′ value and a l′ value, respectively, and Δ expresses the interval between CDM groups by using the number of subcarriers. In Equation 3-2,

$${β}_{PUSCH}^{DMRS}$$

is a scaling factor indicating the ratio between the energy-per-RE (EPRE) of a PUSCH and the EPRE of a DMRS, and may be calculated by

$${β}_{PUSCH}^{DMRS} = {10}^{- \frac{{β}_{D M R S}}{20}} ,$$

and the value of β_{DMRS} may be 0 dB, −3 dB, and −4.77 dB according to 1, 2, and 3 of the number of CDM groups.

$${\tilde{a}}_{k , l}^{( {p}_{j} , μ )} = {w}_{f} ( {k}^{′} ) {w}_{t} ( {l}^{′} ) r ( 2 n + {k}^{′} ) \\ k = \{ \begin{matrix}4 n + 2 {k}^{′} + Δ & Configuration type 1 \\ 6 n + {k}^{′} + Δ & Configuration type 2\end{matrix} \qquad Equation 3 - 2$$

$${k}^{′} = 0 , 1 \\ l = \overline{l} + {l}^{′} \\ n = 0 , 1 , … \\ j = 0 , 1 , … , v - 1 \\ [ \begin{matrix}{a}_{k , l}^{( {p}_{0} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {p}_{0} , μ )} \\ ⋮ \\ {\tilde{a}}_{k , l}^{( {p}_{v - 1} , μ )}\end{matrix} ]$$

According to an embodiment, if frequency hopping is not used, the UE may be required to assume that the higher layer signaling dmrs-AdditionalPosition is configured to be “pos2,” and a maximum of two additional DMRS symbols are available for PUSCH transmission. If frequency hopping is used, the UE may be required to assume that the higher layer signaling dmrs-AdditionalPosition is configured to be “pos1,” and a maximum of one additional DMRS symbols are available for PUSCH transmission.

According to an embodiment, in a case of a PUSCH scheduled by DCI format 0_1 and 0_2, the UE may assume that CDM groups indicated through the column of “Number of DMRS CDM group(s) without data” in Table 25-9 to Table 25-24 may include DMRS ports allocated to a different UE co-schedulable through a multi-user MIMO scheme and may not be used for data transmission of the UE, and may understand that 1, 2, and 3 of the values indicated through the column of “Number of DMRS CDM group(s) without data” in Table 25-9 to Table 25-24 may imply that the indexes of CDM groups corresponding to the above meaning correspond to CDM groups 0, {0,1}, and {0,1,2}, respectively.

### First Embodiment: Method of Supporting Enhanced DMRS Types 1 and 2 Supporting Increased Number of Orthogonal Ports

As an embodiment of the disclosure, a method of supporting enhanced DMRS types 1 and 2 supporting an increased number of orthogonal ports is described. This embodiment may be operated in combination with other embodiments.

An evolved standard of 5G may support enhanced DMRS type 1 and DMRS type 2 supporting an increased number of orthogonal ports while maintaining the same RE use amount and the same overhead as those of DMRS type 1 and DMRS type 2 which have been supported in an initial standard of 5G for all uplink and downlink. In a case of conventional DMRS type 1, if the number of front loaded symbols is 1 and 2, maximum four and eight orthogonal DMRS ports may be supported, respectively, and in a case of DMRS type 2, if the number of front loaded symbols is 1 and 2, maximum six and twelve orthogonal DMRS ports may be supported, respectively. Referring to these supported items, in a case of enhanced DMRS type 1, if the number of front loaded symbols is 1 and 2, maximum eight and sixteen orthogonal DMRS ports may be supported, respectively, and in a case of enhanced DMRS type 2, if the number of front loaded symbols is 1 and 2, maximum twelve and twenty four orthogonal DMRS ports may be supported, respectively. Hereinafter, a new DMRS type supporting an increased number of orthogonal ports as described above may be named one of “enhanced DMRS types 1 and 2,” “new DMRS types 1 and 2,” “new DMRS types 1 and 2,” “DMRS types 1-1 and 2-1,” or “DMRS types 3 and 4,” and other similar expanded names which may be called with the meaning of having a function enhanced compared to that of conventional DMRS types 1 and 2 may not be excluded. The following items are described mainly for downlink, but may also be applied similarly to uplink DMRS supporting.

According to an embodiment, if a UE supports enhanced DMRS types 1 and 2, the UE may report a UE capability of supporting enhanced DMRS types 1 and 2 to a base station. The reporting of the UE capability may be transmitted to the base station in per-band units and, more specifically, may be also transmitted in per-feature set (FS) or per feature set per component carrier (FSPC) units. In addition, the reporting of the UE capability may be differently supported for each FR or may be limited to FR1. Furthermore, the reporting of the UE capability may include, as described above, “the meaning wherein in a case of enhanced DMRS type 1, if the number of front loaded symbols is 1 and 2, maximum eight and sixteen orthogonal DMRS ports may be supported, respectively, and in a case of enhanced DMRS type 2, if the number of front loaded symbols is 1 and 2, maximum twelve and twenty four orthogonal DMRS ports may be supported, respectively.” The UE may perform reporting through common UE capability for enhanced DMRS types 1 and 2. In this case, the UE may report whether the UE supports only enhanced DMRS type 1, supports only enhanced DMRS type 2, or supports both enhanced DMRS types 1 and 2. In addition, the UE may also report whether the UE supports each of enhanced DMRS types 1 and 2 through an individual UE capability.

According to an embodiment, in addition, if the UE supports a dynamic switching function between an enhanced DMRS type and a conventional DMRS type, the UE may report the function through a UE capability. The dynamic switching function between an enhanced type and a conventional type may imply that a DMRS type configured through higher layer signaling is changeable through a MAC-CE, that selection between an enhanced type and a conventional type is possible through DCI, or both of them. If the UE reports, through a common UE capability, whether enhanced DMRS types 1 and 2 are supported, the UE may report, through one UE capability, whether a dynamic switching function for DMRS types 1 and 2 is supported, while reporting whether the UE supports only dynamic switching between DMRS type 1 and enhanced DMRS type 1, the UE supports only dynamic switching between DMRS type 2 and enhanced DMRS type 2, or the UE supports dynamic switching between an enhanced type and a conventional type for both of two types. On the contrary, in a case where the UE reports, through a common UE capability or an individual UE capability, whether enhanced DMRS types 1 and 2 are supported, the UE may report, through an individual UE capability for each type, that dynamic switching between a conventional type and an enhanced type is possible.

According to an embodiment, in addition, in a case where the UE operates in enhanced DMRS type 1 or 2, if the UE supports conventional DMRS type 1 or 2 and multi-user MIMO scheduling, the UE may report the function through a UE capability. The multi-user MIMO scheduling may indicate co-scheduling between conventional DMRS type 1 and enhanced DMRS type 1, or co-scheduling between conventional DMRS type 2 and enhanced DMRS type 2. Similarly to the above description, a UE capability relating to whether co-scheduling between a conventional type and an enhanced type is possible is reported as a common UE capability whereby the UE may report only co-scheduling between conventional type 1 and enhanced type 1 being possible, report only co-scheduling between conventional type 2 and enhanced type 2 being possible, or report co-scheduling between a conventional type and an enhanced type being possible for both types 1 and 2. Alternatively, the UE may perform reporting through an individual UE capability for each type.

With respect to the UE having reported a UE capability, a base station may configure an enhanced DMRS type 1 and 2 scheme for the UE through higher layer signaling by using the following methods.

[Higher layer configuration method 1] For example, an enhanced DMRS type being supported may be configured for the UE through the higher layer signaling DMRS-DownlinkConfig.

[Higher layer configuration method 1-1] The higher layer signaling dmrs-Type-r18 similar to the higher layer signaling dmrs-Type used to determine a conventional type may be configured, and may be used to define an enhanced DMRS type other than DMRS type 1 or 2. An RRC IE that is called dmrs-Type-r18 in addition to dmrs-Type may be newly configured for the UE in the higher layer signaling DMRS-DownlinkConfig. Through dmrs-Type-r18, one of DMRS types 1 or 2 or enhanced DMRS types 1 or 2 may be determined, or one of enhanced DMRS types 1 or 2 may be determined.

For example, as shown in Table 26-3 below, if dmrs-Type-r18 is configured, one of DMRS type 2 and enhanced DMRS type 1 or 2 may be determined, and existing dmrs-Type may be disregarded. If dmrs-Type-r18 is not configured, a DMRS type may be determined according to a dmrs-Type configuration scheme.

As another example, if dmrs-Type-r18 is configured, one of enhanced DMRS types 1 or 2 may be determined, and existing dmrs-Type may be disregarded. If dmrs-Type-r18 is not configured, a DMRS type may be determined according to a dmrs-Type configuration scheme.

If the higher layer configuration method described above is used, the UE may use only one of a conventional scheme (e.g., DMRS type 1 or 2) and an enhanced scheme (e.g., enhanced DMRS type 1 or 2) of DMRS type with respect to each of PDSCH mapping type A or B, and this may be a higher layer configuration scheme in which dynamic switching between a conventional scheme and an enhanced scheme is impossible, or dynamic switching is not considered. The dmrs-Type-r18 which is the name of an RRC IE is merely an example, and may be different from the name of an actual RRC IE.

TABLE 26-3

| | |
|---|---|
| DMRS-DownlinkConfig ::= | SEQUENCE { |
| dmrs-Type | ENUMERATED {type2} |

OPTIONAL, -- Need S

| | |
|---|---|
| dmrs-AdditionalPosition | ENUMERATED {pos0, pos1, pos3} |

OPTIONAL, -- Need S

| | |
|---|---|
| maxLength | ENUMERATED (len2} |

OPTIONAL, -- Need S

| | |
|---|---|
| scramblingID0 | INTEGER (0..65535) |

OPTIONAL, -- Need S

| | |
|---|---|
| scramblingID1 | INTEGER (0..65535) |
| | OPTIONAL, -- Need S |
| phaseTrackingRS | SetupRelease { PTRS-DownlinkConfig } |

```
OPTIONAL, -- Need M
  ...,
  [{
```

| | |
|---|---|
| dmrs-Downlink-r16 | ENUMERATED {enabled} |

OPTIONAL -- Need R
}]

| | |
|---|---|
| dmrs-Type-r18 | ENUMERATED {type2, etype1, etype2} |

OPTIONAL, -- Need S
}

[Higher layer configuration method 1-2] while a conventional meaning of an existing dmrs-Type wherein one of DMRS types 1 and 2 is determined is used, a new RRC IE having the meaning of whether enhanced DMRS type 1 or 2 is available may be additionally configured. As shown in Table 26-4 below, if the higher layer signaling dmrs-Type is not configured for a UE by a base station and enhanced-Dmrs-Type-r18 is not configured therefor, the UE may support a conventional scheme for DMRS type 1. In addition, if dmrs-Type is not configured for the UE and enhanced-Dmrs-Type-r18 is configured to be enabled, this may imply that the UE may support an enhanced scheme for DMRS type 1. In this case, in a case where the UE supports dynamic switching between a conventional type and an enhanced type, if enhanced-Dmrs-Type-r18 is configured for the UE, the UE may perform dynamic switching without additional higher layer signaling, or whether to perform dynamic switching may be configured by the base station for the UE through dynamicSwitchType that is an additional higher layer signaling.

TABLE 26-4

| | |
|---|---|
| DMRS-DownLinkConfig ::= | SEQUENCE { |
| dmrs-Type | ENUMERATED {type2} |

OPTIONAL, -- Need S

| | |
|---|---|
| dmrs-AdditionalPosition | ENUMERATED {pos0, pos1, pos3} |

OPTIONAL, -- Need S

| | |
|---|---|
| maxLength | ENUMERATED {len2} |

OPTIONAL, -- Need S

| | |
|---|---|
| scramblingID0 | INTEGER (0..65535) |

OPTIONAL, -- Need S

| | |
|---|---|
| scramblingID1 | INTEGER (0..65535) |

OPTIONAL, -- Need S

| | |
|---|---|
| phaseTrackingRS | SetupRelease { PTRS-DownlinkConfig } |

```
OPTIONAL, -- Need M
    ...,
    [{
```

| | |
|---|---|
| dmrs-Downlink-r16 | ENUMERATED {enabled} |

OPTIONAL -- Need R
}]

| | |
|---|---|
| enhanced-Dmrs-Type-r18 | ENUMERATED {enabled} |

OPTIONAL, -- Need S
}

[Higher layer configuration method 2] A UE may not use the higher layer signaling DMRS-DownlinkConfig in order to support an enhanced DMRS type, and an enhanced DMRS type being supported may be configured for the UE through a new RRC IE in PDSCH-Config individually to the higher layer signaling. As shown in Table 26-5 below, if the higher layer signaling enhanced-Dmrs-Type-r18 is not configured for a UE by a base station, the UE may determine a DMRS type according to an existing DMRS-DownlinkConfig configuration. If the higher layer signaling enhanced-Dmrs-Type-r18 is configured for the UE by the base station, the UE may use an enhanced scheme for a DMRS type determined according to an existing DMRS-DownlinkConfig configuration. In this case, in a case where the UE supports dynamic switching between a conventional type and an enhanced type, if enhanced-Dmrs-Type-r18 is configured for the UE, the UE may perform dynamic switching without additional higher layer signaling, or whether to perform dynamic switching may be configured by the base station for the UE through dynamicSwitchType that is an additional higher layer signaling.

TABLE 26-5

| | |
|---|---|
| PDSCH-Config ::= | SEQUENCE { |
| dataScramblingIdentityPDSCH | INTEGER (0..1023) |

OPTIONAL, -- Need S

| | |
|---|---|
| dmrs-DownlinkForPDSCH-MappingTypeA | SetupRelease { DMRS-DownlinkConfig } |

OPTIONAL, -- Need M

| | |
|---|---|
| dmrs-DownlinkForPDSCH-MappingTypeB | SetupRelease { DMRS-DownlinkConfig } |

OPTIONAL, -- Need M
...

| | |
|---|---|
| enhanced-Dmrs-Type-r18 | ENUMERATED {enabled} |

OPTIONAL, -- Need S

### Enhanced DMRS Type 1 Support Method

As another embodiment of a method of supporting enhanced DMRS type 1 described above, the UE may determine time and frequency resource mapping of a DMRS RE and an FD-OCC coefficient and a TD-OCC coefficient for the mapping in a case of using enhanced DMRS type 1, based on Equation 4-1 and Table 26-1-1 below. The following items have been created based on a downlink data channel demodulation signal (PDSCH DMRS) and may also be similarly applied to an uplink data channel demodulation signal (PUSCH DMRS), and a DMRS port number may be 0 to 15 rather than 1000 to 1015 as shown in the first column in Table 26-1-1. In the following Equation 4-1, v may indicate the number of layers of a PDSCH or PUSCH.

$${a}_{k , l}^{( {p}_{j} , μ )} = {β}_{PDSCH}^{DMRS} {w}_{f} ( {k}^{′} ) {w}_{t} ( {l}^{′} ) r ( 4 n + {k}^{′} ) k = 8 n + 2 {k}^{′} + Δ ( for enhanced DMRS type 1 ) {k}^{′} = 0 , 1 , 2 , 3 l = \overline{l} + {l}^{′} \\ n = 0 , 1 , … \\ j = 0 , 1 , … , v - 1 \qquad Equation 4 - 1$$

TABLE 26-1-1
Parameters for [enhanced DMRS type 1 support method]

| | CDM | | w_{f}(k′) | | | | wₜ(l′) | |
|---|---|---|---|---|---|---|---|---|
| p | group λ | Δ | k′ = 0 | k′ = 1 | k′ = 2 | k′ = 3 | l′ = 0 | l′ = 1 |
| 1000 | 0 | 0 | +1 | +1 | +1 | +1 | +1 | +1 |
| 1001 | 0 | 0 | +1 | −1 | +1 | −1 | +1 | +1 |
| 1002 | 1 | 1 | +1 | +1 | +1 | +1 | +1 | +1 |
| 1003 | 1 | 1 | +1 | −1 | +1 | −1 | +1 | +1 |
| 1004 | 0 | 0 | +1 | +1 | +1 | +1 | +1 | −1 |
| 1005 | 0 | 0 | +1 | −1 | +1 | −1 | +1 | −1 |
| 1006 | 1 | 1 | +1 | +1 | +1 | +1 | +1 | −1 |
| 1007 | 1 | 1 | +1 | −1 | +1 | −1 | +1 | −1 |
| 1008 | 0 | 0 | +1 | +1 | −1 | −1 | +1 | +1 |
| 1009 | 0 | 0 | +1 | +1 | −1 | −1 | +1 | +1 |
| 1010 | 1 | 1 | +1 | −1 | −1 | +1 | +1 | +1 |
| 1011 | 1 | 1 | +1 | −1 | −1 | +1 | +1 | +1 |
| 1012 | 0 | 0 | +1 | +1 | −1 | −1 | +1 | −1 |
| 1013 | 0 | 0 | +1 | +1 | −1 | −1 | +1 | −1 |
| 1014 | 1 | 1 | +1 | −1 | −1 | +1 | +1 | −1 |
| 1015 | 1 | 1 | +1 | −1 | −1 | +1 | +1 | −1 |

According to an embodiment, [enhanced DMRS type 1 support method] based on Equation 4-1 and Table 26-1-1 may use a total of two CDM groups. In a case of one front loaded DMRS symbol, four DMRS ports may be included in each CDM group and thus a maximum of eight orthogonal DMRS ports may be supported, and in a case of two front loaded DMRS symbols, eight DMRS ports may be included in each CDM group and thus a total of 16 orthogonal DMRS ports may be supported.

As described above, the number of DMRS ports in each CDM groups has been increased and the OCC length therefor has been increased to 4 while maintaining 2 as the number of CDM groups of conventional DMRS type 1. Therefore, scheduling of a PDSCH to be transmitted together with a DMRS may be used in units of two RB s, and a DMRS may be mapped to the same RE position as that of conventional DMRS type 1.

However, in conventional DMRS type 1, under the assumption that channels of two REs (e.g., RE #0 and RE #2) positioned to be spaced two REs apart from each other are the same, an OCC is applied to the two REs to distinguish between orthogonal ports, and in a case of one front loaded DMRS symbol, a total of six REs in one RB are used per port, and three OCCs having a length of 2 are used.

If [enhanced DMRS type 1 support method] is used, in a case of one front loaded DMRS symbol, a total of 12 REs in two RBs are used per port, and a total of four orthogonal antenna ports may be distinguished using an OCC having a length of 4 applied to adjacent four REs. The OCC having a length of 4 is applied to four REs, and the four REs may be spaced two REs apart from each other. That is, the OCC is required to be applied to four REs by considering, as the same channel, the four REs having the relative RE positions of 0, 2, 4, and 6, and thus channel estimation performance may be degraded compared to conventional DMRS type 1. Therefore, this enhanced DMRS type 1 may be used for multi-user MIMO in a channel with low frequency-selective characteristic.

In Table 26-1-1 described above, the w_{f}(k′) values of ports 1000 to 1015 among OCCs of a length of 4 may be determined to provide orthogonality between all ports, and the values in the above table merely correspond to an example and other values are not excluded. In Equation 4-1, β_{PDSCH}^{DMRS} is a scaling factor indicating the ratio between the energy-per-RE (EPRE) of a PDSCH and the EPRE of a DMRS, and may be calculated by β_{PDSCH}^{DMRS}=10β_{DMRS}/20, and the value of β_{DMRS} may be 0 dB and −3 dB according to 1 and 2 of the number of CDM groups.

### Enhanced DMRS Type 2 Support Method

Time and frequency resource mapping of a DMRS RE and an FD-OCC coefficient and a TD-OCC coefficient for the mapping in a case of using enhanced DMRS type 2, based on Equation 4-2 and Table 26-2-1 below may be determined. The following items have been created based on a downlink data channel demodulation signal (PDSCH DMRS) and may also be similarly applied to an uplink data channel demodulation signal (PUSCH DMRS), and a DMRS port number may be 0 to 23 rather than 1000 to 1023 as shown in the first column in Table 26-2-1. In the following Equation 4-2, v may indicate the number of layers of a PDSCH or PUSCH.

$${a}_{k , l}^{( {p}_{j} , μ )} = {β}_{P DSCH}^{DMRS} {w}_{f} ( {k}^{′} ) {w}_{t} ( {l}^{′} ) r ( 4 n + {k}^{′} ) k = 12 n + {k}^{′} + Δ ( for enhanced DMRS type 2 , {k}^{′} = 0 , 1 ) k = 12 n + {k}^{′} + Δ + 4 ( for enhanced DMRS type 2 , {k}^{′} = 2 , 3 ) \\ {k}^{′} = 0 , 1 , 2 , 3 l = \overline{l} + {l}^{′} \\ n = 0 , 1 , … \\ j = 0 , 1 , … , v - 1 \qquad Equation 4 - 2$$

TABLE 26-2-1
Parameters for [enhanced DMRS type 2 support method]

| | CDM | | w_{f}(k′) | | | | wₜ(l′) | |
|---|---|---|---|---|---|---|---|---|
| p | group λ | Δ | k′ = 0 | k′ = 1 | k′ = 2 | k′ = 3 | l′ = 0 | l′ = 1 |
| 1000 | 0 | 0 | +1 | +1 | +1 | +1 | +1 | +1 |
| 1001 | 0 | 0 | +1 | −1 | +1 | −1 | +1 | +1 |
| 1002 | 1 | 2 | +1 | +1 | +1 | +1 | +1 | +1 |
| 1003 | 1 | 2 | +1 | −1 | +1 | −1 | +1 | +1 |
| 1004 | 2 | 4 | +1 | +1 | +1 | +1 | +1 | +1 |
| 1005 | 2 | 4 | +1 | −1 | +1 | −1 | +1 | +1 |
| 1006 | 0 | 0 | +1 | +1 | +1 | +1 | +1 | −1 |
| 1007 | 0 | 0 | +1 | −1 | +1 | −1 | +1 | −1 |
| 1008 | 1 | 2 | +1 | +1 | +1 | +1 | +1 | −1 |
| 1009 | 1 | 2 | +1 | −1 | +1 | −1 | +1 | −1 |
| 1010 | 2 | 4 | +1 | +1 | +1 | +1 | +1 | −1 |
| 1011 | 2 | 4 | +1 | −1 | +1 | −1 | +1 | −1 |
| 1012 | 0 | 0 | +1 | +1 | −1 | +1 | +1 | +1 |
| 1013 | 0 | 0 | +1 | −1 | −1 | −1 | +1 | +1 |
| 1014 | 1 | 2 | +1 | +1 | −1 | +1 | +1 | +1 |
| 1015 | 1 | 2 | +1 | −1 | −1 | −1 | +1 | +1 |
| 1016 | 2 | 4 | +1 | +1 | −1 | +1 | +1 | +1 |
| 1017 | 2 | 4 | +1 | −1 | −1 | −1 | +1 | +1 |
| 1018 | 0 | 0 | +1 | +1 | −1 | +1 | +1 | −1 |
| 1019 | 0 | 0 | +1 | −1 | −1 | −1 | +1 | −1 |
| 1020 | 1 | 2 | +1 | +1 | −1 | +1 | +1 | −1 |
| 1021 | 1 | 2 | +1 | −1 | −1 | −1 | +1 | −1 |
| 1022 | 2 | 4 | +1 | +1 | −1 | +1 | +1 | −1 |
| 1023 | 2 | 4 | +1 | −1 | −1 | −1 | +1 | −1 |

According to an embodiment, [enhanced DMRS type 2 support method] based on Equation 4-2 and Table 26-2-1 may use a total of three CDM groups. In a case of one front loaded DMRS symbol, four DMRS ports may be included in each CDM group and thus a total of 12 orthogonal DMRS ports may be supported. In a case of two front loaded DMRS symbols, eight DMRS ports may be included in each CDM group and thus a total of 24 orthogonal DMRS ports may be supported.

As described above, the number of DMRS ports in each CDM groups has been increased while maintaining the number of CDM groups. Therefore, scheduling of a PDSCH to be transmitted together with a DMRS may be maintained in units of one RB identically to the existing scheduling, and a DMRS may be mapped to the same RE position as that of conventional DMRS type 2.

However, in conventional DMRS type 2, under the assumption that two consecutive REs belong to the same channel, an OCC is applied to the two REs to distinguish between orthogonal ports, and in a case of one front loaded DMRS symbol, a total of four REs in one RB are used per port, and two OCCs having a length of 2 are used.

If [enhanced DMRS type 2 support method] is based, in a case of one front loaded DMRS symbol, a total of four REs in one RB are used per port, and one OCC having a length of 4 may be used to distinguish between a total of four orthogonal ports. That is, an OCC having a length of 4 is applied to two consecutive RE sets spaced six REs apart from each other, that is, the OCC is required to be applied by considering, as the same channel, four REs having relative RE positions of 0, 1, 6, and 7. Therefore, channel estimation performance may be degraded compared to conventional DMRS type 2. Therefore, this enhanced DMRS type 2 may be used for multi-user MIMO in a channel with low frequency-selective characteristic.

In Equation 4-2 described above,

$${β}_{PDSCH}^{DMRS}$$

is a scaling factor indicating the ratio between the energy-per-RE (EPRE) of a PDSCH and the EPRE of a DMRS, and may be calculated by

$${β}_{PDSCH}^{DMRS} = {10}^{- \frac{{β}_{DMRS}}{20}} ,$$

and the value of β_{DMRS} may be 0 dB, −3 dB, and −4.77 dB according to 1, 2, and 3 of the number of CDM groups.

With respect to [enhanced DMRS type 1 support method] and [enhanced DMRS type 2 support method] described above, a UE may report a UE capability meaning each support method being possible to a base station. The UE capability may be valid only for FR1, or may be valid for both FR1 and FR2. The UE capability may include the meaning wherein “as a maximum number of supported ports, for enhanced DMRS type 1, 8 ports are possible when one front-loaded DMRS symbol is used and 16 ports are possible when two front-loaded DMRS symbols are used, and for enhanced DMRS type 2, 12 ports are possible when one front-loaded DMRS symbol is used and 24 ports are possible when two front-loaded DMRS symbols are used.” After receiving the UE capability, the base station may configure a higher layer signaling corresponding thereto, and this may be one of the higher layer signaling configuration methods described above, or may be independent higher layer signaling.

The base station and the UE may support at least one of [enhanced DMRS type 1 support method] or [enhanced DMRS type 2 support method] through a configuration method through higher layer signaling, an indication method based on L1 signaling, a combination method of higher layer signaling and L1 signaling, or a method fixedly specified in a specification.

### Second Embodiment: Method of Additionally Supporting Enhanced DMRS Types 1 and 2 Supporting Increased Number of Orthogonal Ports

As an embodiment of the disclosure, a method of additionally supporting enhanced DMRS types 1 and 2 supporting an increased number of orthogonal ports is described. This embodiment may be operated in combination with other embodiments.

As an additional parameter for [enhanced DMRS type 1 support method] described above, through Table 26-6-1 below, the relation relating to which CDM group in which a DMRS port is included or which FD-OCC index or TD-OCC index is usable may be additionally defined according to which DMRS port is used. In addition, as an additional parameter for [enhanced DMRS type 2 support method] described above, through Table 26-6-2 below, the relation relating to which CDM group in which a DMRS port is included or which FD-OCC index or TD-OCC index is usable may be additionally defined according to which DMRS port is used. The following Table 26-6-3 and Table 26-6-4 may define FD-OCC indexes available in Table 26-6-1 and Table 26-6-2, while Table 26-6-5 and Table 26-6-6 may define TD-OCC indexes available in Table 26-6-1 and Table 26-6-2. In Table 26-6-1 and Table 26-6-2, p indicates a DMRS port, p is used in a case of PDSCHs, and a value obtained by subtracting 1000 from p may be used in a case of PUSCHs.

In Table 26-6-1 below, DMRS ports 1000 to 1003 and 1008 to 1011 may be used for a case of single or double front-loaded DMRS symbols, while DMRS ports 1004 to 1007 and 1012 to 1015 may be used for a case of double front-loaded DMRS symbols.

In Table 26-6-2 below, DMRS ports 1000 to 1005 and 1012 to 1017 may be used for a case of single or double front-loaded DMRS symbols, while DMRS ports 1006 to 1011 and 1018 to 1023 may be used for a case of double front-loaded DMRS symbols.

J, used in Table 26-6-3 to Table 26-6-6 below, is an imaginary number and may indicate sqrt(−1).

In order to support [enhanced DMRS type 1 support method] and [enhanced DMRS type 2 support method] described above, Table 26-6-1 and Table 26-6-2 below may be used respectively, and indexes of an FD-OCC and TD-OCC to be used in each of Table 26-6-1 and Table 26-6-2 may be determined using at least one type of Table 26-6-3 to Table 26-6-6 below. The above determination may be configured for the UE by the base station through higher layer signaling, may be dynamically indicated through L1 signaling, may be notified through a combination of higher layer signaling and L1 signaling, or may be defined in a specification.

According to an embodiment, when the base station schedules a PDSCH or PUSCH, the UE may determine one type of FD-OCC and TD-OCC among Table 26-6-3 to Table 26-6-6 below and apply same to PDSCH and PUSCH scheduling in common.

According to an embodiment, when the base station schedules a PDSCH and PUSCH, the UE may determine one type of FD-OCC and TD-OCC among Table 26-6-3 to Table 26-6-6 below and apply same to PDSCH scheduling, and may determine another type of FD-OCC and TD-OCC among Table 26-6-3 to Table 26-6-6 below and apply same to PUSCH scheduling. For example, when the base station schedules a PDSCH, the UE may use an FD-OCC index and a value in Table 26-6-3 with respect to enhanced DMRS types 1 and 2 described above, and when the base station schedules a PUSCH, the UE may use an FD-OCC index and a value in Table 26-6-4 with respect to enhanced DMRS types 1 and 2 described above. However, this merely corresponds to an example, and various embodiments of the disclosure may not exclude any combinations such as the UE using same FD-OCC for a PDSCH and a PUSCH and using different TD-OCCs for the PDSCH and the PUSCH.

Table 26-6-1 and Table 26-6-2 below are prepared based on a PDSCH DMRS and may be similarly applied to a PUSCH DMRS. In this case, the DMRS port numbers may be 0 to 15 instead of 1000 to 1015 as shown in the first column of Table 26-6-1, and 0 to 23 instead of 1000 to 1023 as shown in the first column of Table 26-6-2.

Table 26-6-6 below is prepared based on a PUSCH DMRS and may be similarly applied to a PDSCH DMRS. In this case, the DMRS port numbers may be, for enhanced DMRS type 1, 100 to 1007 and 1008 to 1015 instead of 0 to 7 and 8 to 15 as shown in the first row of Table 26-6-6. For enhanced DMRS type 2, the DMRS port numbers may be 1000 to 1011 and 1012 to 1023 instead of 0 to 11 and 12 to 23 as shown in the first row of Table 26-6-6.

TABLE 26-6-1
Additional parameters for [enhanced
DMRS type 1 support method]

| p | CDM group λ | Δ | FD-OCC index | TD-OCC index |
|---|---|---|---|---|
| 1000 | 0 | 0 | 0 | 0 |
| 1001 | 0 | 0 | 1 | 0 |
| 1002 | 1 | 1 | 0 | 0 |
| 1003 | 1 | 1 | 1 | 0 |
| 1004 | 0 | 0 | 0 | 1 |
| 1005 | 0 | 0 | 1 | 1 |
| 1006 | 1 | 1 | 0 | 1 |
| 1007 | 1 | 1 | 1 | 1 |
| 1008 | 0 | 0 | 2 | 0 |
| 1009 | 0 | 0 | 3 | 0 |
| 1010 | 1 | 1 | 2 | 0 |
| 1011 | 1 | 1 | 3 | 0 |
| 1012 | 0 | 0 | 2 | 1 |
| 1013 | 0 | 0 | 3 | 1 |
| 1014 | 1 | 1 | 2 | 1 |
| 1015 | 1 | 1 | 3 | 1 |

TABLE 26-6-2
Additional parameters for [enhanced
DMRS type 2 support method]

| p | CDM group λ | Δ | FD-OCC index | TD-OCC index |
|---|---|---|---|---|
| 1000 | 0 | 0 | 0 | 0 |
| 1001 | 0 | 0 | 1 | 0 |
| 1002 | 1 | 2 | 0 | 0 |
| 1003 | 1 | 2 | 1 | 0 |
| 1004 | 2 | 4 | 0 | 0 |
| 1005 | 2 | 4 | 1 | 0 |
| 1006 | 0 | 0 | 0 | 1 |
| 1007 | 0 | 0 | 1 | 1 |
| 1008 | 1 | 2 | 0 | 1 |
| 1009 | 1 | 2 | 1 | 1 |
| 1010 | 2 | 4 | 0 | 1 |
| 1011 | 2 | 4 | 1 | 1 |
| 1012 | 0 | 0 | 2 | 0 |
| 1013 | 0 | 0 | 3 | 0 |
| 1014 | 1 | 2 | 2 | 0 |
| 1015 | 1 | 2 | 3 | 0 |
| 1016 | 2 | 4 | 2 | 0 |
| 1017 | 2 | 4 | 3 | 0 |
| 1018 | 0 | 0 | 2 | 1 |
| 1019 | 0 | 0 | 3 | 1 |
| 1020 | 1 | 2 | 2 | 1 |
| 1021 | 1 | 2 | 3 | 1 |
| 1022 | 2 | 4 | 2 | 1 |
| 1023 | 2 | 4 | 3 | 1 |

TABLE 26-6-3
Available FD-OCC indexes and coefficients

| FD-OCC index | w_{f}(0) | w_{f}(1) | w_{f}(2) | w_{f}(3) |
|---|---|---|---|---|
| 0 | +1 | +1 | +1 | +1 |
| 1 | +1 | −1 | +1 | −1 |
| 2 | +1 | +1 | −1 | −1 |
| 3 | +1 | −1 | −1 | +1 |

TABLE 26-6-4
Available other FD-OCC indexes and coefficients

| FD-OCC index | w_{f}(0) | w_{f}(1) | w_{f}(2) | w_{f}(3) |
|---|---|---|---|---|
| 0 | +1 | +1 | +1 | +1 |
| 1 | +1 | −1 | +1 | −1 |
| 2 | +1 | +j | −1 | −j |
| 3 | +1 | −j | −1 | +j |

TABLE 26-6-5
FD-OCC indexes and coefficients for [enhanced DMRS type 1 support
method] and [enhanced DMRS type 2 support method]

| TD-OCC index | w_{f}(0) | w_{f}(1) |
|---|---|---|
| 0 | +1 | +1 |
| 1 | +1 | −1 |

TABLE 26-6-6
Other FD-OCC indexes and coefficients for [enhanced
DMRS type 1 support method] and [enhanced
DMRS type 2 support method]

| | DMRS port 0~7 | | DMRS port 8~15 | |
|---|---|---|---|---|
| | (Enhanced DMRS type 1) | | (Enhanced DMRS type 1) | |
| | DMRS port 0~11 | | DMRS port 12~23 | |
| | (Enhanced DMRS type 2) | | (Enhanced DMRS type 2) | |
| TD-OCC index | w_{f}(0) | w_{f}(1) | w_{f}(0) | w_{f}(1) |
| 0 | +1 | +1 | +1 | +j |
| 1 | +1 | −1 | +1 | −j |

### Third Embodiment: Additional Support Method for DMRS Type and Enhanced DMRS Type

As an embodiment of the disclosure, an additional support method for a DMRS type and an enhanced DMRS type is described. This embodiment may be operated in combination with other embodiments.

According to an embodiment, one or more DMRS ports based on a DMRS type and an enhanced DMRS type may be indicated to the UE through an antenna port field in a DCI format capable of scheduling a PDSCH or PUSCH among all DCI formats except for DCI formats 0_0 and 1_0,

For example, a type of a DMRS port indicated through an antenna port field in DCI format 1_1 may be configured for the UE by the base station through dmrs-DownlinkForPDSCH-MappingTypeA and/or dmrs-DownlinkForPDSCH-MappingTypeB in the higher layer signaling PDSCH-Config.

As another example, a type of a DMRS port indicated through an antenna port field in DCI format 1_2 may be configured for the UE by the base station through dmrs-DownlinkForPDSCH-MappingTypeA-DCI-1-2 and/or dmrs-DownlinkForPDSCH-MappingTypeB-DCI-1-2 in the higher layer signaling PDSCH-Config.

As another example, a type of a DMRS port indicated through an antenna port field in DCI format 1_3 may be configured for the UE by the base station through dmrs-DownlinkForPDSCH-MappingTypeA and/or dmrs-DownlinkForPDSCH-MappingTypeB in the higher layer signaling PDSCH-Config. That is, the UE may expect that a DMRS type based on the same higher layer signaling parameter is indicated as the types of the DMRS ports indicated through the antenna port fields in DCI formats 1_1 and 1_3.

As another example, a type of a DMRS port indicated through an antenna port field in DCI format 4_2 may be configured for the UE by the base station through dmrs-DownlinkForPDSCH-MappingTypeA and/or dmrs-DownlinkForPDSCH-MappingTypeB in the higher layer signaling pdsch-ConfigMulticast.

According to various embodiments of the disclosure, the UE and the base station may perform the following operations for all the above DCI formats.

According to an embodiment, when PDSCH scheduling is received from the base station through DCI, the UE may be notified that the PDSCH scheduling is based on one of PDSCH mapping type A or B, through a time domain resource assignment (TDRA) field in the DCI.

In addition, when the PDSCH mapping type indicated through the TDRA field in the DCI is PDSCH mapping type A, dmrs-DownlinkForPDSCH-MappingTypeA or dmrs-DownlinkForPDSCH-MappingTypeA-DCI-1-2 in PDSCH-config, or dmrs-DownlinkForPDSCH-MappingTypeA in pdsch-ConfigMulticast may be configured for the UE as a higher layer signaling for a DMRS type connected to mapping type A.

In addition, when the PDSCH mapping type indicated through the TDRA field in the DCI is PDSCH mapping type B, dmrs-DownlinkForPDSCH-MappingTypeB or dmrs-DownlinkForPDSCH-MappingTypeB-DCI-1-2 in PDSCH-config, or dmrs-DownlinkForPDSCH-MappingTypeB in pdsch-ConfigMulticast may be configured for the UE as a higher layer signaling for a DMRS type connected to mapping type A.

In addition, the UE may identify, through higher layer signaling, a DMRS type connected to the PDSCH mapping type indicated through the TDRA field in the DCI, and may interpret an antenna port field in the DCI by using the DMRS type. If the DMRS type connected to PDSCH mapping type A indicated through the TDRA field in the DCI is DMRS type 1, the UE may use DMRS type 1 to interpret the antenna port field in the DCI.

In addition, PDSCH mapping types A and B may be indicated to the UE from the base station through different codepoints in a TDRA field in DCI. To this end, a different PDSCH mapping type for each of values of PDSCH-TimeDomainResourceAllocation indicating respective entries in the higher layer signaling pdsch-TimeDomainAllocationList may be configured for the UE through the higher layer signaling mappingType.

In addition, higher layer signaling may be configured for the UE by the base station so that different DMRS types are connected to different PDSCH mapping types. In this case, the UE may expect that different DMRS types connected to different PDSCH mapping types are all normal DMRS types (e.g., introduced in NR Release 15)(e.g., DMRS type 1 for PDSCH mapping type A and DMRS type 2 for PDSCH mapping type B), or different DMRS types are all enhanced DMRS types (e.g., introduced in NR Release 18)(e.g., enhanced DMRS type 1 for PDSCH mapping type A and enhanced DMRS type 2 for PDSCH mapping type B). On the contrary, the UE may not expect that different DMRS types connected to different PDSCH mapping types correspond to a normal DMRS type and an enhanced DMRS type (e.g., the UE may not expect that normal DMRS type 1 is connected to PDSCH mapping type A and enhanced DMRS type 1 is connected to PDSCH mapping type B).

In addition, the UE may expect that it is possible for different DMRS types to be indicated for different DCI formats. For example, the UE may expect that it is possible that, through a TDRA field in DCI format 1_1 from the base station, enhanced DMRS type 1 being connected to PDSCH mapping type A is configured and enhanced DMRS type 2 being connected to PDSCH mapping type B is configured and, through a TDRA field in DCI format 1_2, DMRS type 1 being connected to PDSCH mapping type A is configured and DMRS type 2 being connected to PDSCH mapping type B is configured, and the UE may expect that there is no limit to the configuration.

According to an embodiment, it may be possible for each DCI format described above to be monitored in a search space mentioned below.

searchSpaceType in the higher layer signaling searchSpace may be configured for the UE for a particular search space by the base station so that the UE is notified of whether the corresponding search space is a UE-specific search space or a group-common search space.

If common is configured for the UE as the higher layer signaling searchSpaceType, a corresponding search space may be a group-common search space and if ue-Specific is configured, the corresponding search space may be a UE-specific search space.

Common may be configured for the UE as searchSpaceType, and the higher layer parameter common may include a higher layer parameter called dci-Format4-2-r17. If the higher layer parameter called dci-Format4-2-r17 being included in the higher layer parameter common is configured for the UE by the base station, the UE may monitor DCI format 4_2 including a CRC scrambled with a G-RNTI or G-CS-RNTI in a corresponding group-common search space.

ue-Specific may be configured for the UE as searchSpaceType, and the higher layer parameter ue-Specific may include a higher layer parameter called dci-Formats. The higher layer parameter called dci-Formats having one value of “formats0-0-And-1-0” or “formats0-1-And-1-1” may be configured for the UE by the base station. If the value of “formats0-0-And-1-0” is configured for the UE as the higher layer parameter called dci-Formats, the UE may monitor DCI formats 0_0 and 1_0 in a corresponding UE-specific search space. If the value of “formats0-1-And-1-1” is configured for the UE as the higher layer parameter called dci-Formats, the UE may monitor DCI formats 0_1 and 1_1 in a corresponding UE-specific search space.

ue-Specific may be configured for the UE as searchSpaceType, and the higher layer parameter ue-Specific may include a higher layer parameter called dci-FormatsExt-r16. The higher layer parameter called dci-FormatsExt-r16 having one value of “formats0-2-And-1-2” or “formats0-1-And-1-1And-0-2-And-1-2” may be configured for the UE by the base station. If the value of “formats0-2-And-1-2” is configured for the UE as the higher layer parameter called dci-FormatsExt-r16, the UE may monitor DCI formats 0_2 and 1_2 in a corresponding UE-specific search space. If the value of “formats0-1-And-1-1And-0-2-And-1-2” is configured for the UE as the higher layer parameter called dci-FormatsExt-r16, the UE may monitor DCI formats 0_1, 1_1, 0_2, and 1_2 in a corresponding UE-specific search space. If both dci-Formats and dci-FormatsExt-r16 are configured for the UE in the higher layer parameter ue-Specific, the UE may disregard dci-Formats.

ue-Specific may be configured for the UE as searchSpaceType, and the higher layer parameter ue-Specific may include a higher layer parameter called dci-FormatsMC. The higher layer parameter called dci-FormatsMC having one value of “formats0-3,” “formats1-3,” or “formats0-3-And-1-3” may be configured for the UE by the base station. If the value of “formats0-3” is configured for the UE as the higher layer parameter called dci-FormatsMC, the UE may monitor DCI format 0_3 in a corresponding UE-specific search space. If the value of “formats1-3” is configured for the UE as the higher layer parameter called dci-FormatsMC, the UE may monitor DCI format 1_3 in a corresponding UE-specific search space. If the value of “formats0-3-And-1-3” is configured for the UE as the higher layer parameter called dci-FormatsMC, the UE may monitor DCI formats 0_3 and 1_3 in a corresponding UE-specific search space. If dci-FormatsMC is configured for the UE in the higher layer parameter ue-Specific with respect to a random UE-specific search space, the UE may not monitor DCI formats other than DCI formats 0_3 and/or 1_3 in the UE-specific search space.

If the higher layer parameter called dci-Format4-2-r17 being included in the higher layer parameter common is configured for the UE by the base station, the UE may monitor DCI format 4_2 including a CRC scrambled with a G-RNTI or G-CS-RNTI in a corresponding search space.

According to various embodiments of the disclosure, if only downlink scheduling DCI is considered, the UE may monitor at least one of DCI formats 1_0, 1_1, 1_2, 1_3, and 4_2 in a particular search space according to a higher layer signaling configuration from the base station.

According to various embodiments of the disclosure, the UE may report which DMRS type is supportable to the base station through a UE capability.

The UE may report, to the base station, which DMRS type is supportable among normal DMRS type 1 and DMRS type 2 (e.g., defined in NR Release 15), in consideration of a DMRS for a PDSCH. The UE may report whether only DMRS type 1 is supportable to the base station or report that both DMRS type 1 and DMRS type 2 are supportable to the base station. The UE may always mandatorily support DMRS type 1. Whether the UE supports DMRS type 2 may be optional. A corresponding UE capability report may be defined per feature set (FS), and may be a UE capability report for a band in a particular band combination. If a corresponding UE capability is not reported to the base station, the UE may understand that only DMRS type 1 is supportable. The corresponding UE capability may be, hereinafter, called a DMRS type-related UE capability.

The UE may report, to the base station, which enhanced DMRS type is supportable among enhanced DMRS type 1 and DMRS type 2 (e.g., defined in NR Release 18), in consideration of a DMRS for a PDSCH. The UE may report whether only enhanced DMRS type 1 is supportable to the base station or report that both enhanced DMRS type 1 and enhanced DMRS type 2 are supportable to the base station. A corresponding UE capability report may be optional to the UE. A corresponding UE capability may be defined per FS, and may correspond to a UE capability report for a band in a particular band combination. If the corresponding UE capability is not reported to the base station, the UE may understand that both enhanced DMRS type 1 and enhanced DMRS type 2 are not supported. The corresponding UE capability may be, hereinafter, called an enhanced DMRS type-related UE capability.

According to various embodiments of the disclosure, the following items may be possible for an operation of the UE and the base station.

The UE may report that a maximum of four different DMRS types (e.g., DMRS type 1, DMRS type 2, enhanced DMRS type 1, and enhanced DMRS type 2) are supportable, to the base station through a DMRS type-related UE capability and an enhanced DMRS type-related UE capability.

The UE may interpret the meaning that four different DMRS types are supportable, which is reported as a UE capability, as “the meaning that the UE includes and reports all respective supportable DMRS types.” However, this may not be necessarily interpreted as the meaning that the reported different DMRS types may be simultaneously configured through higher layer signaling and indicated through the same or different DCI formats. In this case, even if the UE considers and reports only whether each DMRS type is supportable to the base station, the base station may simultaneously transfer, to the UE, all configurations for different DMRS types reported by the UE, thereby providing the UE with a higher layer signaling configuration that the UE is unable to perform. In this case, the UE may report more UE capabilities than actual capabilities.

As another method, the UE may interpret the meaning that different DMRS types are supportable, which is reported as a UE capability, as “the meaning that the UE simultaneously includes and reports all respective supportable DMRS types through higher layer signaling.” In this case, the UE is able to actually support four different DMRS types, but because it is not possible for the DMRS types to be simultaneously configured for the UE and supported thereby, the UE may report fewer UE capabilities than actual capabilities by considering the number of simultaneously configurable DMRS types among the four types.

According to an embodiment, the base station having received such a UE capability may configure 4 as a maximum number of different DMRS types indicatable through different DCI formats, for the UE through higher layer signaling.

For example, a search space in which DCI format 1_1 and DCI format 1_2 are monitorable may be configured for the UE by the base station. Through the above methods, enhanced DMRS type 1 and enhanced DMRS type 2 may be configured for the UE as DMRS types indicatable through DCI format 1_1, and DMRS type 1 and DMRS type 2 may be configured as DMRS types indicatable through DCI format 1_2. In this case, a total of four different DMRS types may be configured for the UE by the base station across DCI formats 1_1 and 1_2 that are monitorable in the search space and, accordingly, a PDSCH DMRS port may be indicated to the UE.

As another example, a search space in which DCI format 1_1 is monitorable may be configured for the UE by the base station, and another search space in which DCI format 4_2 is monitorable may be configured. Through the above methods, enhanced DMRS type 1 and enhanced DMRS type 2 may be configured for the UE as DMRS types indicatable through DCI format 1_1, and DMRS type 1 and DMRS type 2 may be configured as DMRS types indicatable through DCI format 4_2. In this case, different respective two DMRS types may be configured for the UE by the base station in each search space, a total of four different DMRS types may be configured for the UE by the base station across the two search spaces, and, accordingly, a PDSCH DMRS port may be indicated to the UE.

According to various embodiments of the disclosure, in order to perform channel estimation for a PDSCH DMRS, the UE may load in advance, in a memory of the UE, channel estimation-related parameters corresponding to different numbers of DMRS types configured by the base station through higher layer signaling for all DCI formats monitorable in all search spaces that the UE is able to monitor. According to a loaded channel estimation-related parameter, the UE may measure a channel, based on a reference signal transmitted from the base station and periodically update the parameter, based on a corresponding measured value. According to various embodiments, the channel estimation-related parameter described above is a minimum mean square error (MMSE) filter coefficient and may be called a channel correlation matrix.

[Channel estimation parameter management method 1] As described above, loading a channel estimation-related parameter in the memory of the UE may be performed before the UE decodes a DCI format receivable every monitoring position of a search space. This is because, when the UE loads a DMRS type indicatable by a DCI format after identifying the DCI format, delay may increase as much.

[Channel estimation parameter management method 2] As another method, the UE may decode a particular DCI format in each search space, identify a DMRS type indicatable by the DCI format, and then loads a channel estimation-related parameter. This method is advantageous in that the UE does not prepare all channel estimation-related parameters for all configured DMRS types and may load a parameter only when decoding a random DCI format so as to save the memory. However, the UE needs to perform an operation of preparing a channel estimation-related parameter after DCI format decoding, and thus there may occur additional delay after DCI format decoding until channel estimation for a PDSCH DMRS and a demodulation operation for data in a PDSCH.

Through various methods other than the above two methods, the UE may manage a channel estimation parameter for a DMRS type configured for the UE by the base station through higher layer signaling, and this may vary according to the implementation of the UE.

As described above, the UE may manage a channel estimation parameter for a DMRS type configured by the base station through higher layer signaling, and the number of different DMRS types configurable for the UE by the base station through higher layer signaling may be restricted according to the implementation of the UE. For example, if a particular UE implements a PDSCH DMRS channel estimation scheme, based on [Channel estimation parameter management method 1] described above, the number of different DMRS types maximally configurable for the UE by the base station through higher layer signaling may be restricted according to the memory state of the UE or the complexity of a channel estimation algorithm. As another example, if a particular UE implements a PDSCH DMRS channel estimation scheme, based on [Channel estimation parameter management method 2] described above, every time the UE decodes a DCI format, the UE may need to load a channel estimation-related parameter according to a DMRS type indicatable by the DCI format, and thus the UE may require an additional processing time when receiving and decoding a PDSCH.

Meanwhile, as described above, a DMRS type-related UE capability and an enhanced DMRS type-related UE capability may report more or fewer UE capabilities of the UE than actual capabilities of the UE, and thus the UE may not be able to reflect the implementation matters of the UE managing a channel estimation-related parameter of the UE to report an accurate UE capability to the base station. To solve this problem, the UE and the base station may consider at least one combination of the following items.

### Method 3-1

According to an embodiment, the UE may report the total number of different DMRS types maximally configurable for the UE, to the base station through a UE capability.

If MMSE filter coefficient complexities and memory usage amounts corresponding to DMRS type 1, DMRS type 2, enhanced DMRS type 1, and enhanced DMRS type 2 are similar or identical in the UE implementation, the UE may report, to the base station, one value among 2, 3, and 4 as a candidate value of a corresponding UE capability report. The UE needs to necessarily support DMRS type 1, and thus reporting 1 as a candidate value to the base station may not be necessary. The UE may report 2 through the corresponding UE capability report only when the UE has reported at least two different supportable DMRS types through a DMRS type-related UE capability and an enhanced DMRS type-related UE capability. The UE may report 3 through the corresponding UE capability report only when the UE has reported at least three different supportable DMRS types through a DMRS type-related UE capability and an enhanced DMRS type-related UE capability. The UE may report 4 through the corresponding UE capability report only when the UE has reported at least four different supportable DMRS types through a DMRS type-related UE capability and an enhanced DMRS type-related UE capability.

If MMSE filter coefficient complexities and memory usage amounts corresponding to normal DMRS types (DMRS type 1 and DMRS type 2) are similar or identical in the UE implementation, MMSE filter coefficient complexities and memory usage amounts corresponding to enhanced DMRS types (enhanced DMRS type 1 and enhanced DMRS type 2) are similar or identical, and MMSE filter coefficient complexities and memory usage amounts between a normal DMRS type and an enhanced DMRS type are different from each other in consideration of matters of FD-OCCs having different lengths, the UE may report the number of DMRS types and the number of enhanced DMRS types to the base station as candidate values of a UE capability. In this case, the UE may report 2 as the number of normal DMRS types and if this value is not reported, the UE may consider that the UE supports only DMRS type 1. The UE may report 2 as the number of normal DMRS types through a corresponding UE capability report only when the UE has reported, through a DMRS type-related UE capability, supporting of both DMRS type 1 and DMRS type 2. In addition, the UE may report 1 or 2 as the number of enhanced DMRS types and if this value is not reported, the UE may consider that the UE does not include an enhanced DMRS type when considering the number of simultaneously configurable different DMRS types. The UE may report 1 as the number of enhanced DMRS types through a corresponding UE capability report only when the UE has reported, through an enhanced DMRS type-related UE capability, supporting of only enhanced DMRS type 1 or supporting of both enhanced DMRS type 1 and enhanced DMRS type 2. The UE may report 2 as the number of enhanced DMRS types through a corresponding UE capability report only when the UE has reported, through an enhanced DMRS type-related UE capability, supporting of both enhanced DMRS type 1 and enhanced DMRS type 2.

If MMSE filter coefficient complexities and memory usage amounts corresponding to DMRS type 1 and enhanced DMRS type 1 are similar or identical in the UE implementation, MMSE filter coefficient complexities and memory usage amounts corresponding to DMRS type 2 and enhanced DMRS type 2 are similar or identical, and MMSE filter coefficient complexities and memory usage amounts between DMRS type 1 and enhanced DMRS type 1, and DMRS type 2 and enhanced DMRS type 2 are different from each other in consideration of RE mapping, the number of CDM groups, etc., the UE may report, as candidate values of a UE capability, 2 that is the number of simultaneously supportable types among DMRS type 1 and enhanced DMRS type 1, and report 1 or 2 that is the number of simultaneously supportable types among DMRS type 2 and enhanced DMRS type 2.

The UE capability described above may be configured for all possible DMRS types configured for the UE as described above. A higher layer signaling configuration unit considered by the UE may be considered as a particular bandwidth part, a particular cell, all cells within a particular band, all cells within a particular band of a particular band combination, or a particular UE.

The UE capability described above may be considered for all DMRS types usable in a particular time unit for each particular bandwidth part, each particular cell, all cells within a particular band, all cells within a particular band of a particular band combination, or each particular UE. The particular time unit may be a slot, a frame, a subframe, a symbol, a span which is the unit in which the UE monitors a search space, or a monitoring position within a particular slot or a particular span, or the above consideration may not involve any time unit constraints. When the above consideration is performed without any constraints of the time unit, the corresponding UE capability may be applied in a case where a DMRS type is configured within the higher layer signaling configuration unit considered by the UE.

After the UE reports a corresponding UE capability, the base station may combine the UE capability and a DMRS type-related UE capability and an enhanced DMRS type-related UE capability reported by the UE to transfer, to the UE, a higher layer signaling configuration limiting the number of different DMRS types to be configured for the UE within a particular time unit and a higher layer signaling configuration unit. For example, if the UE has reported, through a DMRS type-related UE capability, that DMRS type 1 and DMRS type 2 are supportable, the UE has reported, through an enhanced DMRS type-related UE capability, that enhanced DMRS type 1 is supportable, and the UE has reported 2 through a corresponding UE capability when MMSE filter coefficient complexities and memory usage amounts corresponding to DMRS type 1, DMRS type 2, enhanced DMRS type 1, and enhanced DMRS type 2 are similar or identical in the UE implementation, the UE may expect that two of three different DMRS types (DMRS type 1, DMRS type 2, and enhanced DMRS type 1) reported through the DMRS type-related UE capability and the enhanced DMRS type-related UE capability is configured by the base station for each of all cells within a particular band of a particular band combination. For example, DMRS type 1 and enhanced DMRS type 1 may be configured by the base station for the UE across all the cells within a particular band of the particular band combination, and based on the configuration, a PDSCH DMRS port according to DMRS type 1 or enhanced DMRS type 1 may be indicated to the UE, based on an antenna port field in a particular DCI format.

According to an embodiment, a UE capability described above may include the maximum number of different DMRS types configured to be indicated to the UE through all downlink DCI formats (e.g., DCI formats 1_1, 1_2, 1_3, and 4_2) configured by the base station so that the UE monitors DCI formats except for DCI format 1_0. When the UE reports a corresponding UE capability, a situation where a DMRS type-related UE capability (e.g., feature group 2-10) and an enhanced DMRS type-related UE capability (e.g., feature group 40-4-1) have been reported may need to be determined in advance. The UE may report the UE capability to the base station for each feature set or each band in a band combination. The UE may report a value of 2, 3, or 4 to the base station through the UE capability. As another example, the UE may report a value of 3 or 4 to the base station through the UE capability.

### [Method 3-2]

According to an embodiment, when a particular number of DMRS types or more are configured for the UE through higher layer signaling, the UE may have a scheduling restriction in the time domain on the reception time point of a PDSCH schedulable by the base station, according to which implementation the UE has. For example, if a particular number of different DMRS types or more are configured for the UE by the base station through higher layer signaling within a particular higher layer signaling configuration unit (e.g., for each particular bandwidth part, each particular cell, all cells within a particular band, all cells within a particular band of a particular band combination, or each particular UE), when a PDSCH is scheduled by the base station, the UE may expect that the PDSCH is scheduled after a particular time, symbol, or slot from the reception time position of DCI including scheduling information on the PDSCH. The particular number of DMRS types causing the UE to have a PDSCH scheduling restriction may be notified to the UE by the base station through at least one combination of higher layer signaling, MAC-CE signaling, and L1 signaling, may be transferred by the UE to the base station through a UE capability, or may be fixedly defined in a specification. In addition, a particular time interval, a symbol length, or the number of slots required from a DCI reception time point, which may be considered by the UE as a scheduling restriction on a PDSCH, may be notified to the UE by the base station through at least one combination of higher layer signaling, MAC-CE signaling, and L1 signaling, may be transferred to the base station through a UE capability, or may be fixedly defined in a specification. For example, in a case where the UE reports 3 with respect to maximally simultaneously configurable DMRS types through [Method 3-1], if more than three DMRS types are configured for the UE, the UE may expect that the UE is to receive a PDSCH from the base station by considering a restriction on PDSCH scheduling.

### Method 3-3

According to an embodiment, when a particular number of DMRS types or more are configured for the UE through higher layer signaling, the UE may have a scheduling restriction in the time domain on the reception time point of a PDSCH schedulable by the base station, according to which implementation the UE has. Such a scheduling restriction may be defined in a manner of defining an additional parameter in a PDSCH processing time. The PDSCH processing time may indicate a minimum value of a time from the last symbol of a PDSCH reception by the UE until a PUCCH transmission including HARQ-ACK information for the PDSCH. For example, the UE may transmit a PUCCH including HARQ-ACK information for a PDSCH after a PDSCH processing time from the last symbol on which the PDSCH is received.

In a case where the UE receives scheduling information to receive a PDSCH from the base station through DCI, the UE may need a PDSCH processing time to apply a PDSCH transmission method (e.g., modulation/demodulation and coding indication index (MCS), demodulation reference signal-related information, and time and frequency resource allocation information) indicated through the DCI and receive the PDSCH. The PDSCH processing time of the UE may follow Equation 5 below.

$$Tproc , 1 = ( N 1 + d 1 , 1 + d 2 + d 3 + d 4 ) ( 2048 + 1 \; 44 ) k 2 - μ Tc + Text \qquad Equation 5$$

Each variable of T_{proc,1} described above as Equation 5 may have the following meaning.
N1: The number of symbols determined according to numerology and UE processing capability 1 or 2 corresponding to the capability of the UE

According to an embodiment, if UE processing capability 1 is reported according to a capability report of the UE, N1 may have values in Table 27. If UE processing capability 2 is reported and UE processing capability 2 being available is configured through higher layer signaling, N1 may have values in Table 28. Numerology may correspond to a minimum value among μ^{PDCCH}, μ^{PDSCH}, μ^{UL} to maximize T_{proc,1}, μ^{PDCCH}, μ^{PDSCH}, μ^{UL} may indicate the numerology of a PDCCH scheduling a PDSCH, the numerology of the scheduled PDSCH, and the numerology of an uplink channel through which HARQ-ACK is to be transmitted, respectively.

With respect to UE processing capability 2, if the UE has not reported a particular UE capability report (related to a simultaneous operation between UE processing capability 2 and an enhanced DMRS type) to the base station, the UE may not expect that enabled as the higher layer signaling processingType2Enabled and an enhanced DMRS type are simultaneously configured by the base station and may consider d3 in Equation 5 as 0.

According to an embodiment, if the UE has reported a particular UE capability report (related to a simultaneous operation between UE processing capability 2 and an enhanced DMRS type) to the base station, and/or if an enhanced DMRS type is configured for the UE through higher layer signaling, the UE may consider d3 in Equation 5 as a value reported by the UE. If a subcarrier spacing is 15 kHz, the UE may report one value among 0, 1, 2, 3, and 4 as the value of d3. If the subcarrier spacing is 30 kHz, the UE may report one value among 0, 1, 2, 3, and 4. If the subcarrier spacing is 60 kHz in FR1, the UE may report one value among 0, 1, 2, 3, 4, 5, 6, and 7. If the UE reports a particular UE capability report (related to a simultaneous operation between UE processing capability 2 and an enhanced DMRS type) to the base station, and/or if higher layer signaling for an enhanced DMRS type is not configured for the UE, the UE may consider d3 in Equation 5 as 0.

TABLE 27
PDSCH processing time in case of PDSCH processing capability 1

PDSCH decoding time N₁ [symbols]

| | | PDSCH mapping types A |
|---|---|---|
| | PDSCH mapping types A | and B both are not dmrs- |
| | and B both are dmrs- | AdditionalPosition = |
| | AdditionalPosition = | pos0 in DMRS- |
| | pos0 in DMRS- | DownlinkConfig, |
| | DownlinkConfig, | which is upper layer |
| | which is upper | signaling, or the upper layer |
| μ | layer signaling | parameter is not configured |
| 0 | 8 | N_{1, 0} |
| 1 | 10 | 13 |
| 2 | 17 | 20 |
| 3 | 20 | 24 |

TABLE 28
PDSCH processing time in case of PDSCH processing capability 2

| | PDSCH decoding time N₁ [symbols] |
|---|---|
| | PDSCH mapping types A and B both are |
| | dmrs-AdditionalPosition = pos0 in DMRS- |
| μ | DownlinkConfig, which is upper layer signaling |
| 0 | 3 |
| 1 | 4.5 |
| 2 | 9 for frequency range 1 |

Tₑₓₜ: If the UE uses a shared spectrum channel access scheme, the UE may calculate Tₑₓₜ and apply same to a PDSCH processing time. Otherwise, the UE assumes 0 as Tₑₓₜ.
If l₁ indicating a PDSCH DMRS position value is 12, N_{1,0} in Table 27 has a value of 14 and, otherwise, has a value of 13.
With respect to PDSCH mapping type A, if the last symbol of a PDSCH is an i-th symbol in a slot in which the PDSCH is transmitted and i is smaller than 7 (i<7), d_{1,1} equals to 7-i and, otherwise, d_{1,1} is equal to 0.
d₂: If a PUCCH having a high priority index and a PUCCH or PUSCH having a low priority index overlap with each other in time, d2 of the PUCCH having the high priority index may be configured as a value reported from the UE. Otherwise, d2 is equal to 0.
In a case where PDSCH mapping type B is used for UE processing capability 1, a d_{1,1} value may be determined according to L that is the number of symbols of a scheduled PDSCH and d that is the number of symbols on which a PDCCH scheduling the PDSCH and the scheduled PDSCH overlap, as described below.

$$If L \geq 7 , {d}_{1 , 1} = 0. \\ If L \geq 4 and L \leq 6 , {d}_{1 , 1} = 7 - L . If L = 3 , {d}_{1 , 1} = min ( d , 1 ) . If L = 2 , {d}_{1 , 1} = 3 + d .$$

In a case where PDSCH mapping type B is used for UE processing capability 2, a d_{1,1} value may be determined according to L that is the number of symbols of a scheduled PDSCH and d that is the number of symbols on which a PDCCH scheduling the PDSCH and the scheduled PDSCH overlap, as described below.

$$If L \geq 7 , {d}_{1 , 1} = 0. \\ If L \geq 4 and L \leq 6 , {d}_{1 , 1} = 7 - L . L = 2 ,$$

If a PDCCH for scheduling exists in a CORESET configured by 3 symbols and the CORESET and a scheduled PDSCH have the same start symbol, d_{1,1} is equal to 3 (d_{1,1}=3).
Otherwise, d_{1,1} is equal to d (d_{1,1}=d).
In a case of a UE supporting capability 2 in a given serving cell, the UE may apply a PDSCH processing time corresponding to UE processing capability 2 when the higher layer signaling processingType2Enabled is configured as enabled for the cell.

If the position of a first uplink transmission symbol of a PUCCH including HARQ-ACK information (the position may be based on K1 defined as a HARQ-ACK transmission time point, a PUCCH resource used for HARQ-ACK transmission, and a timing advance effect) does not start earlier than a first uplink transmission symbol after a time interval as long as T_{proc,1} after a last symbol of a PDSCH, the UE is required to transmit a valid HARQ-ACK message. For example, the UE may transmit a PUCCH including HARQ-ACK only when a PDSCH processing time is enough. Otherwise, the UE is unable to provide valid HARQ-ACK information corresponding to a scheduled PDSCH to the base station. T_{proc,1} may be used for both a normal or expanded CP. In a case of a PDSCH configured to have two PDSCH transmission occasions in one slot, d_{1,1} may be calculated based on a first PDSCH transmission occasion in the slot.

According to an embodiment, when a particular number of DMRS types or more are configured for the UE through higher layer signaling, the UE may have a longer PDSCH processing time in consideration of d4 in Equation 5 according to which implementation the UE has. For example, if a particular number of different DMRS types or more are configured for the UE by the base station through higher layer signaling within a particular higher layer signaling configuration unit (e.g., for each particular bandwidth part, each particular cell, all cells within a particular band, all cells within a particular band of a particular band combination, or each particular UE), when a PDSCH is scheduled by the base station, the UE may expect that the PDSCH is scheduled after a particular time, symbol, or slot from the reception time position of DCI including scheduling information on the PDSCH. The particular number of DMRS types causing the UE to have a PDSCH scheduling restriction may be notified to the UE by the base station through at least one combination of higher layer signaling, MAC-CE signaling, and L1 signaling, may be transferred by the UE to the base station through a UE capability, or may be fixedly defined in a specification.

In addition, d4 in Equation 5 which the UE may consider as an additional delay to a PDSCH processing time may be a value which is reported by the UE through a UE capability, is notified to the UE by the base station through at least one combination of higher layer signaling, MAC-CE signaling, and L1 signaling, or is fixedly determined in a specification.

If d4 is reported through a UE capability, the value thereof may differ according to a subcarrier spacing and the number of different DMRS types configured simultaneously. For example, if the subcarrier spacing is 15 kHz and the number of different DMRS types configured simultaneously is 3, the UE may report one value among 0, 1, 2, 3, and 4. If the subcarrier spacing is 15 kHz and the number of different DMRS types configured simultaneously is 4, the UE may report one value among 0, 1, 2, 3, 4, 5, 6, and 7. Similarly, the UE may report a d4 value through a UE capability also in consideration of a case where the subcarrier spacing is 30 kHz or 60 kHz.

### Method 3-4

According to an embodiment, the UE may report, to the base station through a UE capability, whether dynamic switching is possible, through different DCI formats, between a normal DMRS type (DMRS type 1 and DMRS type 2) and an enhanced DMRS type (enhanced DMRS type 1 and enhanced DMRS type 2) by considering the remaining DCI formats (e.g., DCI formats 1_1, 1_2, 1_3, and 4_2) except for a DCI format 1_0. The UE may necessarily support DMRS type 1, and a PDSCH scheduled by DCI format 10 may be scheduled based on DMRS type 1. Therefore, pieces of information, such as system information, which UEs having not accessed a cell should also be able to receive, needs to be included, and thus in a case of considering dynamic switching between DMRS types, DCI format 10 may be excluded. If the UE has reported a corresponding UE capability to the base station, the UE may expect that, as DMRS types indicatable by all DCI formats (e.g., DCI formats 1_1, 1_2, 1_3, and 4_2) capable of PDSCH scheduling except for DCI format 1_0, the base station configures, for the UE, at least one of DMRS type 1 and DMRS type 2 or at least one of enhanced DMRS type 1 and enhanced DMRS type 2, and may not expect that a normal DMRS type and an enhanced DMRS type are indicated through different DCI formats. For example, the UE may expect that a maximum of two different DMRS types are configured through all DCI formats capable of PDSCH scheduling except for DCI format 1_0, and the maximum of two different DMRS types may be all normal DMRS types or enhanced DMRS types.

If the UE has not reported a corresponding UE capability to the base station, the UE may assume that there is no restriction described above, and may expect that, as DMRS types indicatable by all DCI formats (e.g., DCI formats 1_1, 1_2, 1_3, and 4_2) capable of PDSCH scheduling except for DCI format 1_0, the base station configures, for the UE, at least one of DMRS type 1, DMRS type 2, enhanced DMRS type 1, and enhanced DMRS type 2. For example, the UE may expect that a maximum of four different DMRS types are configured through all DCI formats capable of PDSCH scheduling except for DCI format 1_0,

According to various embodiments of the disclosure, the UE may be notified of at least one combination of [Method 3-1] to [Method 3-4] described above by the base station through at least one combination of higher layer signaling, MAC-CE signaling, or L1 signaling, or may expect that at least one combination of [Method 3-1] to [Method 3-4] is fixedly defined in a specification.

Additionally, if the UE is notified by the base station of one or more particular combinations of methods through at least one combination of higher layer signaling, MAC-CE signaling, or L1 signaling, it may imply that the UE is unable to support one or more other particular combinations of methods. For example, the UE may expect that [Method 3-1] is fixedly defined in a specification for a channel state information reporting method and process started by the UE described above. As another example, the UE may be notified by the base station of [Method 3-4] through at least one combination of higher layer signaling, MAC-CE signaling, or L1 signaling, and, in this case, the UE may consider that [Method 3-1] not being supported is notified by the base station.

According to an embodiment, the UE may report whether the UE is able to support at least one combination of [Method 3-1] to [Method 3-4] to the base station as a UE capability. In this case, if the UE has reported, to the base station as a UE capability, whether the UE is able to support one or more particular combinations of methods, it may be considered that the UE has reported that the UE is unable to support one or more other particular combinations of methods. For instance, the UE may report, to the base station, whether the UE is able to support [Method 3-1] or [Method 3-2]. As another example, the UE may report, to the base station, that the UE is able to support [Method 3-1], and such a UE capability report may imply that the UE is unable to support [Method 3-2].

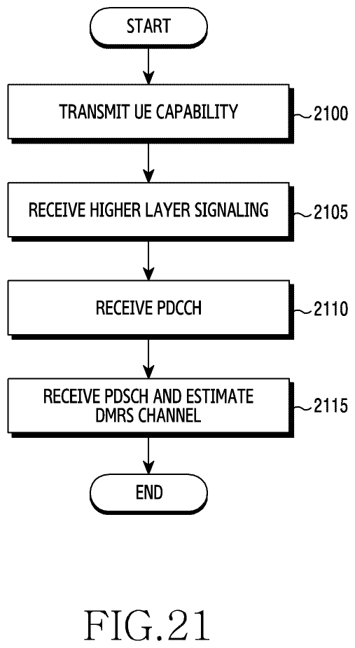

FIG. 21 illustrates an operation of a UE for transmitting or receiving a demodulation signal in a wireless communication system according to an embodiment of the disclosure.

In operation 2100, a UE may transmit a UE capability to a base station. UE capability signaling which may be reported may relate to at least one combination of a DMRS type-related UE capability, an enhanced DMRS type-related UE capability, a search space-related UE capability, a supportable DCI format (e.g., DCI format 1_2, 1_3, or 4_2)-related UE capability, and a UE capability indicating whether [Method 3-1] to [Method 3-4] are supported. Omission of operation 2100 is also possible.

In operation 2105, the UE may receive higher layer signaling from the base station according to the reported UE capability. The UE may define higher layer parameters relating to one or more combinations of search space-related higher layer signaling, higher layer signaling related to a DCI format monitorable in each search space, DMRS type and enhanced DMRS type-related higher layer signaling, and higher layer signaling for [Method 3-1] to [Method 3-4], which is received from the base station, and may use one of the higher layer parameters. A total number of DMRS types indicatable by different DCI formats may be configured for the UE according to the UE capability reported in operation 2100.

In operation 2110, the UE may receive a PDCCH from the base station. The PDCCH may include information scheduling a PDSCH and indicate a DMRS port based on a particular DMRS type.

In operation 2115, the UE may receive a PDSCH and perform DMRS channel estimation. If the UE operates based on [Method 3-2] or [Method 3-3], the UE may expect that a particular time length is ensured from the last symbol of the PDCCH until the scheduled PDSCH at the time of scheduling of the PDSCH. Thereafter, the UE may transmit, to the base station, a PUCCH including HARQ-ACK information corresponding to the PDSCH after a PDSCH processing time from the last symbol of the PDSCH reception.

A flowchart described above illustrates an exemplified method implementable according to the principle of the disclosure, and a method illustrated in the flowchart of this specification may be variously modified. For example, a series of operations are illustrated, but various operations in each drawing may overlap with each other, occur in parallel, occur in a different sequence, or occur several times. In another example, an operation may be omitted or replaced with another operation.

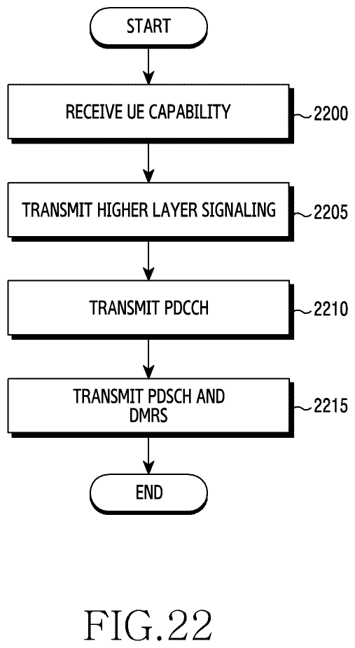

FIG. 22 illustrates an operation of a base station for transmitting or receiving a demodulation signal in a wireless communication system according to an embodiment of the disclosure.

In operation 2200, a base station may receive a UE capability from a UE. UE capability signaling which may be reported may relate to at least one combination of a DMRS type-related UE capability, an enhanced DMRS type-related UE capability, a search space-related UE capability, a supportable DCI format (e.g., DCI format 1_2, 1_3, or 4_2)-related UE capability, and a UE capability indicating whether [Method 3-1] to [Method 3-4] are supported. Omission of operation 2200 is also possible.

In operation 2205, the base station may transmit higher layer signaling to the UE according to the received UE capability. The base station may define higher layer parameters relating to one or more combinations of search space-related higher layer signaling, higher layer signaling related to a DCI format monitorable in each search space, DMRS type and enhanced DMRS type-related higher layer signaling, and higher layer signaling for [Method 3-1] to [Method 3-4], and may transmit one of the higher layer parameters to the UE. The base station may configure a total number of DMRS types indicatable by different DCI formats according to the UE capability received from the UE in operation 2200.

In operation 2210, the base station may transmit a PDCCH to the UE. The PDCCH may include information scheduling a PDSCH and indicate a DMRS port based on a particular DMRS type.

In operation 2215, the base station may transmit a PDSCH to the UE and expect that the UE performs DMRS channel estimation. If the base station operates based on [Method 3-2] or [Method 3-3], the base station may perform scheduling of the PDSCH so that a particular time length is ensured from the last symbol of the PDCCH until the scheduled PDSCH. Thereafter, the base station may expect that the UE may transmit, to the base station, a PUCCH including HARQ-ACK information corresponding to the PDSCH after a PDSCH processing time from the last symbol of the PDSCH reception.

The above-described flowchart illustrates a method that may be implemented according to the principle of the disclosure, and various changes may be made to the method shown in the flowchart herein. For example, a series of operations are illustrated, but various operations in each drawing may overlap with each other, occur in parallel, occur in a different sequence, or occur several times. In another example, an operation may be omitted or replaced with another operation.

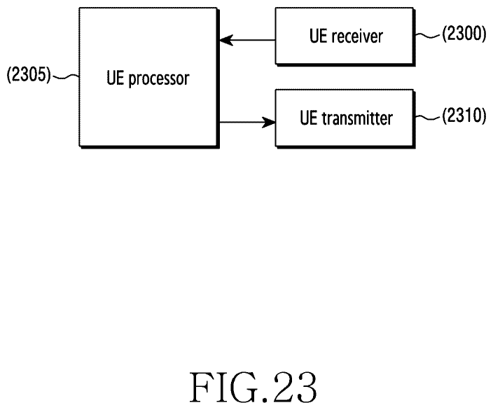

FIG. 23 illustrates a structure of a UE in a wireless communication system according to an embodiment of the disclosure.

Referring to FIG. 23, the UE may include a transceiver, which refers to a UE receiver 2300 and a UE transmitter 2310 as a whole, a memory (not illustrated), and a UE processor 2305 (or UE controller or processor). The UE transceiver 2300 and 2310, the memory, and the UE processor 2305 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include a storage medium such as a ROM, a RAM, a hard disk, a CD-ROM, or a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

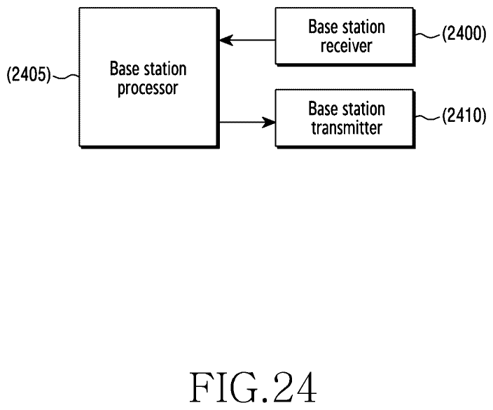

FIG. 24 illustrates a structure of a base station in a wireless communication system according to an embodiment of the disclosure.

Referring to FIG. 24, the base station may include a transceiver, which refers to a base station receiver 2400 and a base station transmitter 2410 as a whole, a memory (not illustrated), and a base station processor 2405 (or base station controller or processor). The base station transceiver 2400 and 2410, the memory, and the base station processor 2405 may operate according to the above-described communication methods of the UE. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include a storage medium such as a ROM, a RAM, a hard disk, a CD-ROM, or a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal.

For example, a part of a first embodiment of the disclosure may be combined with a part of a second embodiment of the disclosure to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A user equipment (UE) in a wireless communication system, the UE comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the UE to:
transmit, to a base station, first UE capability information indicating a supported demodulation reference signal (DMRS) type for downlink and second UE capability information indicating a supported enhanced DMRS type for physical downlink shared channel (PDSCH),
transmit, to the base station, third UE capability information including a value indicating a maximum number of DMRS types for PDSCH across all downlink control information (DCI) formats, and
receive, from the base station, a DMRS for PDSCH according to at least one DMRS type among the supported DMRS type and the supported enhanced DMRS type,
wherein a number of the at least one DMRS type is equal to or less than the maximum number of DMRS types.

2. The UE of claim 1,
wherein the supported DMRS type includes at least one of a DMRS type 1 or a DMRS type 2, and
wherein the supported enhanced DMRS type includes at least one of an enhanced DMRS type 1 or an enhanced DMRS type 2.

3. The UE of claim 1,
wherein the maximum number of DMRS types is configured per cell, and
wherein the value is one of 2, 3, or 4.

4. The UE of claim 1, wherein the third UE capability information is transmitted per feature set.

5. A base station in a wireless communication system, the base station comprising:
a transceiver;
a memory storing one or more computer programs; and
one or more processors communicatively coupled to the transceiver and the memory,
wherein the one or more programs include computer-executable instructions that, when executed by the one or more processors individually or collectively, cause the base station to:
receive, from a user equipment (UE), first UE capability information indicating a supported demodulation reference signal (DMRS) type for downlink and second UE capability information indicating a supported enhanced DMRS type for physical downlink shared channel (PDSCH),
receive, from the UE, third UE capability information including a value indicating a maximum number of DMRS types for PDSCH across all downlink control information (DCI) formats, and
transmit, to the UE, a DMRS for PDSCH according to at least one DMRS type among the supported DMRS type and the supported enhanced DMRS type,
wherein a number of the at least one DMRS type is equal to or less than the maximum number of DMRS types.

6. The base station of claim 5,
wherein the supported DMRS type includes at least one of a DMRS type 1 or a DMRS type 2, and
wherein the supported enhanced DMRS type includes at least one of an enhanced DMRS type 1 or an enhanced DMRS type 2.

7. The base station of claim 5,
wherein the maximum number of DMRS types is configured per cell, and
wherein the value is one of 2, 3, or 4.

8. The base station of claim 5, wherein the third UE capability information is received per feature set.

9. A method performed by a user equipment (UE) in a wireless communication system, the method comprising:
transmitting, to a base station, first UE capability information indicating a supported demodulation reference signal (DMRS) type for downlink and second UE capability information indicating a supported enhanced DMRS type for physical downlink shared channel (PDSCH);
transmitting, to the base station, third UE capability information including a value indicating a maximum number of DMRS types for PDSCH across all downlink control information (DCI) formats; and
receiving, from the base station, a DMRS for PDSCH according to at least one DMRS type among the supported DMRS type and the supported enhanced DMRS type,
wherein a number of the at least one DMRS type is equal to or less than the maximum number of DMRS types.

10. The method of claim 9,
wherein the supported DMRS type includes at least one of a DMRS type 1 or a DMRS type 2, and
wherein the supported enhanced DMRS type includes at least one of an enhanced DMRS type 1 or an enhanced DMRS type 2.

11. The method of claim 9,
wherein the maximum number of DMRS types is configured per cell, and
wherein the value is one of 2, 3, or 4.

12. The method of claim 9, wherein the third UE capability information is transmitted per feature set.

13. A method performed by a base station in a wireless communication system, the method comprising:
receiving, from a user equipment (UE), first UE capability information indicating a supported demodulation reference signal (DMRS) type for downlink and second UE capability information indicating a supported enhanced DMRS type for physical downlink shared channel, PDSCH;
receiving, from the UE, third UE capability information including a value indicating a maximum number of DMRS types for PDSCH across all downlink control information, DCI, formats; and
transmitting, to the UE, a DMRS for PDSCH according to at least one DMRS type among the supported DMRS type and the supported enhanced DMRS type,
wherein a number of the at least one DMRS type is equal to or less than the maximum number of DMRS types.

14. The method of claim 13,
wherein the supported DMRS type includes at least one of a DMRS type 1 or a DMRS type 2, and
wherein the supported enhanced DMRS type includes at least one of an enhanced DMRS type 1 or an enhanced DMRS type 2.

15. The method of claim 13,
wherein the maximum number of DMRS types is configured per cell, and
wherein the value is one of 2, 3, or 4.

16. The method of claim 13, wherein the third UE capability information is received per feature set.
